(19) United States
(12) Patent Application Publication
(10) Pub. No.: US 2024/0405823 A1
(43) Pub. Date: Dec. 5, 2024

(54) METHOD AND DEVICE FOR ENERGY SAVING IN WIRELESS COMMUNICATION SYSTEM

(71) Applicant: Samsung Electronics Co., Ltd., Suwon-si (KR)

(72) Inventors: Junyung YI, Suwon-si (KR); Youngbum KIM, Suwon-si (KR); Younsun KIM, Suwon-si (KR); Kyoungmin PARK, Suwon-si (KR); Youngrok JANG, Suwon-si (KR)

(21) Appl. No.: 18/671,268

(22) Filed: May 22, 2024

(30) Foreign Application Priority Data
May 23, 2023 (KR) 10-2023-0066437
Aug. 10, 2023 (KR) 10-2023-0104993

(51) Int. Cl. H04B 7/06

(52) U.S. Cl. CPC H04B 7/0626; H04B 7/0632; H04B 7/0639

(57) ABSTRACT

The disclosure relates to a fifth generation (5G) or sixth generation (6G) communication system for supporting a higher data transmission rate. A method for determining a mapping order of channel state information (CSI) fields for CSI reports of a terminal to determine spatial domain adaptation and power domain adaptation when network energy saving is applied is provided. A method performed by a terminal in a communication system is provided. The method includes receiving, from a base station, configuration information for a channel state information (CSI) report, wherein the configuration information includes a CSI report configuration including a plurality of sub-configurations for sub-reports, receiving, from the base station, channel state information reference signals (CSI-RSs) associated with the CSI report configuration, identifying CSI based on the CSI-RSs and the configuration information, and transmitting, to the base station, the CSI, wherein the CSI includes CSI fields of sub-reports ordered by indexes of the sub-reports.

### CROSS-REFERENCE TO RELATED APPLICATION(S)

This application is based on and claims priority under 35 U.S.C. § 119 (a) of a Korean patent application number 10-2023-0066437, filed on May 23, 2023, in the Korean Intellectual Property Office, and of a Korean patent application number 10-2023-0104993, filed on Aug. 10, 2023, in the Korean Intellectual Property Office, the disclosure of each of which is incorporated by reference herein in its entirety.

### BACKGROUND

### 1. Field

The disclosure relates to operations of a terminal and a base station in a wireless communication system. More particularly, the disclosure relates to a method and a device for energy saving in a wireless communication system.

### 2. Description of Related Art

The fifth generation (5G) mobile communication technologies define broad frequency bands such that high transmission rates and new services are possible, and can be implemented not only in “Sub 6 giga hertz (GHz)” bands, such as 3.5 GHZ, but also in “Above 6 GHz” bands referred to as mmWave including 28 GHz and 39 GHz. In addition, it has been considered to implement sixth generation (6G) mobile communication technologies (referred to as beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for determining a mapping order of channel state information (CSI) fields for CSI reports of a terminal to determine spatial domain adaptation (SD adaptation) and power domain adaptation (PD adaptation) to reduce energy consumption of a base station in a wireless communication system.

Another aspect of the disclosure is to provide an SD adaptation method of turning off spatial and power elements (e.g., including one or more of an antenna element AE), a power amplifier (PA), an antenna port, or an antenna panel) of a base station for energy saving of the base station.

Another aspect of the disclosure is to provide an efficient method for CSI resource and CSI resource set configuration and CSI report configuration via higher-layer signaling (e.g., radio resource control (RRC) signaling) to apply SD adaptation. For example, a method for determining a mapping order of CSI fields for a CSI report, based on information configured for network energy saving (NES) may be provided. Via this, a base station may receive an appropriate CSI report during SD and PD adaptation for energy saving.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving, from a base station, configuration information for a channel state information (CSI) report, wherein the configuration information includes a CSI report configuration including a plurality of sub-configurations for sub-reports, receiving, from the base station, channel state information reference signals (CSI-RSs) associated with the CSI report configuration, identifying CSI based on the CSI-RSs and the configuration information, and transmitting, to the base station, the CSI, wherein the CSI includes CSI fields of sub-reports ordered by indexes of the sub-reports.

In accordance with another aspect of the disclosure, a method performed by a base station in a wireless communication system is provided. The method includes transmitting, to a terminal, configuration information for a channel state information (CSI) report, wherein the configuration information includes a CSI report configuration including a plurality of sub-configurations for sub-reports, transmitting, to the terminal, channel state information reference signals (CSI-RSs) associated with the CSI report configuration, and receiving, from the terminal, CSI corresponding to the CSI-RSs and the configuration information, wherein the CSI includes CSI fields of sub-reports ordered by indexes of the sub-reports.

In accordance with another aspect of the disclosure, a terminal in a wireless communication system is provided. The terminal includes transceivers, memory storing one or more computer programs, and one or more processors communicatively coupled to the transceivers and the memory, wherein the one or more computer programs include computer-executable instructions that, when executed by the one or more processors individually or collectively, cause the terminal to receive, from a base station, configuration information for a channel state information (CSI) report, wherein the configuration information includes a CSI report configuration including a plurality of sub-configurations for sub-reports, receive, from the base station, channel state information reference signals (CSI-RSs) associated with the CSI report configuration, identify CSI based on the CSI-RSs and the configuration information, and transmit, to the base station, the CSI, wherein the CSI includes CSI fields of sub-reports ordered by indexes of the sub-reports.

In accordance with another aspect of the disclosure, a base station in a wireless communication system is provided. The base station includes transceivers, memory storing one or more computer programs, and one or more processors communicatively coupled to the transceivers and the memory, wherein the one or more computer programs include computer-executable instructions that, when executed by the one or more processors individually or collectively, cause the base station to transmit, to a terminal, configuration information for a channel state information (CSI) report, wherein the configuration information includes a CSI report configuration including a plurality of sub-configurations for sub-reports, transmit, to the terminal, channel state information reference signals (CSI-RSs) associated with the CSI report configuration, and receive, from the terminal, CSI corresponding to the CSI-RSs and the configuration information, wherein the CSI includes CSI fields of sub-reports ordered by indexes of the sub-reports.

According to an embodiment of the disclosure, a method for, during SD adaptation and/or PD adaptation to turn off a spatial element of a base station in a 5G mobile communication system, determining a mapping order of CSI fields for a single CSI report including multiple pieces of CSI can be provided.

According to an embodiment of the disclosure, a problem of excessive energy consumption of a base station can be addressed.

In accordance with another aspect of the disclosure, one or more non-transitory computer-readable storage media storing computer-executable instructions that, when executed by one or more processors of a terminal, cause the terminal to perform operations are provided. The operations include receiving, from a base station, configuration information for a channel state information (CSI) report, wherein the configuration information includes a CSI report configuration including a plurality of sub-configurations for sub-reports, receiving, from the base station, channel state information reference signals (CSI-RSs) associated with the CSI report configuration, identifying CSI based on the CSI-RSs and the configuration information, transmitting, to the base station, the CSI, and wherein the CSI includes CSI fields of sub-reports ordered by indexes of the sub-reports.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a basic structure of time-frequency resources as a wireless resource domain in a wireless communication system according to an embodiment of the disclosure;

FIG. 2 is a diagram illustrating a slot structure considered in a wireless communication system according to an embodiment of the disclosure;

FIG. 3 is a diagram illustrating a beam sweeping operation and a time domain mapping structure of a synchronization signal according to an embodiment of the disclosure;

FIG. 4 is a diagram illustrating a synchronization signal block considered in a wireless communication system according to an embodiment of the disclosure;

FIG. 5 is a diagram illustrating various transmission cases of a synchronization signal block in a frequency band below 6 GHz considered in a wireless communication system according to an embodiment of the disclosure;

FIG. 6 is a diagram illustrating transmission cases of a synchronization signal block in a frequency band of 6 GHz or higher considered in a wireless communication system according to an embodiment of the disclosure;

FIG. 7 illustrates cases of synchronization signal block transmission according to a subcarrier spacing within 5 ms of time in a wireless communication system according to an embodiment of the disclosure;

FIG. 8 illustrates demodulation reference signal (DMRS) patterns (type1 and type2) used for communication between a base station and a terminal in a wireless communication system according to an embodiment of the disclosure;

FIG. 9 illustrates channel estimation using a DMRS received on one physical uplink shared channel (PUSCH) in a time band of a wireless communication system according to an embodiment of the disclosure;

FIG. 10 illustrates a method of reconfiguring synchronization signal block (SSB) transmission via dynamic signaling in a wireless communication system according to an embodiment of the disclosure;

FIG. 11 illustrates a method of reconfiguring a BWP and a BW via dynamic signaling in a wireless communication system according to an embodiment of the disclosure;

FIG. 12 illustrates a method of reconfiguring discontinuous reception (DRX) via dynamic signaling in a wireless communication system according to an embodiment of the disclosure;

FIG. 13 illustrates a discontinuous transmission (DTx) method for base station energy saving according to an embodiment of the disclosure;

FIG. 14 illustrates an operation of a base station according to a next-generation node B (gNB) wake-up signal according to an embodiment of the disclosure;

FIG. 15 illustrates an antenna adaptation method of a base station for energy saving in a wireless communication system according to an embodiment of the disclosure;

FIG. 16A illustrates a method of receiving CSI feedback for each terminal to determine SD adaptation of a base station in a wireless communication system according to an embodiment of the disclosure;

FIG. 16B illustrates a method of receiving CSI feedback for each terminal to determine SD adaptation of a base station in a wireless communication system according to an embodiment of the disclosure;

FIG. 17A illustrates a method of configuring a CSI resource/resource set/report for each terminal by a base station to determine SD adaptation in a wireless communication system according to an embodiment of the disclosure;

FIG. 17B is a diagram illustrating a method of configuring a CSI resource/resource set/report for each terminal by a base station to determine SD adaptation in a wireless communication system according to an embodiment of the disclosure;

FIG. 17C is a diagram illustrating a method of configuring a CSI resource/resource set/report for each terminal by a base station to determine SD adaptation in a wireless communication system according to an embodiment of the disclosure;

FIG. 18 is a diagram illustrating an operation in which a base station and a terminal transmit multiple pieces of CSI via a single CSI report according to an embodiment of the disclosure;

FIG. 19 is a diagram illustrating a method in which a base station and a terminal determine a precoding matrix indicator (PMI) subset for energy saving of a base station according to an embodiment of the disclosure;

FIG. 20 is a diagram illustrating a CSI report in which a base station and a terminal have multiple sub-configurations, multiple CSI-RSs, and multiple power control offset values according to an embodiment of the disclosure;

FIG. 21 is a flowchart for illustrating a terminal operation of applying an energy saving method in a wireless communication system according to an embodiment of the disclosure;

FIG. 22 is a flowchart for illustrating a base station operation of applying an energy saving method in a wireless communication system according to an embodiment of the disclosure;

FIG. 23 is a block diagram of a terminal according to an embodiment of the disclosure; and

FIG. 24 is a block diagram of a base station according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, long term evolution (LTE) or LTE-advanced (LTE-A) systems may be described by way of example, but the embodiments of the disclosure may also be applied to other communication systems having similar technical backgrounds or channel types to the embodiments of the disclosure. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in the embodiments may include one or more processors.

Hereinafter, embodiments of the disclosure will be described in conjunction with the accompanying drawings. Method and devices as proposed in the embodiments of the disclosure below may be applied without being limited to the respective embodiments of the disclosure, and all or some of one or more embodiments proposed in the disclosure may be employed in combination. Therefore, based on determinations by those skilled in the art, the embodiments of the disclosure may be applied through some modifications without significantly departing from the scope of the disclosure.

Furthermore, in describing the disclosure, a detailed description of known functions or configurations incorporated herein will be omitted when it is determined that the description may make the subject matter of the disclosure unnecessarily unclear. The terms which will be described below are terms defined based on the functions in the disclosure, and may be different according to users, intentions of the users, or customs. Therefore, the definitions of the terms should be made based on the contents throughout the specification.

A wireless communication system is advancing to a broadband wireless communication system for providing high-speed and high-quality packet data services using communication standards, such as high-speed packet access (HSPA) of 3GPP, LTE-Advanced (LTE-A), LTE-Pro, high-rate packet data (HRPD) of 3GPP2, ultra-mobile broadband (UMB), IEEE 802.17e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). uplink refers to a radio link via which a user equipment (UE) or a mobile station (MS) transmits data or control signals to a base station (BS) or eNode B, and the downlink refers to a radio link via which the base station transmits data or control signals to the UE. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multiple-input multiple-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services, such as the Internet of things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time, such as 10 to 16 years, because it is difficult to frequently replace the battery of the UE.

Lastly, URLLC is a cellular-based mission-critical wireless communication service. For example, URLLC may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and must also assign a large number of resources in a frequency band in order to secure reliability of a communication link.

The three services in the 5G communication system (hereinafter may be interchangeably used with “5G system”), that is, eMBB, URLLC, and mMTC, may be multiplexed and transmitted in a single system. In order to satisfy different requirements of the respective services, different transmission/reception techniques and transmission/reception parameters may be used between the services.

Hereinafter, a frame structure of a 5G system will be described with reference to the drawings. Hereinafter, a configuration of a 5G system will be described as an example of a wireless communication to which the disclosure is applied for the sake of descriptive convenience, but the embodiments of the disclosure may also be applied in the same or similar manner to 5G or higher systems or other communication systems to which the disclosure is applicable.

According to an embodiment of the disclosure, the method may include an operation of configuring, via higher-layer signaling, CSI reports and/or CSI resources (and/or CSI resource sets) having/including multiple antenna configuration hypotheses and power control offsets for spatial domain (SD) and/or power domain (PD) adaptation.

According to an embodiment of the disclosure, the method may include an operation of determining multiple CSI report configurations among the multiple antenna configuration hypotheses, based on the configured information.

According to an embodiment of the disclosure, the method may include an operation of determining a mapping order of CSI fields of a single transmission CSI report, in which multiple CSI reports according to the multiple antenna configuration hypotheses are transmitted in one physical uplink control channel (PUCCH) or PUSCH occasion, based on the configured information.

According to an embodiment of the disclosure, a single CSI report including multiple pieces of CSI may be received on a PUSCH or PUCCH, based on the determined mapping order.

According to an embodiment of the disclosure, the method may then include an operation of applying SD and/or PD adaptation, based on a CSI report received from a terminal.

According to an embodiment of the disclosure, a method performed by a terminal in a communication system may be provided.

According to an embodiment of the disclosure, the method may include an operation of configuring, via higher-layer signaling, CSI reports and/or CSI resources (and/or CSI resource sets) having/including multiple antenna configuration hypotheses and power control offsets for SD and/or PD adaptation.

According to an embodiment of the disclosure, the method may include an operation of determining a CSI report configuration among the multiple antenna configuration hypotheses, based on the configured information.

According to an embodiment of the disclosure, the method may include an operation of determining a mapping order of CSI fields of a single transmission CSI report, in which multiple pieces of CSI according to the multiple antenna configuration hypotheses are transmitted in one PUCCH or PUSCH occasion, based on the configured information.

According to an embodiment of the disclosure, the method may include an operation of transmitting a single CSI report including multiple pieces of CSI on a PUSCH or PUCCH, based on the determined mapping order.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

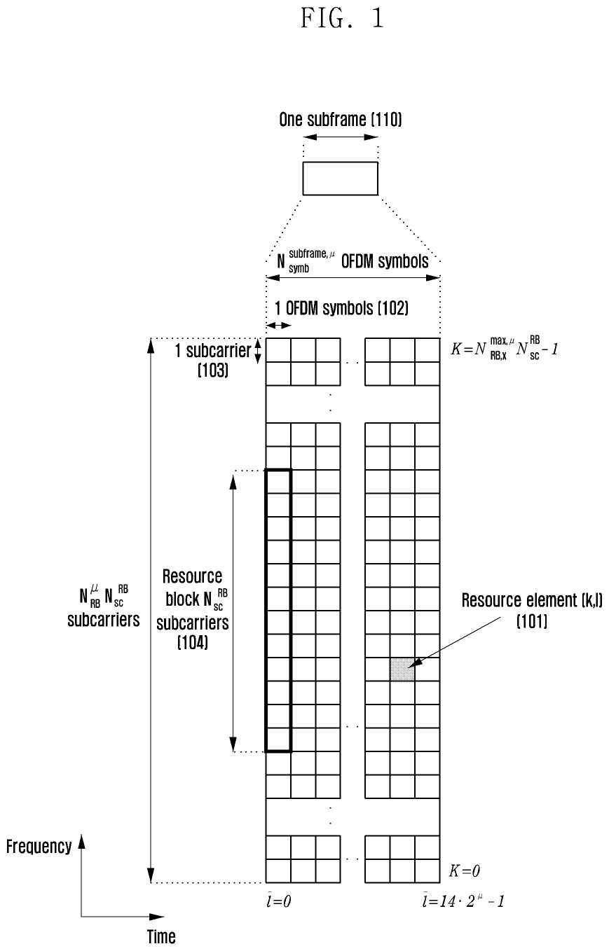

FIG. 1 illustrates a basic structure of a time-frequency resources as a radio resource domain in a wireless communication system according to an embodiment of the disclosure.

Referring to FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol (or discrete Fourier transform spread OFDM (DFT-s-OFDM) symbol) 102 on the time axis and one subcarrier 103 on the frequency axis. In the frequency domain, N_{sc}^{RB} (indicating the number of subcarriers per resource block (RB), for example, 12) consecutive REs may constitute one resource block (RB) 104. In addition, in the time domain, N_{symb}^{subframe} (indicating the number of symbols per subframe) consecutive OFDM symbols may constitute one subframe 110.

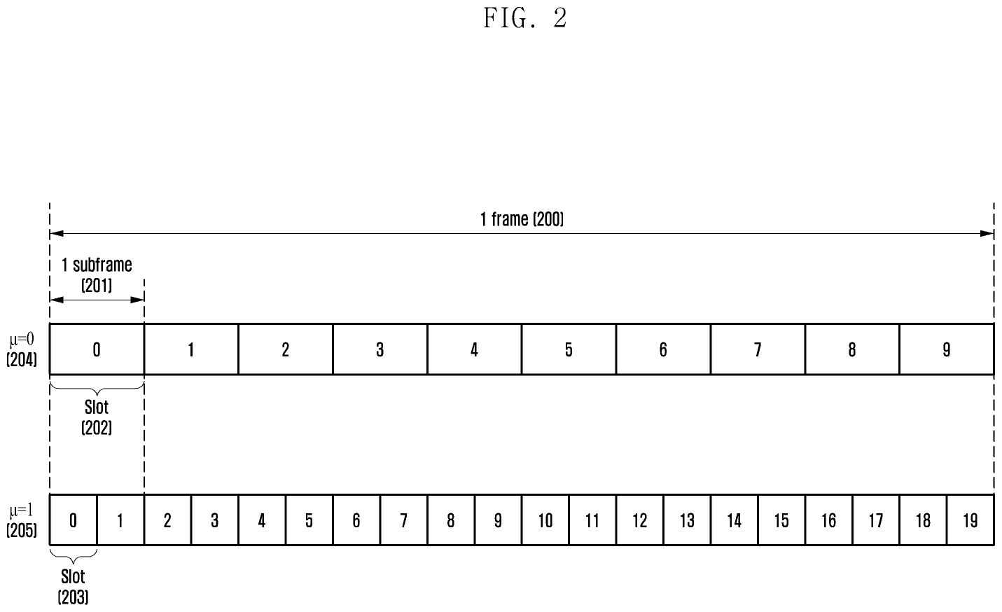

FIG. 2 illustrates a slot structure considered in a wireless communication system according to an embodiment of the disclosure.

Referring to FIG. 2, an example of a slot structure including a frame 200, a subframe 201, and a slot 202 is illustrated. One frame 200 may be defined as 10 ms. One subframe 201 may be defined as 1 ms, and thus one frame 200 may include a total of 10 subframes 201. One slot 202 or 203 may be defined as 14 OFDM symbols (that is, the number of symbols per one slot, N_{symb}^{slot}=14). One subframe 201 may include one or multiple slots 202 and 203, and the number of slots 202 and 203 per one subframe 201 may vary depending on configuration values μ for the subcarrier spacing 204 or 205.

FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots (for example, slots 203). For example, the number of slots per one subframe Nₛₗₒₜ^{subframe,μ} may differ depending on the subcarrier spacing configuration value u, and the number of slots per one frame Nₛₗₒₜ^{frame,μ} may differ accordingly. For example, Nₛₗₒₜ^{subframe,μ} and Nₛₗₒₜ^{frame,μ} may be defined according to each subcarrier spacing configuration μ as in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In the 5G wireless communication system, a synchronization signal block (SSB) (SS block or SS/physical broadcast channel (PBCH) block may be interchangeably used) for initial access of a terminal may be transmitted, and the synchronization signal block may include a primary synchronization signal (PSS), a secondary synchronization signal (SSS), and a physical broadcast channel (PBCH).

During an initial access operation of a terminal accessing a system, the terminal may first acquire downlink time and frequency domain synchronization from a synchronization signal via a cell search and may acquire a cell ID. The synchronization signal may include a PSS and an SSS. In addition, the terminal may receive, from a base station, a PBCH for transmitting of a master information block (MIB) so as to acquire a basic parameter value and system information related to transmission and reception, such as a system bandwidth or related control information. Based on this information, the terminal may perform decoding on a physical downlink control channel (PDCCH) and a physical downlink shared channel (PDSCH) so as to acquire a system information block (SIB). Then, the terminal may exchange terminal identification-related information with the base station via a random-access operation, and may initially access a network via registration and authentication operations. Additionally, the terminal may receive system information (system information block (SIB)) transmitted by the base station, so as to acquire control information related to cell common transmission and reception. The cell-common transmission and reception-related control information may include random-access-related control information, paging-related control information, common control information for various physical channels, or the like.

A synchronization signal is a signal that serves as a reference for a cell search, and for each frequency band, a subcarrier spacing appropriate for a channel environment, such as phase noise, may be applied. For a data channel or a control channel, in order to support various services as described above, a subcarrier spacing may be applied differently depending on a service type.

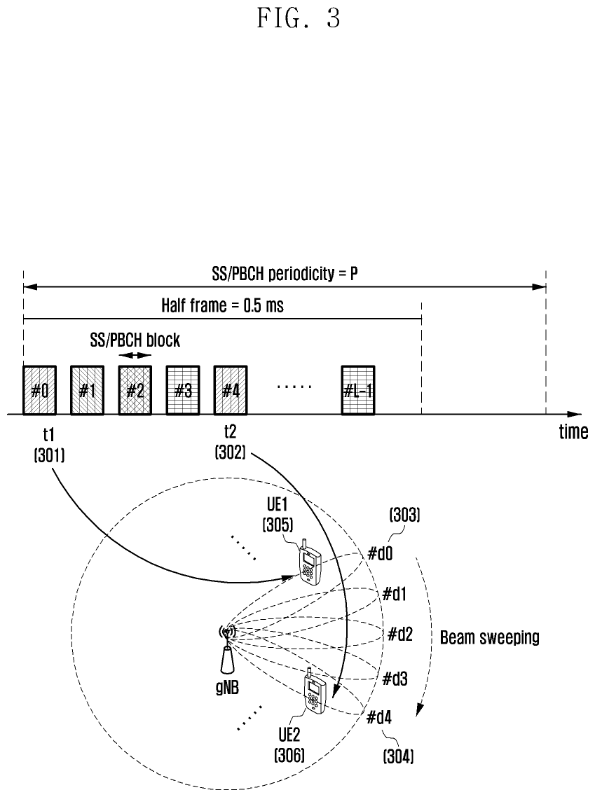

FIG. 3 illustrates a beam sweeping operation and a time domain mapping structure of a synchronization signal according to an embodiment of the disclosure. For description purposes, the following elements may be defined.
Primary synchronization signal (PSS): A PSS is a signal that serves as a reference for DL time/frequency synchronization, and provides some of cell ID information.
Secondary synchronization signal (SSS): An SSS serves as a reference for DL time/frequency synchronization, and provides some of the remaining cell ID information. Additionally, the SSS may serve as a reference signal for demodulation of a PBCH.
Physical broadcast channel (PBCH): A PBCH provides a master information block (MIB) which is essential system information required for transmission and reception of a data channel and a control channel of a terminal. The essential system information may include search space-related control information indicating radio resource mapping information of a control channel, scheduling control information for a separate data channel for transmission of system information, information, such as a system frame number (SFN) which is a frame unit index that serves as a timing standard, and the like.
SS/PBCH block: An SS/PBCH block is configured by N OFDM symbols and may include a combination of a PSS, an SSS, a PBCH, or the like. For a system to which a beam sweeping technology is applied, an SS/PBCH block is a minimum unit to which beam sweeping is applied. In the 5G system, N=4 may be satisfied. A base station may transmit up to L SS/PBCH blocks, and the L SS/PBCH blocks are mapped within a half frame (0.5 ms). In addition, the L SS/PBCH blocks are periodically repeated in each predetermined period P. The base station may inform a terminal of period P via signaling. If there is no separate signaling for period P, the terminal may apply a previously agreed default value.

Referring to FIG. 3, it illustrates an example in which beam sweeping is applied in units of SS/PBCH blocks over time. In an example of FIG. 3, terminal 1 305 receives an SS/PBCH block by using a beam emitted in direction #d0 303, by beamforming applied to SS/PBCH block #0 at time point t1 301. In addition, terminal 2 306 receives an SS/PBCH block by using a beam emitted in direction #d4 304, by beamforming applied to SS/PBCH block #4 at time point t2 302. The terminal may acquire, from the base station, an optimal synchronization signal via a beam emitted in a direction where the terminal is located. For example, it may be difficult for terminal 1 305 to acquire time/frequency synchronization and essential system information from the SS/PBCH block via the beam emitted in direction #d4 which is far from the position of terminal 1.

In addition to the initial access, the terminal may receive an SS/PBCH block also for determining whether a radio link quality of a current cell is maintained at a certain level or higher. In addition, during handover in which the terminal moves access from the current cell to an adjacent cell, the terminal may determine a radio link quality of the adjacent cell and receive an SS/PBCH block of the adjacent cell to acquire time/frequency synchronization of the adjacent cell.

Hereinafter, initial cell access operations of the 5G wireless communication system will be described with reference to drawings.

A synchronization signal is a signal that serves as a reference for a cell search, and may be transmitted by applying of a subcarrier spacing appropriate for a channel environment (e.g., phase noise) for each frequency band. A 5G base station may transmit multiple synchronization signal blocks according to the number of analog beams to be operated. A PSS and an SSS may be mapped and transmitted over 12 RBs, and a PBCH may be mapped and transmitted over 24 RBs. Hereinafter, a description will be provided for a structure in which a synchronization signal and a PBCH are transmitted in the 5G communication system.

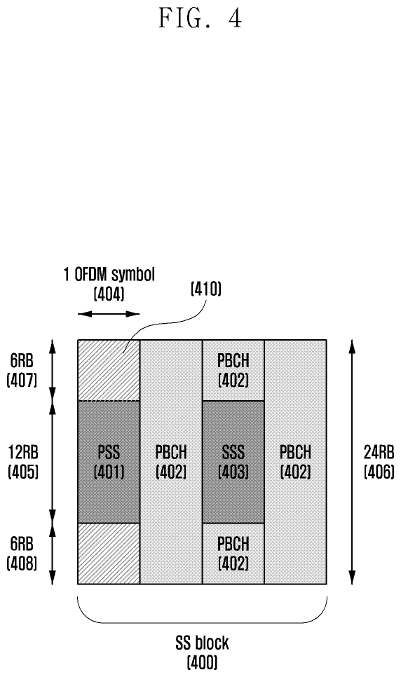

FIG. 4 illustrates a synchronization signal block considered in the wireless communication system according to an embodiment of the disclosure.

Referring to FIG. 4, a synchronization signal block (SS block) 400 may include a PSS 401, an SSS 403, and a physical broadcast channel (PBCH) 402.

The synchronization signal block 400 may be mapped to four OFDM symbols 404 on the time axis. The PSS 401, under block 410, and the SSS 403 may be transmitted in 12 RBs 405 on the frequency axis, and in first and third OFDM symbols, respectively, on the time axis. In the 5G system, for example, a total of 1008 different cell IDs may be defined. Depending on a physical layer cell ID (physical cell ID (PCI)) of a cell, the PSS 401 may have 3 different values, and the SSS 403 may have 336 different values. Via detection for the PSS 401 and the SSS 403, based on a combination thereof, a terminal may acquire one of 1008 (336×3=1008) cell IDs. This may be expressed by Equation 1 below.

$${N}_{ID}^{cell} = 3 {N}_{ID}^{( 1 )} + {N}_{ID}^{( 2 )} \qquad Equation 1$$

Here, N_{1D}⁽¹⁾ may be estimated from the SSS 403, and may have a value between 0 and 335. N_{1D}⁽²⁾ may be estimated from the PSS 401 and may have a value between 0 and 2. The terminal may estimate a value of N_{1D}^{cell}, which is a cell ID, by using a combination of N_{1D}⁽¹⁾ and N_{1D}⁽²⁾.

In 24 RBs 406 on the frequency axis and in a second or a fourth OFDM symbol of the SS block on the time axis, the PBCH 402 may be transmitted in resources including 6 RBs 407 and 6 RBs 408 on both sides, excluding 12 RBs. The PBCH 402 may include a PBCH payload and a PBCH demodulation reference signal (DMRS), and various system information referred to as MIB may be transmitted in the PBCH payload. For example, an MIB may include information as in Table 2 below.

```
TABLE 2
MIB ::=  SEQUENCE {
  systemFrameNumber  BIT STRING (SIZE (6)),
  subCarrierSpacingCommon ENUMERATED {scs15or60, scs30or120},
  ssb-SubcarrierOffset  INTEGER (0..15),
  dmrs-TypeA-Position  ENUMERATED {pos2, pos3},
  pdcch-ConfigSIB1  PDCCH-ConfigSIB1,
  cellBarred  ENUMERATED {barred, notBarred},
  intraFreqReselection  ENUMERATED {allowed, notAllowed},
  spare  BIT STRING (SIZE (1))
}
```

Synchronization signal block information: An offset of the frequency domain of the synchronization signal block may be indicated via 4-bit ssb-SubcarrierOffset in an MIB. The terminal may indirectly acquire an index of the synchronization signal block including the PBCH via decoding of the PBCH and the PBCH DMRS. In an embodiment of the disclosure, in a frequency band below 6 GHZ, 3 bits acquired via decoding of the PBCH DMRS may indicate the synchronization signal block index, and in a frequency band of 6 GHz or higher, a total of 6 bits, which includes 3 bits acquired via decoding of the PBCH DMRS and 3 bits which are included in the PBCH payload and acquired from PBCH decoding, may indicate the synchronization signal block index including the PBCH.
Physical downlink control channel (PDCCH) configuration information: A subcarrier spacing of a common downlink control channel may be indicated via 1 bit (subCarrierSpacingCommon) in an MIB, and time-frequency resource configuration information of a control resource set (CORESET) and a search space (SS) may be indicated via 8 bits (pdcch-ConfigSIB1).
System frame number (SFN): In an MIB, 6 bits (systemFrameNumber) may be used to indicate a part of an SFN. Least significant bit (LSB) 4 bits of the SFN may be included in the PBCH payload and indirectly acquired by the terminal via PBCH decoding.
Timing information in a radio frame: Timing information is 1 bit (half frame) which is included in the aforementioned synchronization signal block index and PBCH payload, and acquired via PBCH decoding, and the terminal may indirectly identify whether the synchronization signal block has been transmitted in a first or second half frame of a radio frame.

The transmission bandwidth (12 RBs 405) for the PSS 401 and the SSS 403 is different from the transmission bandwidth (24 RBs 406) for the PBCH 402, so that, in a first OFDM symbol in which the PSS 401 is transmitted within the PBCH 402 transmission bandwidth, there exist 6 RBs 407 and 6 RBs 408 on both sides excluding 12 RBs while the PSS 401 is being transmitted, and the area may be used for transmitting another signal or may be empty.

Synchronization signal blocks may be transmitted using the same analog beam. For example, the PSS 401, the SSS 403, and the PBCH 402 may all be transmitted via the same beam. Since analog beams cannot be applied differently to the frequency axis, the same analog beam may be applied to all frequency axis RBs within a specific OFDM symbol to which a specific analog beam has been applied.

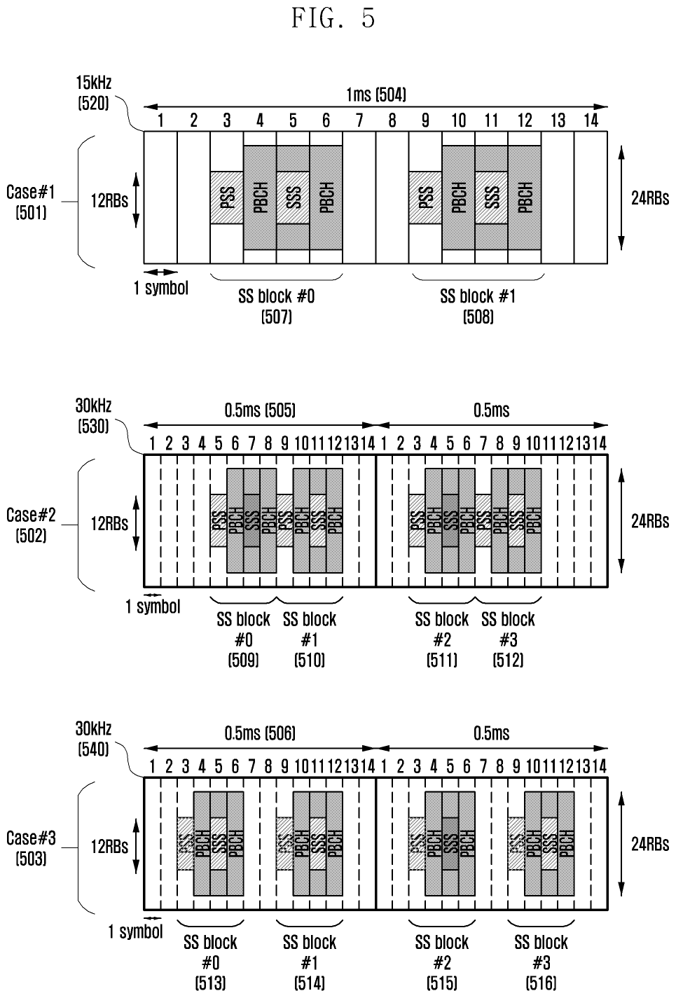

FIG. 5 illustrates various transmission cases of a synchronization signal block in a frequency band below 6 GHz considered in the communication system according to an embodiment of the disclosure.

Referring to FIG. 5, in the 5G communication system, a subcarrier spacing (SCS) 520 of 15 kHz and a subcarrier spacing (SCS) 530 or 540 of 30 kHz may be used for synchronization signal block transmission in a frequency band of 6 GHz or lower (or frequency range 1 (FR1), e.g., a frequency band of 410 MHz to 7,125 MHZ). There may be one transmission case (e.g., case #1 501) for a synchronization signal block in the subcarrier spacing 520 of 15 kHz, and there may be two transmission cases (e.g., case #2 402 and case #3 503) for a synchronization signal block in the subcarrier spacing 530 or 540 of 30 KHz.

In FIG. 5, in case #1 501 with the subcarrier spacing 520 of 15 kHz, up to 2 synchronization signal blocks may be transmitted in 1 ms of time 504 (or corresponding to a length of 1 slot when 1 slot includes 14 OFDM symbols). In an example of FIG. 4, synchronization signal block #0 507 and synchronization signal block #1 508 are illustrated. For example, synchronization signal block #0 507 may be mapped to 4 consecutive symbols starting from a third OFDM symbol, and synchronization signal block #1 508 may be mapped to 4 consecutive symbols starting from a ninth OFDM symbol.

Different analog beams may be applied to synchronization signal block #0 507 and synchronization signal block #1 508. In addition, the same beam may be applied to all of the third to sixth OFDM symbols to which synchronization signal block #0 507 is mapped, and the same beam may be applied to all of the ninth to 12th OFDM symbols to which synchronization signal block #1 508 is mapped. With regard to beams to be used for seventh, eighth, 13th, and 14th OFDM symbols to which no synchronization signal block is mapped, an analog beam may be freely determined at the discretion of a base station.

In FIG. 5, in case #2 502 with the subcarrier spacing 530 of 30 kHz, up to 2 synchronization signal blocks may be transmitted in 0.5 ms of time 505 (or corresponding to a length of 1 slot when 1 slot includes 14 OFDM symbols), and accordingly, up to 4 synchronization signal blocks may be transmitted in 1 ms of time (or corresponding to a length of 2 slots when 1 slot includes 14 OFDM symbols). In an example of FIG. 5, a case where synchronization signal block #0 509, synchronization signal block #1 510, synchronization signal block #2 511, and synchronization signal block #3 512 are transmitted in 1 ms of time (i.e., two slots) is illustrated. Synchronization signal block #0 509 and synchronization signal block #1 510 may be mapped starting from a 5th OFDM symbol and a 9th OFDM symbol of a first slot, respectively, and synchronization signal block #2 511 and synchronization signal block #3 512 may be mapped starting from a 3rd OFDM symbol and a 7th OFDM symbol of a second slot, respectively.

Different analog beams may be applied to synchronization signal block #0 509, synchronization signal block #1 510, synchronization signal block #2 511, and synchronization signal block #3 512, respectively. In addition, the same analog beam may be applied to all of fifth to eighth OFDM symbols of a first slot in which synchronization signal block #0 509 is transmitted, ninth to 12th OFDM symbols of the first slot in which synchronization signal block #1 510 is transmitted, third to sixth symbols of a second slot in which synchronization signal block #2 511 is transmitted, and seventh to 10th symbols of the second slot in which synchronization signal block #3 512 is transmitted. With regard to beams to be used for OFDM symbols to which no synchronization signal block is mapped, analog beams may be freely determined at the discretion of a base station.

In FIG. 5, in case #3 503 with the subcarrier spacing 540 of 30 kHz, up to 2 synchronization signal blocks may be transmitted in 0.5 ms of time 506 (or corresponding to a length of 1 slot when 1 slot includes 14 OFDM symbols), and accordingly, up to 4 synchronization signal blocks may be transmitted in 1 ms of time (or corresponding to a length of 2 slots when 1 slot includes 14 OFDM symbols). In an example of FIG. 5, transmission of synchronization signal block #0 513, synchronization signal block #1 514, synchronization signal block #2 515, and synchronization signal block #3 516 in 1 ms of time (i.e., two slots) is illustrated. Synchronization signal block #0 513 and synchronization signal block #1 514 may be mapped starting from a third OFDM symbol and a ninth OFDM symbol of a first slot, respectively, and synchronization signal block #2 515 and synchronization signal block #3 516 may be mapped starting from a third OFDM symbol and a ninth OFDM symbol of a second slot, respectively.

Different analog beams may be used for synchronization signal block #0 513, synchronization signal block #1 514, synchronization signal block #2 515, and synchronization signal block #3 516, respectively. As described in the examples above, the same analog beam may be used for all 4 OFDM symbols in which respective synchronization signal block are transmitted, and in OFDM symbols to which no synchronization signal block is mapped, beams to be used may be freely determined at the discretion of a base station.

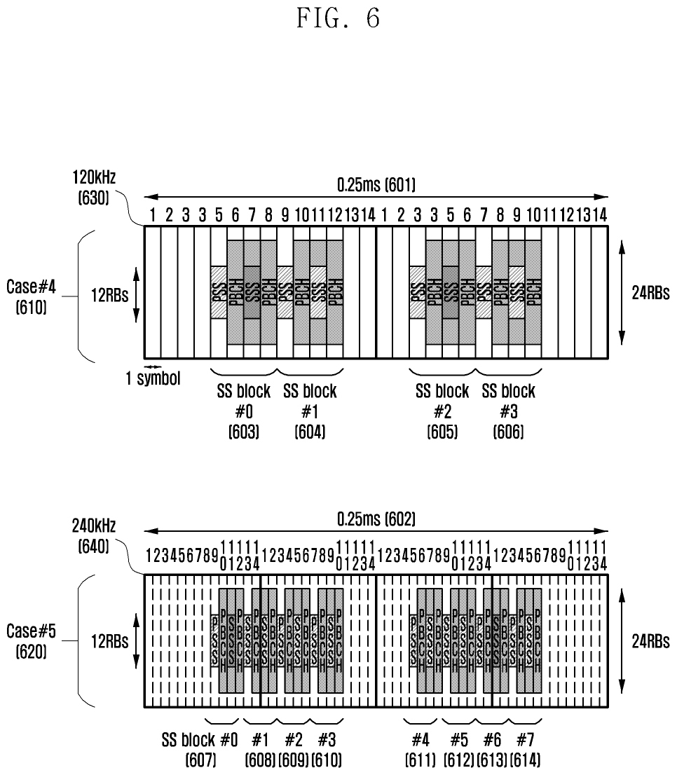

FIG. 6 illustrates transmission cases of a synchronization signal block in a frequency band of 6 GHz or higher considered in the wireless communication system, according to an embodiment of the disclosure.

In the 5G communication system, in a frequency band of 6 GHz or higher (or FR2, e.g., a frequency band of 24,250 MHz to 52,600 MHz), a subcarrier spacing 630 of 120 kHz as shown in case #4 610 and a subcarrier spacing 640 of 240 kHz as shown in case #5 620 may be used for synchronization signal block transmission.

Referring to FIG. 6, in case #4 610 with the subcarrier spacing 630 of 120 kHz, up to 4 synchronization signal blocks may be transmitted in 0.25 ms of time 601 (or corresponding to a length of 2 slots when 1 slot includes 14 OFDM symbols). In an example of FIG. 6, a case where synchronization signal block #0 603, synchronization signal block #1 604, synchronization signal block #2 605, and synchronization signal block #3 606 are transmitted in 0.25 ms of time (i.e., two slots) is illustrated. Synchronization signal block #0 603 and synchronization signal block #1 604 may be respectively mapped to 4 consecutive symbols starting from a fifth OFDM symbol and to 4 consecutive symbols starting from a ninth OFDM symbol of a first slot, and synchronization signal block #2 605 and synchronization signal block #3 606 may be respectively mapped to 4 consecutive symbols starting from a third OFDM symbol and to 4 consecutive symbols starting from a seventh OFDM symbol of a second slot.

As described in the embodiment above, different analog beams may be used for synchronization signal block #0 603, synchronization signal block #1 604, synchronization signal block #2 605, and synchronization signal block #3 606, respectively. In addition, the same analog beam may be used for all 4 OFDM symbols in which respective synchronization signal block are transmitted, and in OFDM symbols to which no synchronization signal block is mapped, beams to be used may be freely determined at the discretion of a base station.

In case #5 620 with the subcarrier spacing 640 of 240 kHz, up to 8 synchronization signal blocks may be transmitted in 0.25 ms of time 602 (or corresponding to a length of 4 slots when 1 slot includes 14 OFDM symbols). In an example of FIG. 6, a case where synchronization signal block #0 607, synchronization signal block #1 608, synchronization signal block #2 609, synchronization signal block #3 610, synchronization signal block #4 611, synchronization signal block #5 612, synchronization signal block #6 613, and synchronization signal block #7 614 are transmitted in 0.25 ms of time (i.e., 4 slots) is illustrated.

Synchronization signal block #0 607 and synchronization signal block #1 608 may be respectively mapped to 4 consecutive symbols starting from a ninth OFDM symbol and to 4 consecutive symbols starting from a 13th OFDM symbol of a first slot, synchronization signal block #2 609 and synchronization signal block #3 610 may be respectively mapped to 4 consecutive symbols starting from a third OFDM symbol and to 4 consecutive symbols starting from a seventh OFDM symbol of a second slot, synchronization signal block #4 611, synchronization signal block #5 612, and synchronization signal block #6 613 may be respectively mapped to 4 consecutive symbols starting from a fifth OFDM symbol, to 4 consecutive symbols starting from a ninth OFDM symbol, and to 4 consecutive symbols starting from a 13th OFDM symbol of a third slot, and synchronization signal block #7 614 may be mapped to 4 consecutive symbols starting from a third OFDM symbol of a fourth slot.

As described in the embodiment above, different analog beams may be applied to synchronization signal block #0 607, synchronization signal block #1 608, synchronization signal block #2 609, synchronization signal block #3 610, synchronization signal block #4 611, synchronization signal block #5 612, synchronization signal block #6 613, and synchronization signal block #7 614, respectively. In addition, the same analog beam may be used for all 4 OFDM symbols in which respective synchronization signal block are transmitted, and in OFDM symbols to which no synchronization signal block is mapped, beams to be used may be freely determined at the discretion of a base station.

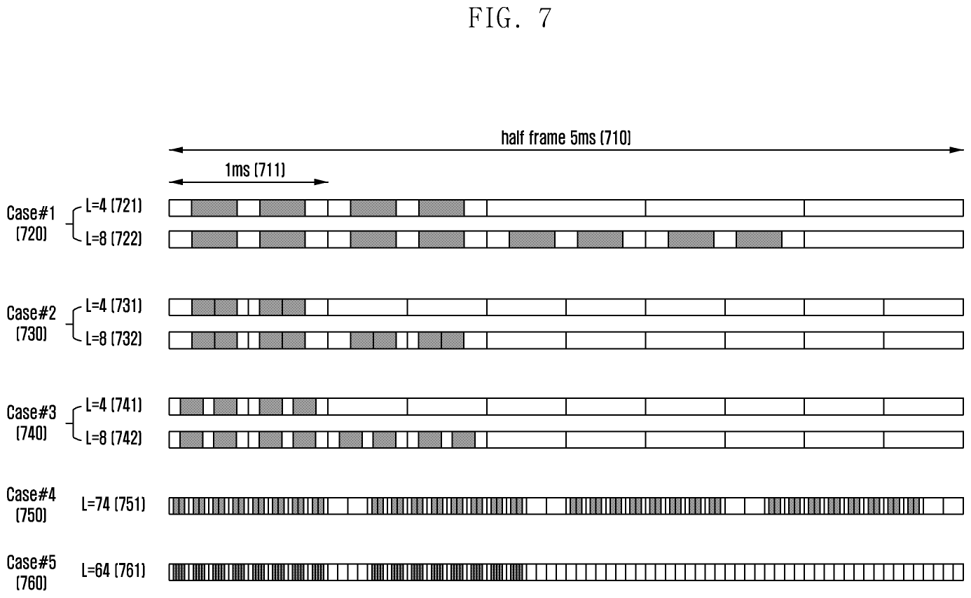

FIG. 7 is a diagram illustrating cases of synchronization signal block transmission according to a subcarrier spacing within 5 ms in the wireless communication system, according to an embodiment of the disclosure.

Referring to FIG. 7, in the 5G communication system, synchronization signal blocks may be transmitted periodically, for example, in units of time intervals 710 of 5 ms (corresponding to 5 subframes or a half frame) and 711 of 1 ms.

In a frequency band of 3 GHz or lower, up to 4 synchronization signal blocks may be transmitted within 5 ms of time 710. In a frequency band higher than 3 GHz and equal to or lower than 6 GHz, up to 8 synchronization signal blocks may be transmitted. In a frequency band higher than 6 GHz, up to 64 synchronization signal blocks may be transmitted. As described above, subcarrier spacings of 15 kHz and 30 kHz may be used at a frequency of 6 GHz or lower.

In examples of FIG. 7, with regard to case #1 720 including one slot with the subcarrier spacing of 15 kHz in FIG. 5, synchronization signal blocks may be mapped to a first slot and a second slot in a frequency band equal to or lower than 3 GHz so that up to 4 synchronization signal blocks 721 may be transmitted, and synchronization signal blocks may be mapped to first, second, third, and fourth slots in a frequency band higher than 3 GHz and equal to or lower than 6 GHz so that up to 8 synchronization signal blocks 722 may be transmitted. With regard to case #2 730 or case #3 740 including two slots with the subcarrier spacing of 30 kHz in FIG. 5, synchronization signal blocks may be mapped starting from a first slot in a frequency band of 3 GHz or lower so that up to 4 synchronization signal blocks 731 or 741 may be transmitted, and synchronization signal blocks may be mapped starting from first and third slots in a frequency band higher than 3 GHz and equal to or lower than 6 GHZ so that up to 8 synchronization signal blocks 732 or 742 may be transmitted.

The subcarrier spacings of 120 kHz and 240 kHz may be used at a frequency higher than 6 GHz. In examples of FIG. 6, with regard to case #4 610 or 750 including two slots with the subcarrier spacing of 120 kHz in FIG. 6, synchronization signal blocks may be mapped starting from 1st, 3rd, 5th, 7th, 11th, 13th, 15th, 17th, 21st, 23rd, 25th, 27th, 31st, 33rd, 35th, and 37th slots in a frequency band higher than 6 GHz so that up to 64 synchronization signal blocks 751 may be transmitted. In examples of FIG. 7, with regard to case #5 620 or 760 including four slots with the subcarrier spacing of 240 kHz in FIG. 6, synchronization signal blocks may be mapped starting from 1st, 5th, 9th, 13th, 21st, 25th, 29th, and 33rd slots in a frequency band higher than 6 GHz so that up to 64 synchronization signal blocks 761 may be transmitted.

A terminal may decode a PDCCH and a PDSCH, based on system information included in a received MIB, and then acquire an SIB. The SIB may include at least one of uplink cell bandwidth-related information, a random-access parameter, a paging parameter, or an uplink power control-related parameter.

In general, the terminal may establish a radio link to a network via a random-access procedure, based on system information and synchronization with the network acquired during a cell search. A contention-based or contention-free scheme may be used for random access. When the terminal performs cell selection and reselection during an initial cell access operation, for example, for the purpose of moving from an RRC_IDLE (RRC idle) state to an RRC_CONNECTED (RRC connected) state, the contention-based random-access scheme may be used. Contention-free random access may be used to re-establish uplink synchronization in a case of downlink data arrival, handover, or positioning. Table 3 below illustrates conditions (events) for triggering a random-access procedure in the 5G system.

TABLE 3

Initial access from RRC_IDLE;
RRC Connection Re-establishment procedure;
DL or UL data arrival during RRC_CONNECTED when UL
synchronisation status is ″non-synchronised″;
UL data arrival during RRC_CONNECTED when there are no
PUCCH resources for SR available;
SR failure;
Request by RRC upon synchronous reconfiguration (e.g., handover);
RRC Connection Resume procedure from RRC_INACTIVE;
To establish time alignment for a secondary TAG;
Request for Other SI;
Beam failure recovery;
Consistent UL LBT failure on SpCell.

Hereinafter, a description will be provided for a measurement time configuration method for radio resource management (RRM) based on a synchronization signal block (SS block or SSB) in the 5G wireless communication system.

The terminal may be configured with MeasObjectNR of MeasObjectToAddModList for SSB-based intra/inter-frequency measurements and CSI-RS-based intra/inter-frequency measurements via higher-layer signaling. For example, MeasObjectNR may be configured as shown in Table 4 below.

```
TABLE 4
  MeasObjectNR ::=  SEQUENCE {
    ssbFrequency ARFCN-ValueNR
OPTIONAL, -- Cond SSBorAssociatedSSB
    ssbSubcarrierSpacing  SubcarrierSpacing
OPTIONAL, -- Cond SSBorAssociatedSSB
    smtc1  SSB-MTC
OPTIONAL, -- Cond SSBorAssociatedSSB
    smtc2  SSB-MTC2
OPTIONAL, -- Cond IntraFreqConnected
    refFreqCSI-RS  ARFCN-ValueNR
OPTIONAL, -- Cond CSI-RS
    referenceSignalConfig  ReferenceSignalConfig,
    absThreshSS-BlocksConsolidation  ThresholdNR
OPTIONAL, -- Need R
    absThreshCSI-RS-Consolidation  ThresholdNR
OPTIONAL, -- Need R
    nrofSS-BlocksToAverage  INTEGER (2..maxNrofSS-
BlocksToAverage)  OPTIONAL, -- Need R
    nrofCSI-RS-ResourcesToAverage  INTEGER (2..maxNrofCSI-
RS-ResourcesToAverage)  OPTIONAL, -- Need R
    quantityConfigIndex  INTEGER
(1..maxNrofQuantityConfig),
    offsetMO  Q-OffsetRangeList,
    cellsToRemoveList  PCI-List
OPTIONAL, -- Need N
    cellsToAddModList  CellsToAddModList
OPTIONAL, -- Need N
    blackCellsToRemoveList  PCI-RangeIndexList
OPTIONAL, -- Need N
    blackCellsToAddModList  SEQUENCE (SIZE
(1..maxNrofPCI-Ranges)) OF PCI-RangeElement OPTIONAL, -- Need N
    whiteCellsToRemoveList  PCI-RangeIndexList
OPTIONAL, -- Need N
    whiteCellsToAddModList  SEQUENCE (SIZE
(1..maxNrofPCI-Ranges)) OF PCI-RangeElement OPTIONAL, -- Need N
    ...,
    [[
    freqBandIndicatorNR  FreqBandIndicatorNR
OPTIONAL, -- Need R
    measCycleSCell  ENUMERATED {sf160, sf256,
sf320, sf512, sf640, sf1024, sf1280} OPTIONAL -- Need R
    ]],
    [[
    smtc3list-r16  SSB-MTC3List-r16
OPTIONAL, -- Need R
    rmtc-Config-r16  SetupRelease {RMTC-Config-r16}
OPTIONAL, -- Need M
    t312-r16  SetupRelease { T312-r16 }
OPTIONAL -- Need M
    ]]
  }
```

The terms in Table 4 may perform the following functions. However, the functions of the terms are not limited to the following.
ssbFrequency: A frequency of a synchronization signal related to MeasObjectNR may be configured.
ssbSubcarrierSpacing: A subcarrier spacing of SSB may be configured.

Only 15 kHz or 30 kHz may be applied for FR1, and only 120 kHz or 240 kHz may be applied for FR2.
smtc1: smtc1 may indicate an SS/PBCH block measurement timing configuration, a primary measurement timing configuration may be configured, and a timing offset and duration for SSB may be configured.
smtc2: A secondary measurement timing configuration for SSB related to MeasObjectNR having a PCI listed in pci-List may be configured.

In addition, SMTC may be configured via other higher-layer signaling. For example, SMTC may be configured for the terminal via reconfigurationWithSync for NR PSCell change and NR PCell change or SIB2 for intra-frequency, inter-frequency, and inter-RAT cell reselection, and SMTC may also be configured for the terminal via SCellConfig for adding an NR SCell.

The terminal may configure a first SS/PBCH block measurement timing configuration (SMTC) according to periodictiyAndOffset (providing periodicity and offset) via smtc1 configured via higher-layer signaling for SSB measurement. In an embodiment of the disclosure, a first subframe of each SMTC occasion may start from a subframe of an SpCell and a system frame number (SFN) which satisfy conditions in Table 5 below.

TABLE 5

SFN mod T = (FLOOR (Offset/10));
if the Periodicity is larger than sf5:
subframe = Offset mod 10;
else:
subframe = Offset or (Offset +5);
with T = CEIL(Periodicity/10).

If smtc2 is configured, for cells indicated by pci-List values of smtc2 in the same MeasObjectNR, the terminal may configure an additional SMTC according to the periodicity of configured smtc2 and the offset and duration of smtc1. In addition, for the same frequency (e.g., a frequency for intra frequency cell reselection) or different frequencies (e.g., frequencies for inter frequency cell reselection), the terminal may be configured with smtc and measure an SSB, via smtc3list for smtc2-LP (with long periodicity) and integrated access and backhaul-mobile termination (IAB-MT). In an embodiment of the disclosure, the terminal may not consider an SSB transmitted in a subframe other than an SMTC occasion for SSB-based RRM measurement in configured ssbFrequency.

A base station may use various multi-transmit/receive point (TRP) operation schemes according to a serving cell configuration and a physical cell identifier (PCI) configuration. When two TRPs at physically distant locations have different PCIs, there may be two methods for operating the two TRPs from among the multi-TRP operation schemes.

### [Operation Method 1]

The two TRPs having different PCIs may be operated by two serving cell configurations.

Based on [operation method 1], the base station may configure channels and signals transmitted from the different TRPs by including same in different serving cell configurations. For example, the respective TRPs may have independent serving cell configurations, and frequency band values of FrequencyInfoDL indicated by DownlinkConfigCommon in the respective serving cell configurations may indicate at least partially overlapping bands. Since the multiple TRPs operate based on multiple ServCellIndex (e.g., ServCellIndex #1 and ServCellIndex #2) values, the respective TRPs may use separate PCIs. For example, the base station may assign one PCI per ServCellIndex.

In the case, when multiple SSBs are transmitted from TRP 1 and TRP 2, the SSBs may have different PCIs (e.g., PCI #1 and PCI #2), and the base station may properly select a ServCellIndex value indicated by a cell parameter in quasi co location (QCL)-Info so as to map a PCI appropriate for each TRP, and may designate an SSB transmitted from one of TRP 1 and TRP 2, as a source RS of QCL configuration information. However, this configuration is to apply, to multiple TRPs, one serving cell configuration available for carrier aggregation (CA) of the terminal, and thus there may be a problem of restricting a degree of freedom of CA configuration or increasing signaling loads.

### [Operation Method 2]

The two TRPs having different PCIs may be operated by one serving cell configuration.

Based on [operation method 2], the base station may configure channels and signals transmitted from different TRPs, via one serving cell configuration. Since the terminal operates based on one ServCellIndex (e.g., ServCellIndex #1), a PCI (e.g., PCI #2) assigned to a second TRP may not be able to be recognized. [Operation method 1] may have a higher degree of freedom of CA configuration when compared to [operation method 1] described above, but when multiple SSBs are transmitted from TRP 1 and TRP 2, the SSBs may have different PCIs (e.g., PCI #1 and PCI #2), and the base station may not be able to map the PCI (e.g., PCI #2) of the second TRP via ServCellIndex indicated by a cell parameter in QCL-Info. The base station may only be able to designate an SSB transmitted from TRP 1, as a source RS of QCL configuration information, and may not be able to designate an SSB transmitted from TRP 2.

As described above, [operation method 1] may enable multi-TRP operation for the two TRPs having different PCIs via an additional serving cell configuration without additional specification support, but [operation method 2] may be operated based on the additional UE capability reporting and base station configuration information described below.

### Relating to UE Capability Reporting for [Operation Method 2]

The terminal may report, to the base station via UE capability, that configuration of an additional PCI other than a PCI of a serving cell is possible from the base station via higher-layer signaling. The UE capability may include two independent numbers of X1 and X2, or each of X1 and X2 may be reported via independent UE capability.
X1 refers to a maximum number of additional PCIs which may be configured for the terminal, and the PCIs may be different from the PCI of the serving cell, wherein the time domain position and periodicity of an SSB corresponding to an additional PCI may be the same as those of the SSB of the serving cell.
X2 refers to a maximum number of additional PCIs which may be configured for the terminal, and the PCIs in this case may be different from the PCI of the serving cell, wherein the time domain position and periodicity of an SSB corresponding to an additional PCI may be different from those of an SSB corresponding to a PCI reported with X1.
Due to the definition, PCIs corresponding to values reported with X1 and X2 may not be configured simultaneously.
Each of the values reported with X1 and X2 that are reported via UE capability reporting may have one integer value from 0 to 7.
For the values reported with X1 and X2, different values may be reported in FR1 and FR2.

### Relating to Higher-Layer Signaling for [Operation Method 2]

The terminal may be configured with SSB-MTCAdditionalPCI-r17, which is higher-layer signaling, from the base station based on the aforementioned UE capability reporting, the higher-layer signaling may at least include multiple additional PCIs having values different from a value of the serving cell, SSB transmission power corresponding to each additional PCI, and ssb-PositionInBurst corresponding to each additional PCI, and the maximum number of configurable additional PCIs may be 7.
For an assumption on an SSB corresponding to an additional PCI having a value different from that of the serving cell, the terminal may assume that a center frequency, a subcarrier spacing, or a subframe number offset for the SSB is the same as that for the SSB of the serving cell.
The terminal may assume that an RS (e.g., SSB or CSI-RS) corresponding to the PCI of the serving cell is always connected to an activated transmission configuration indicator (TCI) state, and when there are one or multiple additionally configured PCIs having a value different from that of the serving cell, the terminal may assume that only one PCI among the PCIs is connected to an activated TCI state.
If the terminal is configured with two different coresetPoolIndex values, an RS corresponding to the serving cell PCI is connected to one or multiple activated TCI states, and an RS corresponding to the additionally configured PCI having a value different from that of the serving cell is connected to one or multiple activated TCI states, the terminal may expect that the activated TCI state(s) connected to the PCI of the serving cell is connected to one coresetPoolIndex out of two, or that the activated TCI state(s) connected to the additionally configured PCI having a value different from that of the serving cell is connected to the remaining one coresetPoolIndex.

Via the higher-layer signaling of the base station and UE capability reporting for [operation method 2] described above, the additional PCI having a value different from that of the PCI of the serving cell may be configured. When the configuration is absent, an SSB corresponding to the additional PCI having a value different from that of the PCI of the serving cell unable to be designated by a source RS may be used for the purpose of designation as a source RS of QCL configuration information. In addition, the SSB corresponding to the additional PCI may be used to serve as a QCL source RS to support operation of multiple TRPs having different PCIs, unlike an SSB which may be configured to be used for purposes of, such as RRM, mobility, or handover, similarly to configuration information on an SSB which may be configured in smtc1 and smtc2 of higher-layer signaling.

Subsequently, a demodulation reference signal (DMRS) that is one of reference signals in the 5G system will be described.

A DMRS may include multiple DMRS ports, and each of the ports maintains orthogonality by using code division multiplexing (CDM) or frequency division multiplexing (FDM) so as to prevent interference with each other. However, the term for DMRS may be expressed in other terms depending on a user's intention and the purpose of using a reference signal. The term DMRS merely provides a specific example to easily describe the technical content of the disclosure and to help understanding of the disclosure, and is not intended to limit the scope of the disclosure. In other words, it is apparent to those skilled in the art belonging to the disclosure, that the disclosure can be implemented for any reference signal based on the technical idea of the disclosure.

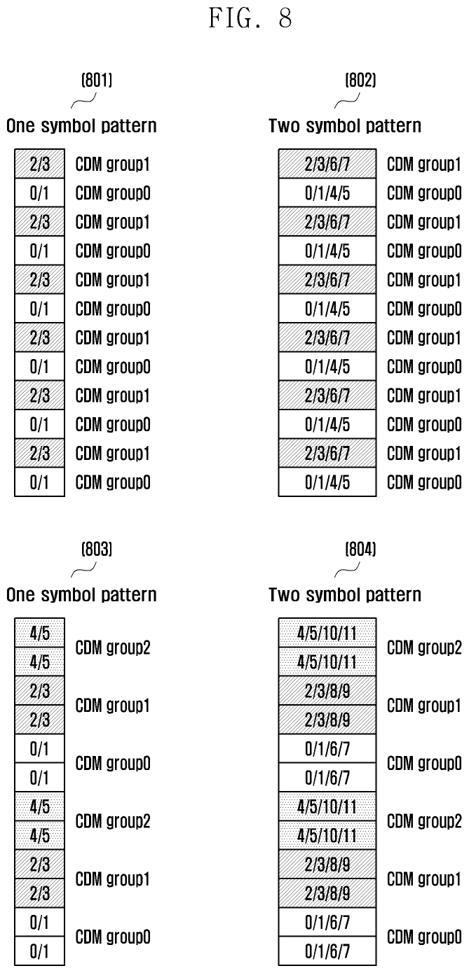

FIG. 8 is a diagram illustrating DMRS patterns (type1 and type2) used for communication between a base station and a terminal in the 5G system according to an embodiment of the disclosure. Two DMRS patterns may be supported in the 5G system. FIG. 8 illustrates two DMRS patterns.

Referring to FIG. 8, reference numerals 801 and 802 correspond to DMRS type1, where reference numeral 801 indicates a 1-symbol pattern and reference numeral 802 indicates a 2-symbol pattern. DMRS type 1 of reference numerals 801 and 802 is a DMRS pattern with a comb 2 structure and may include two CDM groups, and different CDM groups may be FDMed.

In the 1-symbol pattern 801, CDM on frequency may be applied to the same CDM group so that 2 DMRS ports may be distinguished, and therefore a total of 4 orthogonal DMRS ports may be configured. The 1-symbol pattern 801 may include DMRS port IDs mapped to respective CDM groups (e.g., a DMRS port ID for downlink may be indicated by an illustrated number+1000). In the 2-symbol pattern 802, CDM on time/frequency may be applied to the same CDM group so that 4 DMRS ports may be distinguished, and therefore a total of 8 orthogonal DMRS ports may be configured. The 2-symbol pattern 802 may include DMRS port IDs mapped to respective CDM groups (e.g., a DMRS port ID for downlink may be indicated by an illustrated number+1000).

DMRS type 2 illustrated in reference numerals 803 and 804 is a DMRS pattern with a structure in which frequency domain orthogonal cover codes (FD-OCCs) are applied to a subcarrier adjacent on frequency, and may include three CDM groups, and different CDM groups may be FDMed.

In the 1-symbol pattern 803, CDM on frequency may be applied to the same CDM group so that 2 DMRS ports may be distinguished, and therefore a total of 6 orthogonal DMRS ports may be configured. The 1-symbol pattern 803 may include DMRS port IDs mapped to respective CDM groups (e.g., a DMRS port ID for downlink may be indicated by an illustrated number+1000). In the 2-symbol pattern 704, CDM on time/frequency may be applied to the same CDM group so that 4 DMRS ports may be distinguished, and therefore a total of 12 orthogonal DMRS ports may be configured. The 2-symbol pattern 804 may include DMRS port IDs mapped to respective CDM groups (e.g., a DMRS port ID for downlink may be indicated by an illustrated number+1000).

As described above, in the NR system, two different DMRS patterns (e.g., the DMRS patterns 801 and 802, or the DMRS patterns 803 and 804) may be configured, and whether each DMRS pattern is a one-symbol pattern 801 or 803 or is an adjacent two-symbol pattern 802 or 804 may also be configured. In addition, in the NR system, not only a DMRS port number may be scheduled, but also the number of CDM groups scheduled together for PDSCH rate matching may be configured and signaled. In addition, for cyclic prefix-based orthogonal frequency division multiplexing (CP-OFDM), both the aforementioned two DMRS patterns may be supported in DL and UL, and for discrete Fourier transform spread OFDM (DFT-S-OFDM), only DMRS type1 among the aforementioned DMRS patterns may be supported in UL.

In addition, an additional DMRS may be supported to be configurable. A front-loaded DMRS may refer to a first DMRS transmitted and received in a front-most symbol in the time domain from among DMRSs, and an additional DMRS may refer to a DMRS transmitted and received in a symbol after the front-loaded DMRS in the time domain. In the NR system, the number of additional DMRSs may be configured to be a minimum of 0 to a maximum of 3. In addition, when an additional DMRS is configured, the same pattern as that of the front-loaded DMRS may be assumed. In an embodiment of the disclosure, when information on whether the described DMRS pattern type for the front-loaded DMRS is type 1 or type 2, information on whether the DMRS pattern is a one-symbol pattern or is an adjacent two-symbol pattern, and information on a DMRS port and the number of CDM groups used are indicated, in a case where an additional DMRS is further configured, it may be assumed that the additional DMRS is configured with the same DMRS information as that for the front-loaded DMRS.

In an embodiment of the disclosure, the downlink DMRS configuration described above may be configured via RRC signaling as shown in Table 6 below.

TABLE 6

```
  DMRS-DownlinkConfig ::=  SEQUENCE {
  dmrs-Type  ENUMERATED {type2}  OPTIONAL, --
Need S
  dmrs-AdditionalPosition ENUMERATED {pos0, pos1, pos3}
OPTIONAL, -- Need S
  maxLength  ENUMERATED {len2}  OPTIONAL, --
Need S
  scramblingID0  INTEGER (0..65535) OPTIONAL, --
Need S
  scramblingID1  INTEGER (0..65535) OPTIONAL, --
Need S
  phaseTrackingRS  SetupRelease {PTRS-DownlinkConfig}
OPTIONAL, -- Need M
    ...
  }
```

Here, dmrs-Type may configure a DMRS type, dmrs-AdditionalPosition may configure additional DMRS OFDM symbols, maxLength may configure a 1-symbol DMRS pattern or a 2-symbol DMRS pattern, scramblingID0 and scramblingID1 may configure scrambling IDs, and phaseTrackingRS may configure a phase tracking reference signal (PTRS).

In addition, the uplink DMRS configuration described above may be configured via RRC signaling as shown in Table 7 below.

```
TABLE 7
  DMRS-UplinkConfig ::= SEQUENCE {
    dmrs-Type ENUMERATED {type2} OPTIONAL, --
Need S
    dmrs-AdditionalPosition  ENUMERATED {pos0, pos1, pos3}
OPTIONAL, -- Need R
    phaseTrackingRS  SetupRelease { PTRS-UplinkConfig }
OPTIONAL, -- Need M
    maxLength  ENUMERATED {len2}  OPTIONAL,
-- Need S
    transformPrecodingDisabled SEQUENCE {
      scramblingID0  INTEGER (0..65535)  OPTIONAL,
-- Need S
      scramblingID1  INTEGER (0..65535)  OPTIONAL,
-- Need S
      ...
    }  OPTIONAL, -- Need R
    transformPrecodingEnabled SEQUENCE {
      nPUSCH-Identity  INTEGER (0..1007)
OPTIONAL, -- Need S
      sequenceGroupHopping ENUMERATED {disabled}
OPTIONAL, -- Need S
      sequenceHopping  ENUMERATED {enabled}
OPTIONAL, -- Need S
      ...
    }  OPTIONAL, -- Need R
    ...
  }
```

Here, dmrs-Type may configure a DMRS type, dmrs-AdditionalPosition may configure additional DMRS OFDM symbols, phaseTrackingRS may configure a PTRS, and maxLength may configure a 1-symbol DMRS pattern or a 2-symbol DMRS pattern. scramblingID0 and scramblingID1 may configure scrambling ID0s, nPUSCH-Identity may configure a cell ID for DFT-s-OFDM, sequenceGroupHopping may disable sequence group hopping, and sequenceHopping may enable sequence hopping.

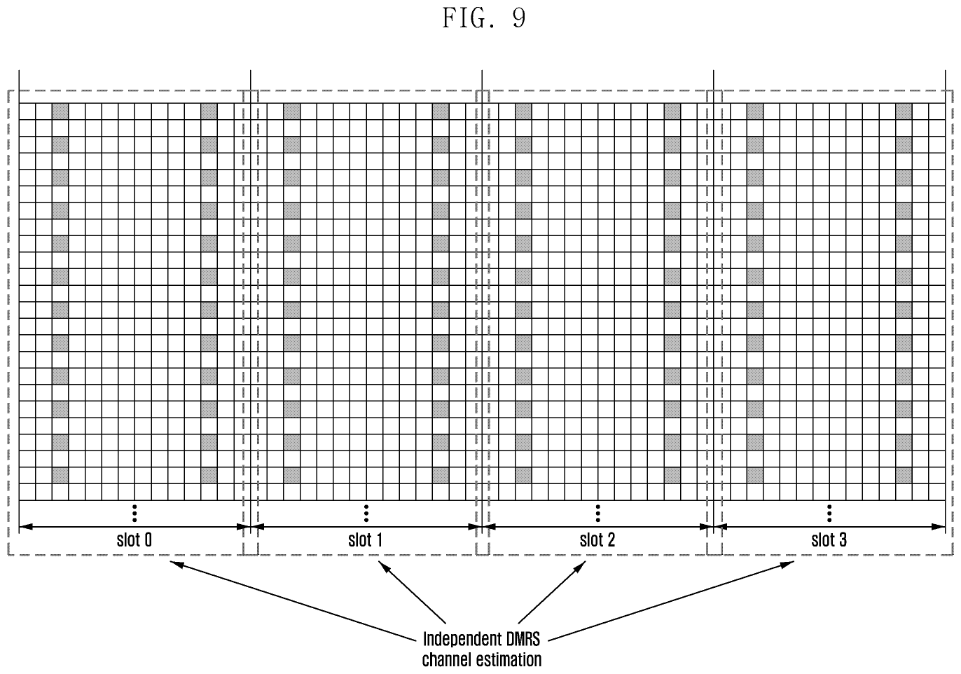

FIG. 9 is a diagram illustrating channel estimation using a DMRS received on one PUSCH in a time band of the 5G system according to an embodiment of the disclosure.

Referring to FIG. 9, when performing channel estimation for data decoding using a DMRS, the channel estimation may be performed within a precoding resource block group (PRG), which is a corresponding bundling unit, by using physical resource block (PRB) bundling linked to a system band in a frequency band. In addition, channel estimation is performed by assuming that, in the time unit, only DMRSs received on one PUSCH have the same precoding.

Hereinafter, a description will be provided for a time domain resource allocation (TDRA) method for a data channel in the 5G communication system. A base station may configure, for a terminal via higher-layer signaling (e.g., RRC signaling), a time domain resource allocation information table for a downlink data channel (physical downlink shared channel (PDSCH)) and an uplink data channel (physical uplink shared channel (PUSCH)).

The base station may configure a table including up to maxNrofDL-Allocations=17 entries for a PDSCH, and may configure a table including up to maxNrofUL-Allocations=17 entries for a PUSCH. The time domain resource allocation information may include, for example, at least one of PDCCH-to-PDSCH slot timing (denoted as KO, and corresponding to a time interval in units of slots between a time point at which a PDCCH is received and a time point at which a PDSCH scheduled by the received PDCCH is transmitted), PDCCH-to-PUSCH slot timing (denoted as K2, and corresponding to a time interval in units of slots between a time point at which a PDCCH is received and a time point at which a PUSCH scheduled by the received PDCCH is transmitted), information on a position and a length of a start symbol in which the PDSCH or PUSCH is scheduled within a slot, a mapping type of the PDSCH or PUSCH, or the like.

In an embodiment of the disclosure, the time domain resource allocation information for the PDSCH may be configured for the terminal via RRC signaling as shown in Table 8 below.

TABLE 8
PDSCH-TimeDomainResourceAllocationList information element

```
  PDSCH-TimeDomainResourceAllocationList ::= SEQUENCE
(SIZE(1..maxNrofDL-Allocations)) OF PDSCH-
TimeDomainResourceAllocation
  PDSCH-TimeDomainResourceAllocation ::= SEQUENCE {
    k0  INTEGER(0..32)  OPTIONAL, -- Need
S
  mappingType  ENUMERATED {typeA, typeB},
  startSymbolAndLength  INTEGER (0..127)
  repetitionNumber  ENUMERATED {n2, n3, n4, n5, n6, n7, n8,
n16} OPTIONAL, -- Cond Formats1-0and1-1
  }
```

Here, k0 may indicate PDCCH-to-PDSCH timing (i.e., a slot offset between downlink control information (DCI) and the scheduled PDSCH) in slot units, mappingType may indicate a PDSCH mapping type, startSymbolAndLength may indicate a start symbol and a length of the PDSCH, and repetitionNumber may indicate the number of PDSCH transmission occasions according to a slot-based repetition scheme.

In an embodiment of the disclosure, the time domain resource allocation information for the PUSCH may be configured for the terminal via RRC signaling as shown in Table 9 below.

TABLE 9
PUSCH-TimeDomainResourceAllocation information element

```
  PUSCH-TimeDomainResourceAllocationList ::= SEQUENCE
(SIZE(1..maxNrofUL-Allocations)) OF PUSCH-
TimeDomainResourceAllocation
  PUSCH-TimeDomainResourceAllocation ::= SEQUENCE {
    k2  INTEGER(0..32)   OPTIONAL, -- Need
S
  mappingType ENUMERATED {typeA, typeB},
    startSymbolAndLength  INTEGER (0..127)
  }
  PUSCH-Allocation-r16 ::= SEQUENCE {
    mappingType-r16  ENUMERATED {typeA, typeB}
OPTIONAL, -- Cond NotFormat01-02-Or-TypeA
    startSymbolAndLength-r16 INTEGER (0..127)  OPTIONAL, --
Cond NotFormat01-02-Or-TypeA
    startSymbol-r16  INTEGER (0..13)   OPTIONAL, -- Cond
RepTypeB
    length-r16  INTEGER (1..14)   OPTIONAL, -- Cond
RepTypeB
    numberOfRepetitions-r16 ENUMERATED {n1, n2, n3, n4, n7, n8,
n12, n16} OPTIONAL, -- Cond Format01-02
    ...
  }
```

Here, k2 may indicate PDCCH-to-PUSCH timing (i.e., a slot offset between DCI and the scheduled PUSCH) in units of slots, mappingType may indicate a PUSCH mapping type, startSymbolAndLength or StartSymbol and length may indicate a start symbol and a length of the PUSCH, and numberOfRepetitions may indicate the number of repetitions applied to PUSCH transmission.

The base station may indicate at least one entry in the time domain resource allocation information table to the terminal via L1 signaling (e.g., downlink control information (DCI)) (for example, the indication may be made via “time domain resource allocation” in DCI). The terminal may acquire the time domain resource allocation information for the PDSCH or PUSCH, based on the DCI received from the base station.

Hereinafter, transmission of an uplink data channel (physical uplink shared channel (PUSCH)) in the 5G system will be described. PUSCH transmission may be dynamically scheduled by a UL grant in the DCI (e.g., dynamic grant (DG)-PUSCH) or may be scheduled by configured grant Type 1 or configured grant Type 2 (e.g., configured grant (CG)-PUSCH). Dynamic scheduling for PUSCH transmission may be indicated by, for example, DCI format 0_0 or 0_1.

PUSCH transmission of configured grant type 1 may be configured semi-statically via reception of configuredGrantConfig including rrc-ConfiguredUplinkGrant in Table 10, via higher-layer signaling without reception of the UL grant in the DCI. PUSCH transmission of configured grant type 2 may be scheduled semi-persistently based on the UL grant in the DCI after receiving configuredGrantConfig that does not include rrc-ConfiguredUplinkGrant in Table 10 via higher-layer signaling.

In an embodiment of the disclosure, when PUSCH transmission is scheduled by the configured grant, parameters applied to the PUSCH transmission may be configured via configuredGrantConfig which is higher-layer signaling in Table 10, except for specific parameters (e.g., dataScramblingIdentityPUSCH, txConfig, codebookSubset, maxRank, or scaling of UCI-OnPUSCH) provided via pusch-Config in Table 11, which is higher-layer signaling. For example, if the terminal receives transformPrecoder in configuredGrantConfig which is higher-layer signaling in Table 10, the terminal may apply tp-pi2BPSK in pusch-Config of Table 11 to PUSCH transmission operated by the configured grant.

TABLE 10
ConfiguredGrantConfig

```
  ConfiguredGrantConfig ::=  SEQUENCE {
    frequencyHopping  ENUMERATED {intraSlot, interSlot}
OPTIONAL, -- Need S,
    cg-DMRS-Configuration DMRS-UplinkConfig,
    mcs-Table  ENUMERATED {qam256, qam64LowSE}
OPTIONAL, -- Need S
    mcs-TableTransformPrecoder ENUMERATED {qam256,
qam64LowSE}  OPTIONAL, -- Need S
    uci-OnPUSCH  SetupRelease { CG-UCI-OnPUSCH }
OPTIONAL, -- Need M
    resourceAllocation  ENUMERATED { resourceAllocationType0,
resourceAllocationType1, dynamicSwitch },
    rbg-Size  ENUMERATED {config2}
OPTIONAL, -- Need S
    powerControlLoopToUse  ENUMERATED {n0, n1},
    p0-PUSCH-Alpha  P0-PUSCH-AlphaSetId,
    transformPrecoder  ENUMERATED {enabled, disabled}
OPTIONAL, -- Need S
    nrofHARQ-Processes  INTEGER(1..17),
    repK  ENUMERATED {n1, n2, n4, n8},
    repK-RV  ENUMERATED {s1-0231, s2-0303, s3-0000}
OPTIONAL, -- Need R
    periodicity  ENUMERATED {
    sym2, sym7, sym1x14, sym2x14, sym4x14, sym5x14, sym8x14,
sym10x14, sym17x14, sym20x14,
    sym32x14, sym40x14, sym64x14, sym80x14, sym128x14,
sym170x14, sym256x14, sym320x14, sym512x14,
    sym640x14, sym1024x14, sym1280x14, sym2560x14,
sym5120x14,
    sym6, sym1x12, sym2x12, sym4x12, sym5x12, sym8x12,
sym10x12, sym17x12, sym20x12, sym32x12,
    sym40x12, sym64x12, sym80x12, sym128x12, sym170x12,
sym256x12, sym320x12, sym512x12, sym640x12,
    sym1280x12, sym2560x12
    },
    configuredGrantTimer  INTEGER (1..64)
OPTIONAL, -- Need R
    rrc-ConfiguredUplinkGrant  SEQUENCE {
      timeDomainOffset  INTEGER (0..5119),
      timeDomainAllocation  INTEGER (0..16),
      frequencyDomainAllocation  BIT STRING (SIZE(18)),
      antennaPort  INTEGER (0..31),
      dmrs-SeqInitialization   INTEGER (0..1)
OPTIONAL, -- Need R
      precodingAndNumberOfLayers   INTEGER (0..63),
      srs-ResourceIndicator   INTEGER (0..16)
OPTIONAL, -- Need R
      mcsAndTBS   INTEGER (0..31),
      frequencyHoppingOffset   INTEGER (1..
maxNrofPhysicalResourceBlocks-1) OPTIONAL, -- Need R
      pathlossReferenceIndex   INTEGER
(0..maxNrofPUSCH-PathlossReferenceRSs-1),
      ...
    }  OPTIONAL, -- Need R
    ...
  }
```

Next, a PUSCH transmission method is described. A DMRS antenna port for PUSCH transmission may be the same as an antenna port for sounding reference signal (SRS) transmission. PUSCH transmission may follow each of a codebook-based transmission method and a non-codebook-based transmission method, depending on whether a value of txConfig in pusch-Config of Table 7, which is higher signaling, is “codebook” or “nonCodebook”. As described above, PUSCH transmission may be dynamically scheduled via DCI format 0_0 or 0_1, and may be semi-statically configured by the configured grant.

If the terminal is indicated with scheduling for PUSCH transmission via DCI format 0_0, the terminal may perform beam configuration for PUSCH transmission, by using pucch-spatialRelationInfoID corresponding to a UE-specific (dedicated) PUCCH resource having a lowest ID within an activated uplink bandwidth part (BWP) in a serving cell. In an embodiment of the disclosure, PUSCH transmission may be performed based on a single antenna port. The terminal may not expect scheduling for PUSCH transmission via DCI format 0_0, within a BWP for which a PUCCH resource including pucch-spatialRelationInfo is not configured. If the terminal is not configured with txConfig in pusch-Config of Table 11, the terminal may not expect to be scheduled via DCI format 0_1.

TABLE 11
PUSCH-Config

```
    PUSCH-Config ::=  SEQUENCE {
      dataScramblingIdentityPUSCH  INTEGER (0..1023)
OPTIONAL, -- Need S
      txConfig  ENUMERATED {codebook, nonCodebook}
OPTIONAL, -- Need S
      dmrs-UplinkForPUSCH-MappingTypeA SetupRelease { DMRS-
UplinkConfig } OPTIONAL, -- Need M
      dmrs-UplinkForPUSCH-MappingTypeB SetupRelease { DMRS-
UplinkConfig } OPTIONAL, -- Need M
      pusch-PowerControl  PUSCH-PowerControl
OPTIONAL, -- Need M
      frequencyHopping  ENUMERATED {intraSlot,
interSlot} OPTIONAL, -- Need S
      frequencyHoppingOffsetLists SEQUENCE (SIZE (1..4)) OF
INTEGER (1.. maxNrofPhysicalResourceBlocks-1) OPTIONAL, -- Need
M
      resourceAllocation  ENUMERATED
{ resourceAllocationType0, resourceAllocationType1, dynamicSwitch},
      pusch-TimeDomainAllocationList  SetupRelease { PUSCH-
TimeDomainResourceAllocationList } OPTIONAL, -- Need M
      pusch-AggregationFactor  ENUMERATED { n2, n4, n8 }
OPTIONAL, -- Need S
      mcs-Table  ENUMERATED {qam256, qam64LowSE}
OPTIONAL, -- Need S
      mcs-TableTransformPrecoder ENUMERATED {qam256,
qam64LowSE} OPTIONAL, -- Need S
      transformPrecoder  ENUMERATED {enabled, disabled}
OPTIONAL, -- Need S
      codebookSubset ENUMERATED
{fully AndPartialAndNonCoherent, partialAndNonCoherent, nonCoherent}
        OPTIONAL, -- Cond codebookBased
      maxRank  INTEGER (1..4)  OPTIONAL, --
Cond codebookBased
      rbg-Size  ENUMERATED { config2}
OPTIONAL, -- Need S
      uci-OnPUSCH  SetupRelease { UCI-OnPUSCH}
OPTIONAL, -- Need M
      tp-pi2BPSK  ENUMERATED {enabled}
OPTIONAL, -- Need S
      ...
  }
```

Next, codebook-based PUSCH transmission is described. Codebook-based PUSCH transmission may be dynamically scheduled via DCI format 0_0 or 0_1 and may operate semi-statically by a configured grant. If scheduling is performed dynamically by codebook-based PUSCH DCI format 0_1 or configuration is performed semi-statically by the configured grant, the terminal may determine a precoder for PUSCH transmission, based on an SRS resource indicator (SRI), a transmission precoding matrix indicator (TPMI), and a transmission rank (the number of PUSCH transmission layers).

In an embodiment of the disclosure, an SRI may be given via a field of SRS resource indicator in DCI, or may be configured via srs-ResourceIndicator which is higher signaling. The terminal may be configured with at least one SRS resource during codebook-based PUSCH transmission, and for example, up to two SRS resources may be configured. When the terminal is provided with the SRI via the DCI, an SRS resource indicated by the SRI may refer to an SRS resource corresponding to the SRI from among SRS resources transmitted before a PDCCH including the SRI. In addition, the TPMI and the transmission rank may be given via a field of precoding information and number of layers in the DCI, or may be configured via precodingAndNumberOfLayers which is higher signaling. The TPMI may be used to indicate the precoder applied to PUSCH transmission.

The precoder to be used for PUSCH transmission may be selected from an uplink codebook having the same number of antenna ports as a value of nrofSRS-Ports in SRS-Config which is higher signaling. In codebook-based PUSCH transmission, the terminal may determine a codebook subset, based on the TPMI and codebookSubset in pusch-Config which is higher signaling. In an embodiment of the disclosure, codebookSubset in pusch-Config which is higher signaling may be configured to be one of “fullyAndPartialAndNonCoherent”, “partialAndNonCoherent”, or “nonCoherent”, based on UE capability reported to the base station by the terminal.

If the terminal has reported “partialAndNonCoherent” via the UE capability, the terminal may not expect that a value of codebookSubset which is higher signaling is configured to be “fullyAndPartialAndNonCoherent”. In addition, if the terminal has reported “nonCoherent” via the UE capability, the terminal may not expect that the value of codebookSubset which is higher signaling is configured to be “fullyAndPartialAndNonCoherent” or “partialAndNonCoherent”. If nrofSRS-Ports in SRS-ResourceSet which is higher signaling indicates two SRS antenna ports, the terminal may not expect that the value of codebookSubset which is higher signaling is configured to be “partialAndNonCoherent”.

The terminal may be configured with one SRS resource set in which a value of usage in SRS-ResourceSet that is higher signaling is configured to be “codebook”, and one SRS resource in the SRS resource set may be indicated via the SRI. If multiple SRS resources are configured in the SRS resource set in which the usage value in SRS-ResourceSet that is higher signaling is configured to be “codebook”, the terminal may expect that the value of nrofSRS-Ports in SRS-Resource which is higher signaling is configured to be the same for all SRS resources.

The terminal transmits one or multiple SRS resources included in the SRS resource set, in which the value of usage is configured to be “codebook”, to the base station according to higher signaling, and the base station may select one of the SRS resources transmitted by the terminal and indicate the terminal to perform PUSCH transmission using transmission beam information of the corresponding SRS resource. In an embodiment of the disclosure, in codebook-based PUSCH transmission, the SRI may be used as information for selection of an index of one SRS resource, and may be included in the DCI. Additionally, the base station includes, in the DCI, information indicating the TPMI and rank to be used for PUSCH transmission by the terminal, so as to transmit the information. The terminal may use the SRS resource indicated by the SRI to perform PUSCH transmission by applying the precoder indicated by the TPMI and the rank, which has been indicated based on a transmission beam of the SRS resource.

Next, non-codebook-based PUSCH transmission is described. Non-codebook-based PUSCH transmission may be dynamically scheduled via DCI format 0_0 or 0_1, or may be performed semi-statically by the configured grant. When at least one SRS resource is configured in an SRS resource set in which the value of usage in SRS-ResourceSet that is higher signaling is configured to be “nonCodebook”, the terminal may be scheduled for non-codebook-based PUSCH transmission via DCI format 0_1.

For the SRS resource set in which the value of usage in SRS-ResourceSet that is higher signaling is configured to be “nonCodebook”, the terminal may be configured with a non-zero power (NZP) CSI-RS resource associated with one SRS resource set. The terminal may perform calculation on a precoder for SRS transmission via measurement on the NZP CSI-RS resource configured in association with the SRS resource set. If the difference between a last reception symbol of an aperiodic NZP CSI-RS resource associated with the SRS resource set and a first symbol of aperiodic SRS transmission in the terminal is smaller than a specific number of symbols (e.g., 42 symbols), the terminal may not expect updating of information on the precoder for SRS transmission.

If a value of resourceType in SRS-ResourceSet which is higher signaling is configured to be “aperiodic”, the NZP CSI-RS associated with SRS-ResourceSet may be indicated by an SRS request which is a field in DCI format 0_1 or 1_1. In an embodiment of the disclosure, a case in which an NZP CSI-RS resource associated with SRS-ResourceSet is an aperiodic NZP CSI resource, and the value of the SRS request which is a field in DCI format 0_1 or 1_1 is not “00” may indicate the presence of the NZP CSI-RS resource associated with SRS-ResourceSet. The DCI may indicate neither a cross carrier nor cross BWP scheduling. If the value of the SRS request indicates the presence of an NZP CSI-RS, the NZP CSI-RS may be located in a slot in which a PDCCH including the SRS request field is transmitted. TCI states configured in scheduled subcarriers may not be configured to be QCL-TypeD.

If a periodic or semi-persistent SRS resource set is configured, an NZP CSI-RS associated with the SRS resource set may be indicated via associatedCSI-RS in SRS-ResourceSet which is higher signaling. For non-codebook-based transmission, the terminal may not expect that spatialRelationInfo, which is higher signaling for the SRS resource, and associatedCSI-RS in SRS-ResourceSet, which is higher signaling, are configured together.

When multiple SRS resources are configured, the terminal may determine the transmission rank and precoder to be applied to PUSCH transmission, based on the SRI indicated by the base station. In an embodiment of the disclosure, the SRI may be indicated via the field of SRS resource indicator in the DCI or may be configured via srs-ResourceIndicator which is higher signaling. Similar to the aforementioned codebook-based PUSCH transmission, when the terminal is provided with the SRI via the DCI, an SRS resource indicated by the SRI may refer to an SRS resource corresponding to the SRI from among SRS resources transmitted before the PDCCH including the SRI. The terminal may use one or multiple SRS resources for SRS transmission, and the maximum number of SRS resources simultaneously transmittable in the same symbol within one SRS resource set may be determined by UE capability reported to the base station by the terminal. The SRS resources simultaneously transmitted by the terminal may occupy the same RB. The terminal may configure one SRS port for each SRS resource. Only one SRS resource set, in which the value of usage in SRS-ResourceSet that is higher signaling is configured to be “nonCodebook”, may be configured, and configuration of up to 4 SRS resources for non-codebook-based PUSCH transmission may be possible.

The base station may transmit one NZP CSI-RS associated with the SRS resource set to the terminal, and the terminal may calculate, based on a result of measurement at reception of the NZP CSI-RS, a precoder to be used at transmission of one or multiple SRS resources in the SRS resource set. The terminal may apply the calculated precoder when transmitting, to the base station, one or multiple SRS resources in the SRS resource set in which usage is configured to be “nonCodebook”, and the base station may select one or multiple SRS resources from among the received one or multiple SRS resources. In non-codebook-based PUSCH transmission, the SRI may indicate an index which may represent one SRS resource or a combination of multiple SRS resources, and the SRI may be included in DCI. The number of SRS resources indicated by the SRI transmitted by the base station may be the number of PUSCH transmission layers, and the terminal may perform PUSCH transmission by applying, to each layer, the precoder applied to SRS resource transmission.

Hereinafter, description will be provided for a method of repeated uplink data channel (PUSCH) transmission and single transport block (TB) transmission via multiple slots in the 5G system. The 5G system may support two types of repeated transmission methods for an uplink data channel (e.g., repeated PUSCH transmission type A and repeated PUSCH transmission type B) and TB processing over multi-slot PUSCH (TBOMS) for multi-PUSCH transmission in which a single TB is transmitted over multiple slots. In addition, the terminal may be configured with one of repeated PUSCH transmission type A or B via higher-layer signaling. In addition, the terminal may be configured with “numberOfSlotsTBOMS” via a resource allocation table so as to transmit TBoMS.

### Repeated PUSCH Transmission Type A

As described above, the start symbol and length of an uplink data channel may be determined by a method of time domain resource allocation in one slot, and the base station may transmit the number of repeated transmissions, to the terminal via higher-layer signaling (e.g., RRC signaling) or L1 signaling (e.g., DCI). The number N of slots configured by numberOfSlotsTBoMS for TBS determination may be 1.
The terminal may repeatedly transmit, in consecutive slots, an uplink data channel which has the same start symbol and length as those of the configured uplink data channel, based on the number of repeated transmissions received from the base station. In an embodiment of the disclosure, when at least one symbol among symbols in a slot configured as downlink by the base station for the terminal or in a slot for repeated uplink data channel transmission configured for the terminal is configured for downlink, the terminal may skip uplink data channel transmission in the corresponding slot. For example, the terminal may not transmit the uplink data channel within the number of repeated uplink data channel transmissions. On the other hand, the terminal which supports Rel-17 repeated uplink data transmission may determine that a slot available for repeated uplink data transmission is an available slot, and may count the number of transmissions during repeated uplink data channel transmission in the slot determined to be the available slot. When repeated uplink data channel transmission in the slot determined to be the available slot is skipped, the terminal may perform repeated transmission via a slot available for transmission after postponing. By using Table 12 below, a redundancy version may be applied according to a redundancy version pattern configured for each n-th PUSCH transmission occasion.

### Repeated PUSCH Transmission Type B

As described above, the start symbol and length of the uplink data channel may be determined by the method of time domain resource allocation in one slot, and the base station may notify the terminal of the number of repeated transmissions, numberofrepetitions, via higher signaling (e.g., RRC signaling) or L1 signaling (e.g., DCI). In an embodiment of the disclosure, the number N of slots configured by numberOfSlotsTBoMS for TBS determination may be 1.
First, nominal repetition of the uplink data channel may be determined as follows, based on the configured start symbol and length of the uplink data channel. Here, nominal repetition may refer to a resource of a symbol which the base station has configured for repeated PUSCH transmission, and the terminal may determine a resource available for uplink in the configured nominal repetition. In this case, a slot in which an n-th nominal repetition starts may be given by

$${K}_{s} + ⌊ \frac{S + n \cdot L}{{N}_{symb}^{slot}} ⌋ ,$$

and a symbol in which the nominal repetition starts in the start slot may be given by mod (S+n·L, N_{symb}^{slot}). A slot in which the n-th nominal repetition ends may be given by

$${K}_{s} + ⌊ \frac{S + ( n + 1 ) \cdot L - 1}{{N}_{symb}^{slot}} ⌋ ,$$

and a symbol in which the nominal repetition ends in the last slot may be given by mod (S+(n+1)·L−1, N_{symb}^{slot}). Here, n=0, 1, . . . numberofrepetitions−1, S may denote the configured start symbol of the uplink data channel, and L may denote the configured symbol length of the uplink data channel. Ks may denote a slot in which PUSCH transmission starts, and N_{symb}^{slot} may denote the number of symbols per slot.
The terminal may determine an invalid symbol for repeated PUSCH transmission type B. A symbol configured as downlink by tdd-UL-DL-ConfigurationCommon or tdd-UL-DL-ConfigurationDedicated may be determined to be an invalid symbol for repeated PUSCH transmission type B. Additionally, an invalid symbol may be configured based on a higher-layer parameter (e.g., InvalidSymbolPattern). For example, the higher-layer parameter (e.g., InvalidSymbolPattern) may provide a symbol-level bitmap in one slot or over two slots so that an invalid symbol may be configured. In an embodiment of the disclosure, an indication of 1 in a bitmap may represent an invalid symbol. In addition, the periodicity and pattern of the bitmap may be configured via a higher-layer parameter (e.g., periodicityAndPattern). If the higher-layer parameter (e.g., InvalidSymbolPattern) is configured, and parameter InvalidSymbolPatternIndicator-ForDCIFormat0_1 or parameter InvalidSymbolPatternIndicator-ForDCIFormat0_2 indicates 1, the terminal may apply an invalid symbol pattern, and if the parameter indicates 0, the terminal may not apply an invalid symbol pattern. Alternatively, if the higher-layer parameter (e.g., InvalidSymbolPattern) is configured, and parameter InvalidSymbolPatternIndicator-ForDCIFormat0_1 or parameter InvalidSymbolPatternIndicator-ForDCIFormat0_2 is not configured, the terminal may apply an invalid symbol pattern.
After invalid symbols are determined in respective nominal repetitions, the terminal may consider, as valid symbols, symbols other than the determined invalid symbols. If one or more valid symbols are included in each nominal repetition, the nominal repetition may include one or more actual repetitions. Here, each actual repetition may refer to a symbol actually used for repeated PUSCH transmission from among symbols configured as the configured nominal repetition, and may include consecutive sets of valid symbols available for repeated PUSCH transmission type B in one slot. The terminal may skip actual repetition transmission when an actual repetition having one symbol is configured to be valid, except for a case where the configured symbol length of the uplink data channel is 1 (L=1). By using Table 8 below, a redundancy version may be applied according to a redundancy version pattern configured for each n-th actual repetition.

### TB Processing Over Multiple Slots (TBoMS)

As described above, the start symbol and length of an uplink data channel may be determined by a method of time domain resource allocation in one slot, and the base station may transmit the number of repeated transmissions, to the terminal via higher-layer signaling (e.g., RRC signaling) or L1 signaling (e.g., DCI). In an embodiment of the disclosure, a TBS may be determined using an N value greater than or equal to 1, which is the number of slots configured via numberOfSlotsTBoMS.
The terminal may transmit, in consecutive slots, an uplink data channel which has the same start symbol and length as those configured for the uplink data channel above, based on the number of repeated transmissions and the number of slots for determination of the TBS received from the base station. In an embodiment of the disclosure, when at least one symbol among symbols in a slot configured as downlink by the base station for the terminal or in a slot for repeated uplink data channel transmission configured for the terminal is configured for downlink, the terminal may skip uplink data channel transmission in the corresponding slot. For example, even if the uplink data channel is included in the number of repeated transmissions, the terminal may not transmit the same.

On the other hand, the terminal which supports Rel-17 repeated uplink data transmission may determine that a slot available for repeated uplink data transmission is an available slot, and may count the number of transmissions during repeated uplink data channel transmission in the slot determined to be the available slot. When repeated uplink data channel transmission in the slot determined to be the available slot is skipped, the terminal may perform repeated transmission via a slot available for transmission after postponing. In an embodiment of the disclosure, by using Table 12 below, a redundancy version may be applied according to a redundancy version pattern configured for each n-th PUSCH transmission occasion.

TABLE 12

| | rv_{id} to be applied to n^{th} transmission occasion (repetition | | | |
|---|---|---|---|---|
| | Type A) or TB processing over multiple slots) or n^{th} actual | | | |
| rvid indicated | repetition (repetition Type B) | | | |
| by the DCI | ((n − (n mod | ((n − (n mod | ((n − (n | ((n − (n mod |
| scheduling the | N))/N) mod | N))/N) mod | mod N))/N) | N))/N) mod |
| PUSCH | 4 = 0 | 4 = 0 | mod 4 = 0 | 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

Hereinafter, description will be provided for a method for determining an uplink available slot for single or multi-PUSCH transmission in the 5G system.

In an embodiment of the disclosure, when AvailableSlotCounting is configured to be enabled for the terminal, the terminal may determine an available slot based on tdd-UL-DL-ConfigurationCommon, tdd-UL-DL-ConfigurationDedicated, ssb-PositionsInBurst, and a time domain resource allocation (TDRA) information field value, for type A repeated PUSCH transmission and TBoMS PUSCH transmission. In other words, if, in a slot for PUSCH transmission, at least one symbol configured via TDRA for PUSCH overlaps with at least one symbol having a purpose other than uplink transmission, the slot may be determined to be an unavailable slot.

Hereinafter, a description will be provided for a method for reducing SSB density via dynamic signaling to save base station energy in the 5G system.

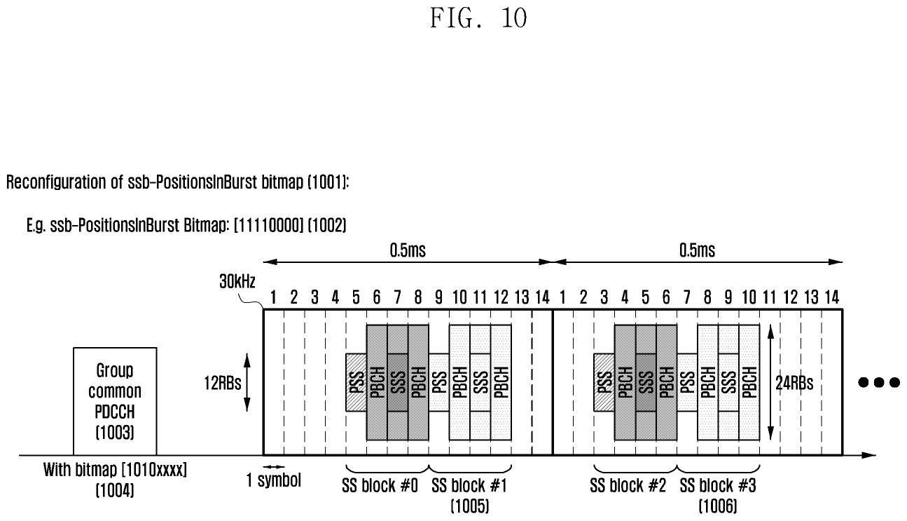

FIG. 10 is a diagram illustrating a method of SSB transmission reconfiguration via dynamic signaling according to an embodiment of the disclosure.

Referring to FIG. 10, a terminal may be configured with ssb-PositionsInBurst=“11110000” 1002 via higher-layer signaling (SIB1 or ServingCellConfigCommon) from a base station, up to two synchronization signal blocks at a subcarrier spacing of 30 kHz may be transmitted within 0.5 ms (or corresponding to a length of one slot when one slot includes 14 OFDM symbols), and accordingly, the terminal may receive four synchronization signal blocks (SSB) within 1 ms (or corresponding to a length of two slots when one slot includes 14 OFDM symbols). In this case, in order to reduce SSB transmission density to save energy, the base station may reconfigure SSB transmission configuration information by broadcasting bitmap “1010xxxx” 1004 via group/cell common DCI 1003 having a network energy saving-radio network temporary identifier (nwes-RNTI) (or es-RNTI). In this case, transmission of SS block #1 1005 and SS block #3 1006 may be canceled based on the bitmap 1004 configured via the group/cell common DCI. FIG. 10 provides a method 1001 of reconfiguring SSB transmission via bitmap-based group/cell common DCI.

In addition, via the group/cell common DCI, the base station may reconfigure ssb-periodicity configured via higher-layer signaling. In addition, by additionally configuring timer information for indication of a time point to apply the group/cell common DCI, SSB transmission may be performed based on SSB transmission information reconfigured via the group/cell common DCI during a configured timer. Then, when the timer expires, the base station may operate according to the SSB transmission information configured via existing higher-layer signaling. The base station may change a configuration from a normal mode to an energy saving mode via the timer, and may reconfigure the SSB configuration information according to the change. As another method, the base station may configure, for the terminal, an application time point and a period of the SSB configuration information, which are reconfigured via the group/cell common DCI, as offset and duration information. In this case, the terminal may not monitor an SSB for the duration from a moment when the group/cell common DCI is received and an offset is applied.

Hereinafter, a description will be provided for a method for determining priority between CSI reports in the 5G system.

CSI reports are associated with a priority value Pri_{iCSI}(y,k,c,s)=2·N_{cells}·Mₛ·y+N_{cells}·Mₛ·k+Mₛ·c+s, where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP and k=1 for CSI reports not carrying L1-RSRP;
c is the serving cell index and N_{cells} is the value of the higher layer parameter maxNrofServingCells;
s is the reportConfigID and Mₛ is the value of the higher layer parameter maxNrofCSI-ReportConfigurations.

A first CSI report is said to have priority over second CSI report if the associated Pri_{iCSI}(y,k,c,s) value is lower for the first report than for the second report.

In addition, when physical channels scheduled to carry two CSI reports overlap in at least one symbol, the two CSI reports may be multiplexed, or a low-priority CSI report determined by the method above may be dropped.

Hereinafter, a description will be provided for a method of BWP or BW adaptation via dynamic signaling for energy reduction of a base station in the 5G system.

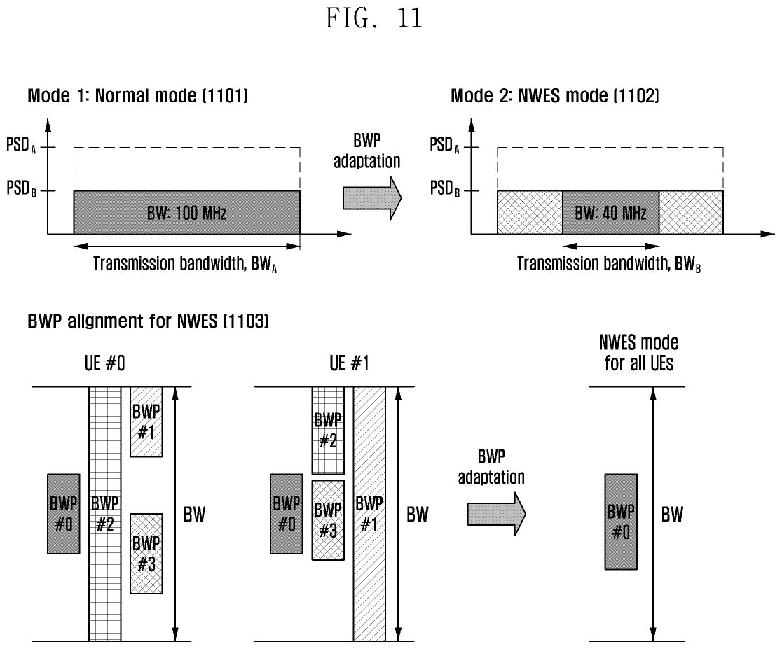

FIG. 11 is a diagram illustrating a method of reconfiguring a BWP and a BW via dynamic signaling according to an embodiment of the disclosure.

Referring to FIG. 11, a terminal may operate based on a BWP or BW activated via higher-layer signaling and L1 signaling from a base station, in mode 1101. For example, the terminal may operate via a full BW of 100 MHz with fixed power PSD_{B}. In this case, for energy saving, the base station may adjust the BW and BWP to activate, for the terminal, a narrower BW of 40 MHz with the same power PSD_{B}, in mode 1102. In this case, adjusting of the BW or BWP for energy saving by the base station may be configured to equally adjust the UE-specifically configured BWP and BW via group common DCI and cell-specific DCI, in mode 1103. For example, UE#0 and UE#1 may have different BWP configurations and positions. In this case, in order for the base station to save energy by reducing BWs used, BWs and BWPs of all terminals may be configured equally to one. In this case, one or more BWPs or BWs in the operation for energy saving may be configured, which may be used to configure a UE group-specific BWP.

Hereinafter, in description of the disclosure, higher-layer signaling may be signaling corresponding to at least one of or a combination of one or more of the following signaling types.
Master information block (MIB)
System information block (SIB) or SIB X (X=1, 2, . . . )
Radio resource control (RRC)
Medium access control (MAC) control element (CE)

In addition, L1 signaling may be signaling corresponding to at least one of or a combination of one or more of signaling methods using the following physical layer channels or signaling types.
Physical downlink control channel (PDCCH)
Downlink control information (DCI)
Terminal-specific (UE-specific) DCI
Group common DCI
Common DCI
Scheduling DCI (e.g., DCI used for scheduling of downlink or uplink data)
Non-scheduling DCI (e.g., DCI not for the purpose of scheduling downlink or uplink data)
Physical uplink control channel (PUCCH)
Uplink control information (UCI)

Hereinafter, in the disclosure, descriptions of the examples will be provided via multiple embodiments of the disclosure, but these are not independent of each other, and it is possible that one or more embodiments are applied simultaneously or in combination.

Hereinafter, a description will be provided for a DRX alignment method via dynamic signaling to save base station energy in the 5G system.

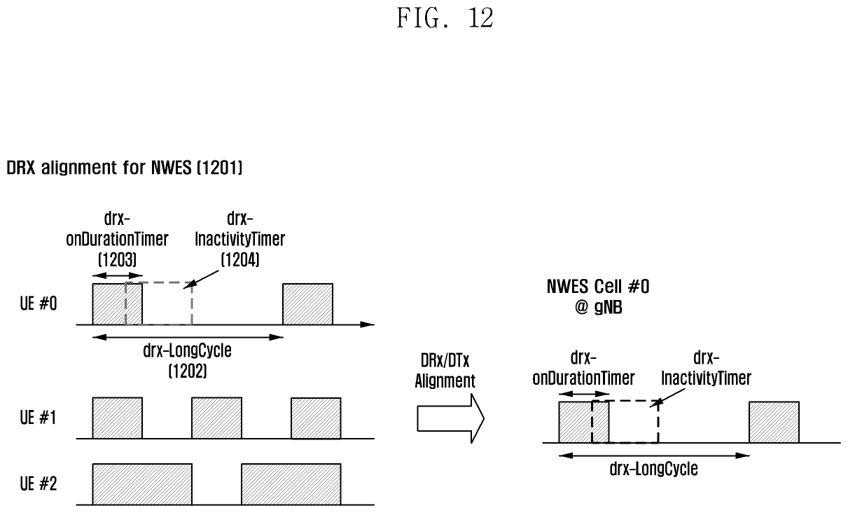

FIG. 12 illustrates a method of reconfiguring DRX via dynamic signaling in the wireless communication system according to an embodiment of the disclosure.

Referring to FIG. 12, a base station may UE-specifically configure DRX via higher-layer signaling. For example, different drx-LongCycle 1202, drx-ShortCycle, drx-onDurationTimer 1203, and drx-InactivityTimer 1204 may be configured for each terminal. Then, the base station may perform 1201 UE-specific DRX configuration for energy saving via UE group-specific or cell-specific L1 signaling. Via this, the base station may achieve, for energy saving, the same effect as that of power saving via DRX by the terminal.

Hereinafter, an example will be illustrated for describing a discontinuous transmission (DTx) operation for reducing energy consumption of a base station in the 5G system.

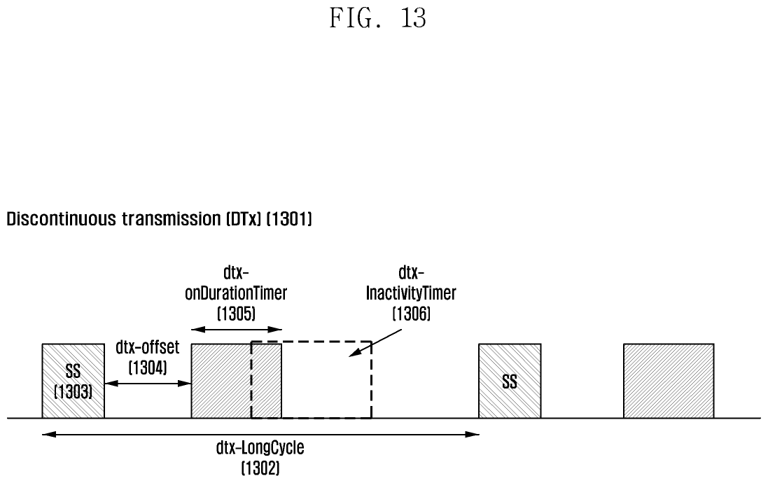

FIG. 13 is a diagram illustrating a DTx method for base station energy saving according to an embodiment of the disclosure.

Referring to FIG. 13, a base station may configure discontinuous transmission (DTx) 1301 for energy saving via higher-layer signaling (new system information block (SIB) for DTx or RRC signaling) and L1 signaling (DCI). In this case, for a DTx operation, the base station may configure dtx-onDurationTimer 1305 for transmitting a PDCCH for DL SCH scheduling or a reference signal for RRM measurement, beam management, pathloss measurement, or the like, dtx-InactivityTimer 1306 for receiving a PDSCH after reception of the PDCCH for DL SCH scheduling, synchronization signal (SS) 1303 configuration information for synchronization before dtx-onDurationTimer, dtx-offset 1304 which is subsequent to SS and for configuration of an offset between the SS and dtx-onDurationTimer, and dtx-(Long) Cycle 1302 for DTx to operate periodically based on the configuration information. In this case, dtx-cycle may include a long cycle and a short cycle, and a plurality of dtx-cycle may be configured. During the DTx operation, the base station may consider a transmission end to be off (or inactive) and therefore, the base station may not transmit DL CCH, SCH, and DL RS. For example, during the DTx operation, the base station may perform downlink transmission (PDCCH, PDSCH, RS, or the like) only during SS, dtx-onDurationTimer, and dtx-InactivityTimer. In this case, SS-gapbetweenBurst or the number of SS bursts may be additionally configured as additional information of the configured SS.

Hereinafter, a description will be provided for a method of activating a base station via a gNB wake-up signal (WUS) during a deactivation mode of the base station in order to reduce energy consumption of the base station in the 5G system.

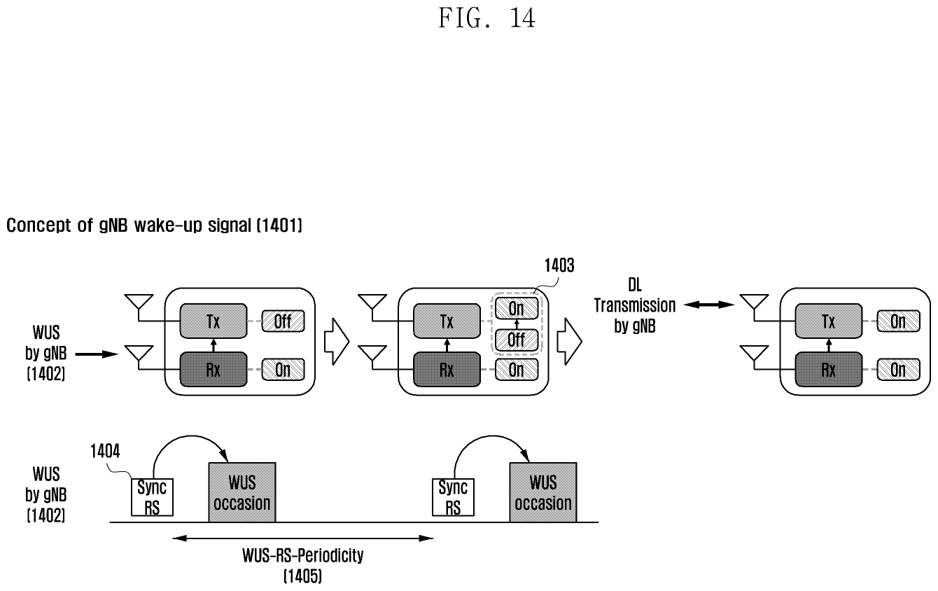

FIG. 14 illustrates an operation of a base station according to a gNB wake-up signal 1401 according to an embodiment of the disclosure.

Referring to FIG. 14, a base station may maintain a transmission end to be off (or inactive) while the base station is inactive (or sleep mode) for energy saving. Then, the base station may receive, from a terminal, a gNB wake-up signal 1402 to activate the sleep mode of the base station. Then, when the base station receives the WUS from the terminal via an Rx end, the Tx end may be switched to be in an on (or active) state 1403. Then, the base station may perform downlink transmission to the terminal. In this case, the base station may perform synchronization after Tx on, and perform control and data transmission. In addition, various uplink signals, for example, a physical random access channel (PRACH), a scheduling request (SR PUCCH), a PUCCH including acknowledgment (ACK), or the like, may be considered as the gNB WUS. Via the method above, the base station may perform energy saving, and at the same time, the terminal may improve latency.

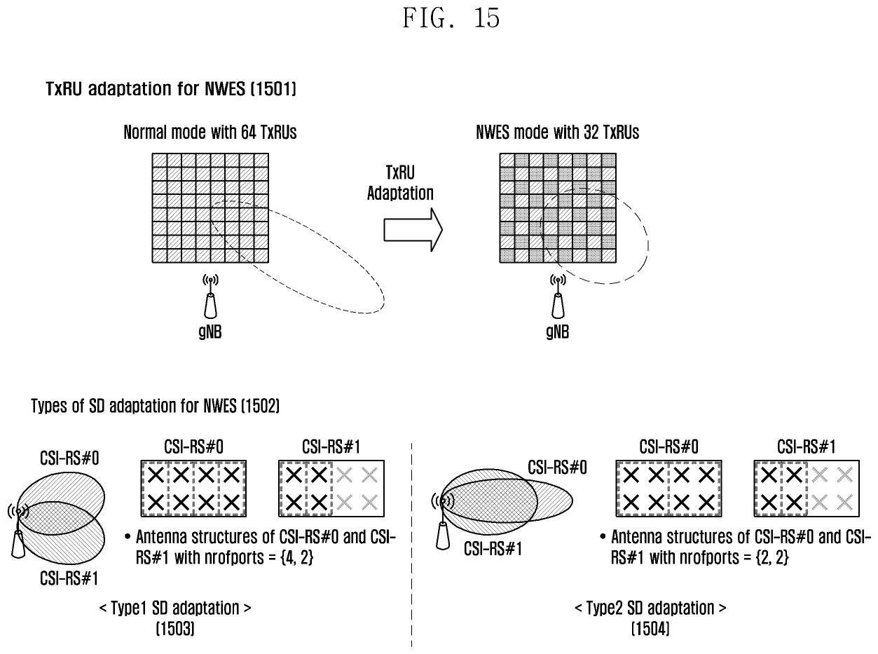

In this case, the base station may configure a WUS occasion for gNB WUS reception, and a Sync RS for synchronization before the terminal transmits a gNB WUS. In this case, an SSB, a TRS, a light SSB (PSS+SSS), consecutive SSBs, a new RS (e.g., continuous PSS+SSS), or the like may be considered as the Sync RS, and a PRACH, a PUCCH with SR, a sequence-based signal, or the like may be considered as the WUS. A SyncRS 1404 for the terminal to activate an inactivation mode for energy saving of the base station, and a WUS occasion for receiving a WUS may be repeatedly configured in a WUS-RS periodicity 1405. In the case of FIG. 15, an embodiment is described using 1-to-1 mapping of Sync and WUS occasion as an example, but the disclosure is not limited thereto. For example, Sync and WUS occasion may be N-to-1 mapped, 1-to-N mapped, or N-to-M mapped.

Hereinafter, a description will be provided for a method of dynamically turning on/off spatial domain elements (i.e., an antenna, a PA, or transceiver units or transmission radio units (TxRUs)) of a base station to save base station energy in the 5G system.

FIG. 15 is a diagram illustrating a base station antenna adaptation method for energy saving in the wireless communication system according to an embodiment of the disclosure.

Referring to FIG. 15, a base station may adjust 1501 a Tx antenna port per radio unit (RU) for energy saving (network energy savings (NWES)). For example, since energy consumed in a PA of the base station accounts for most of energy consumption of the base station, the base station may turn off a Tx antenna to save energy. In this case, in order to determine whether it is possible to turn off the Tx antenna, the base station may refer to/use a reference signal received power (RSRP), a channel quality indicator (CQI), a reference signal received quality (RSRQ), or the like, of a terminal. The base station may transmit signals by adjusting the number of activated Tx antennas for each UE group or UE. In this case, the base station may configure, for the terminal, information including one or more of reference signal information (e.g., one or more of a CSI resource, a CSI resource set, an SSB, or a CSI report) or beam information according to antenna on/off, via higher-layer signaling (e.g., RRC signaling) and DCI signaling. In addition, the base station may configure different antenna information for each BWP so as to enable reconfiguration of the antenna information according to a BWP change. In addition, the base station may receive CSI feedback from the terminal to determine whether SD adaptation is possible. The base station may determine SD adaptation (based on the CSI feedback). The base station may receive multiple pieces of feedback from the terminal via antenna structure hypotheses of multiple antenna patterns for SD adaptation.

More specifically, the base station may apply 1502 multiple types (e.g., two types) of SD adaptation for energy saving. For example, the multiple types may include Type 1 SD adaptation 1503 and Type 2 SD adaptation 1504.

When Type 1 SD adaptation 1503 is applied, the base station may adapt the number of antenna ports while maintaining the number of physical antenna elements per antenna port (i.e., a logical port or a port can be interchangeably used). In this case, radio frequency (RF) characteristics (e.g., tx power and beam) per port may be the same. Therefore, the terminal may perform measurement by combining CSI-RSs having the same port index during CSI measurement (e.g., layer 1-RSRP (L1-RSRP), layer 3-RSRP (L3-RSRP), or the like) (even if energy saving is applied and the number of antenna ports is changed).

As another method, when Type 2 SD adaptation 1504 is applied, the base station may maintain the same number of antenna ports (i.e., logical ports), and turn on/off 1504 the physical antenna element per port. In this case, the RF characteristics per port may vary. When energy saving is applied during CSI measurement and RF characteristics of an antenna port are changed, the terminal may separately perform measurement on CSI-RSs of the same port in a section where energy saving is applied and a section where energy saving is not applied. The base station may save energy via one or more among multiple types of SD adaptation methods including the two types of SD adaptation methods.

Via methods according to an embodiment of the disclosure, energy consumption of a base station may be reduced. In addition, for the methods according to an embodiment of the disclosure, one of the methods may be configured/used, or a combination of more than one of the methods may be simultaneously configured/used.

According to an embodiment of the disclosure, a method for a base station to receive CSI feedback from a terminal in order to perform SD adaptation to reduce energy consumption may be provided. In addition, according to an embodiment of the disclosure, a method of configuring one or multiple CSI resources and/or CSI resource sets and/or one or multiple CSI reports for a base station to receive CSI feedback from a terminal may be provided. According to an embodiment of the disclosure, a thresholding-based CSI report method for reducing overhead of CSI measurement and reporting of a terminal may be provided. According to an embodiment of the disclosure, by applying appropriate SD adaptation for each terminal, energy consumption may be reduced without deterioration of coverage and service performance, and CSI feedback overhead of a terminal may also be improved. In the disclosure, energy saving, reducing energy consumption, decreasing energy consumption, or the like, may be used interchangeably, and may be understood to have the same meaning. Unless specifically stated otherwise, in the disclosure, CSI-RS resource configuration may include CSI-RS resource set configuration. For example, CSI-RS resource configuration may be performed based on CSI-RS resource set configuration.

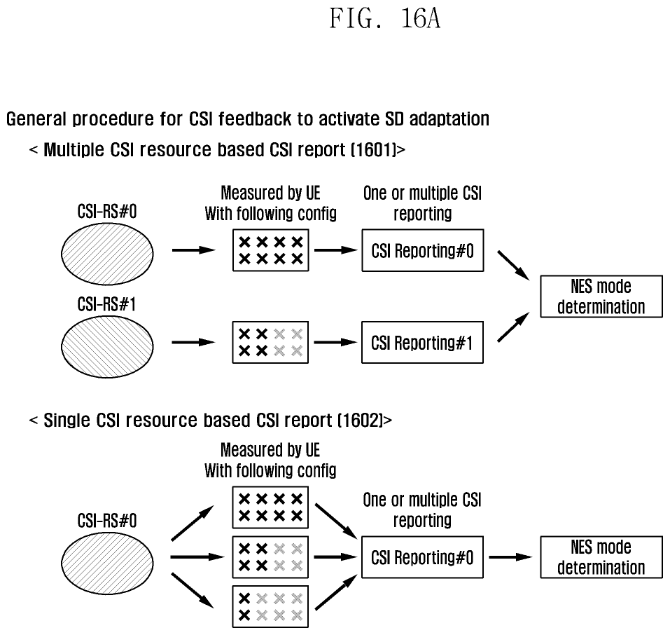

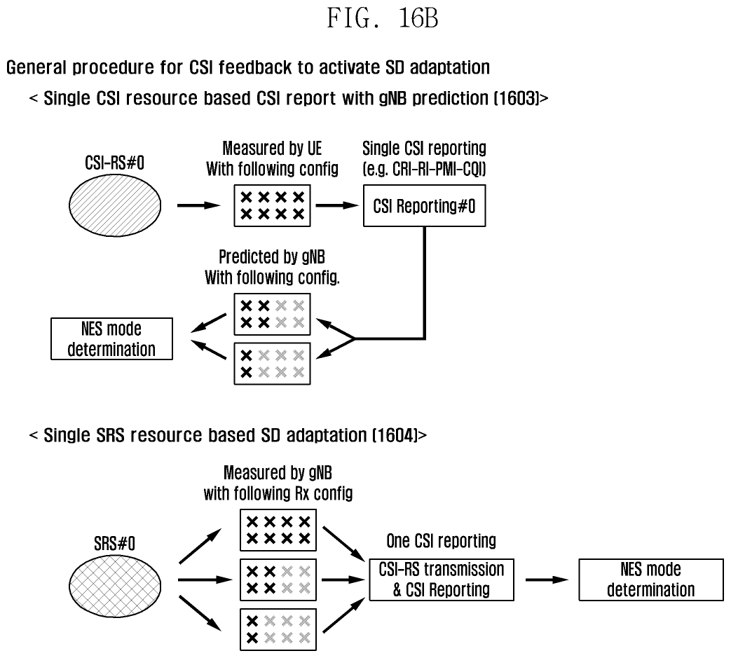

Referring to FIGS. 16A and 16B, according to an embodiment of the disclosure, a base station may determine SD adaptation, based on CSI feedback for each terminal. For example, this may be for energy saving. According to an embodiment of the disclosure, the base station may determine, based on CSI feedback, a network energy savings (NES) mode, and the determining of the NES mode may include determining SD adaptation. The base station may obtain CSI feedback to determine an appropriate/suitable antenna pattern for SD adaptation for each terminal by using one of or a combination of the following methods.

FIG. 16A is a diagram illustrating a base station receives an SRS or receives CSI feedback for each terminal to determine SD adaptation of the base station according to an embodiment of the disclosure.

### [Method 1]—Multiple CSI Resource-Based CSI Report 1601

According to method 1 1601 according to an embodiment of the disclosure, a multi-CSI reporting method via multiple CSI-RS measurements may be provided. For example, this may be for energy saving of a base station.

A base station may configure 1601, for a terminal via higher-layer signaling, (a single CSI report configuration or) multiple CSI report configurations and multiple CSI resources (hereinafter, a CSI resource may be understood as an NZP CSI-RS resource/resource set, an SSB set, a CSI-IM resource/resource set, or the like) having different antenna structures. For example, in method 1601, CSI-RS#0 and CSI-RS#1 having different numbers of antenna ports have been configured. In this case, for each CSI feedback generated by separately measuring different CSI-RSs, the terminal may perform CSI reporting via different PUCCHs or PUSCHs or the same PUCCH or PUSCH. In this case, each CSI feedback may be generated and reported based on each CSI report configuration. The terminal may acquire different CSI feedback by separately measuring different CSI-RSs. The terminal may transmit (multiple) CSI reports based on different CSI feedback via the same PUCCH (or the same PUSCH) or via different PUCCHs (or different PUSCHs). Then, the base station may determine SD adaptation for energy saving via the multiple CSI reports.

For example, the base station may configure a CSI resource corresponding to CSI-RS#0 and a CSI resource corresponding to CSI-RS#1 via higher-layer signaling. The terminal may report CSI reporting#0 including CSI measurement obtained based on CSI-RS#0, and may report CSI reporting#1 including CSI measurement obtained based on CSI-RS#1. The base station may perform NES mode determination based on reported CSI reporting#0 and CSI reporting#1.

According to method 1 1601 according to an embodiment of the disclosure, the base station may receive CSI feedback for multi-SD adaptation. Method 1 1601 according to an embodiment may be a suitable method for determining about Type 2 SD adaptation in which antenna ports are adapted to have different RF characteristics. According to method 1 1601 according to an embodiment of the disclosure, the base station may perform CSI-RS transmission multiple times and perform CSI report reception multiple times. In addition, the base station may configure respective CSI resources for multiple times of CSI-RS transmission and CSI reporting for multiple times of CSI reporting. In addition, the terminal may perform measurement multiple times to report multiple CSI reports.

### [Method 2]—Single CSI Resource-Based CSI Report 1602

According to method 2 1602 according to an embodiment of the disclosure, a multi-CSI reporting method via single CSI-RS measurement may be provided. For example, this may be for energy saving of a base station.

A base station may configure 1602, for a terminal via higher-layer signaling, a CSI report configuration including one or multiple antenna structure configurations and a single CSI resource configuration for SD adaptation. The base station may transmit a single CSI-RS to receive CSI feedback for SD adaptation. The CSI-RS may be a CSI-RS for one or multiple CSI report configurations. The terminal may perform measurement multiple times for the single CSI-RS by hypothesizing various antenna structures (which may correspond to multiple antenna structure configurations) and by hypothesizing and considering CSI-RS patterns, based on the configured CSI report configuration. For example, the terminal may measure CSI-RS#0 transmitted by the base station, based on various numbers of antenna ports (or antenna structures). Then, the terminal may report, via one or multiple PUCCHs or one or multiple PUSCHs, measurement results obtained via hypothesizing of multiple antenna structures. The terminal may acquire multiple pieces of CSI feedback by measuring a single CSI-RS multiple times based on one or multiple CSI report configurations. The terminal may transmit (multiple) CSI reports based on different CSI feedback via the same PUCCH (or the same PUSCH) or via different PUCCHs (or different PUSCHs). The base station may apply appropriate SD adaptation to the terminal, based on a CSI report received from the terminal.

For example, the base station may configure a CSI resource corresponding to CSI-RS#0 via higher-layer signaling. The terminal may report CSI reporting#0 including multiple CSI measurements obtained based on CSI-RS#0. The base station may perform NES mode determination based on reported CSI reporting#0.

According to method 2 1602 according to an embodiment of the disclosure, the base station may determine SD adaptation for energy saving. Method 2 1602 according to an embodiment may be applied for Type 1 SD adaptation in which RF characteristics of the antenna ports remain the same. According to method 2 1602 according to an embodiment of the disclosure, overhead for CSI-RS transmission may be reduced via single CSI-RS transmission. According to method 2 1602 according to an embodiment of the disclosure, the terminal may perform CSI reporting by considering multiple antenna patterns.

FIG. 16B is a diagram illustrating a base station receives an SRS or receives CSI feedback for each terminal to determine SD adaptation of the base station according to an embodiment of the disclosure.

[Method 3]—Single CSI Resource-Based CSI Report with gNB Prediction 1603

According to method 3 1603 according to an embodiment of the disclosure, a method for CSI feedback prediction by a base station based on multiple antenna structures may be provided. This may be for energy saving of a base station.

A base station may configure, for a terminal via higher-layer signaling, a single CSI resource configuration and a single CSI report configuration for SD adaptation. Then, the base station may receive a CSI report from the terminal, based on the configured information. The base station may perform CSI reporting prediction by considering various antenna patterns via the received CSI report. For example, the terminal may report CSI feedback based on a single CSI resource (CSI-RS#0), and the base station may predict CSI feedback for various antenna patterns, based on the CSI feedback. For example, when performing CSI reporting, the terminal may report the entire measured channel matrix, and the base station may perform CSI reporting prediction via the CSI report. The base station may configure, for the terminal, a single CSI resource configuration and a single CSI report configuration, and the terminal may report a single CSI report based on the same. The single CSI report may be obtained by considering a single antenna pattern. The base station may predict CSI reporting for various antenna patterns, based on the received single CSI report. Based on this, the base station may determine a terminal-specific antenna pattern of SD adaptation for energy saving. According to method 3 1603 according to an embodiment of the disclosure, the CSI report received from the terminal may include new channel state information (e.g., full or partial channel matrix), or the like.

For example, the base station may configure a CSI resource corresponding to CSI-RS#0 via higher-layer signaling. The terminal may report CSI reporting#0 including CSI measurement obtained based on CSI-RS#0. CSI reporting#0 may be configured based on a specific ReportQuantity (e.g., cri-rank indicator (RI)-PMI-CQI or a new measured channel matrix). Alternatively, one or more among CQIs may be included. The base station may perform NES mode determination based on reported CSI reporting#0.

According to method 3 1603 according to an embodiment of the disclosure, configuration and measurement overhead for the CSI report may be reduced from the perspective of both the base station and the terminal.

### [Method 4]—Single SRS Resource-Based SD Adaptation 1604

According to method 4 1604 according to an embodiment of the disclosure, a method of SD adaptation via SRS measurement can be provided. This may be for energy saving of a base station.

A base station may configure, for a terminal via higher-layer signaling, a single SRS resource or multiple SRS resources (and/or an SRS resource set) for SD adaptation. The terminal may transmit an SRS according to configuration information. Then, the base station may determine antenna patterns for SD adaptation via single SRS measurement. As another method, the base station may determine the antenna patterns for SD adaptation, by performing multiple SRS measurements based on different Rx antenna patterns, respectively. For example, the base station may determine multiple antenna patterns for SD adaptation, via a single SRS measurement acquired based on a single SRS resource. Alternatively, the base station may determine multiple antenna patterns for SD adaptation, via multiple SRS measurements acquired based on multiple SRS resources. The base station may transmit a CSI-RS via the determined antenna pattern, receive, from the terminal, CSI reporting based on the transmitted CSI-RS, and re-identify the determined antenna pattern. Based on the re-identification, when an L1-RSRP and/or CQI of the reported CSI report are low (e.g., equal to or lower than/lower than a specific threshold), the base station may perform fallback to SD adaptation having a full antenna pattern. Otherwise (when the L1-RSRP and/or CQI of the reported CSI report are not low (e.g., equal to or higher than/higher than the specific threshold)), the base station may apply SD adaptation (for each terminal) by using an antenna pattern determined in advance via SRS measurement. The base station may determine an antenna pattern for SD adaptation for each terminal via the SRS measurement.

For example, the base station may configure an SRS resource corresponding to SRS#0 via higher-layer signaling. The terminal may transmit SRS#0, based on the SRS resource. The base station may determine one or multiple antenna patterns, based on SRS#0. The base station may transmit a CSI-RS and receive CSI reporting corresponding to the CSI-RS, based on the determined antenna patterns. In addition, the base station may determine the NES mode.

Method 4 1604 according to an embodiment may consider, for example, reciprocity between DL and UL in a time division duplex (TDD) situation. According to method 4 1604 according to an embodiment of the disclosure, the base station may determine SD adaptation only by receiving an SRS without transmission of an additional CSI resource (e.g., CSI-RS) and CSI feedback, so that SD adaptation may be performed with better energy efficiency. The terminal may perform SRS transmission according to an additional SRS configuration.

Hereinafter, a description will be provided for a CSI feedback reception method for a base station to apply SD adaptation for each terminal according to an embodiment. The CSI feedback reception method according to an embodiment may be applied in combination with the SD adaptation determination method according to an embodiment described above.

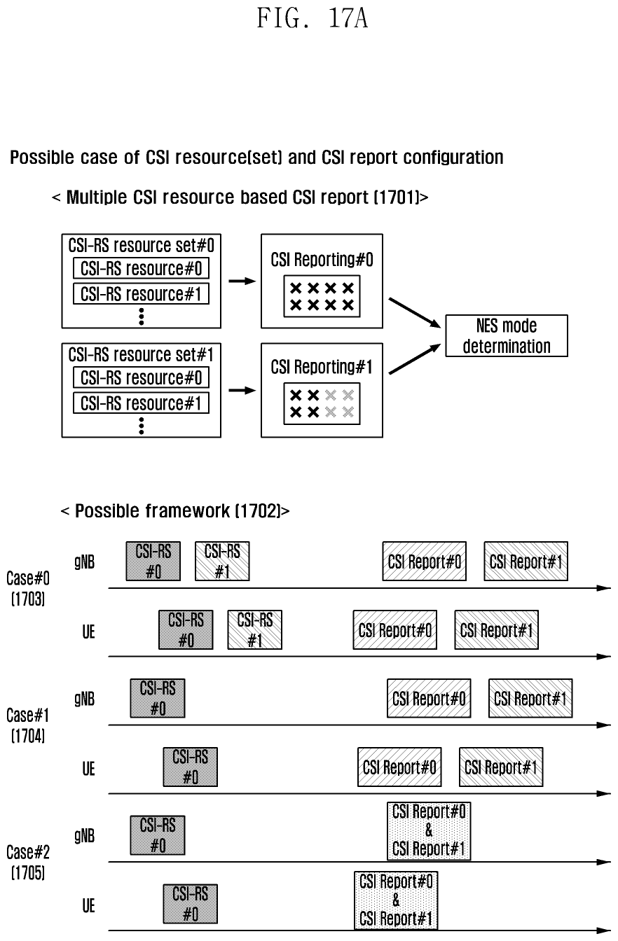

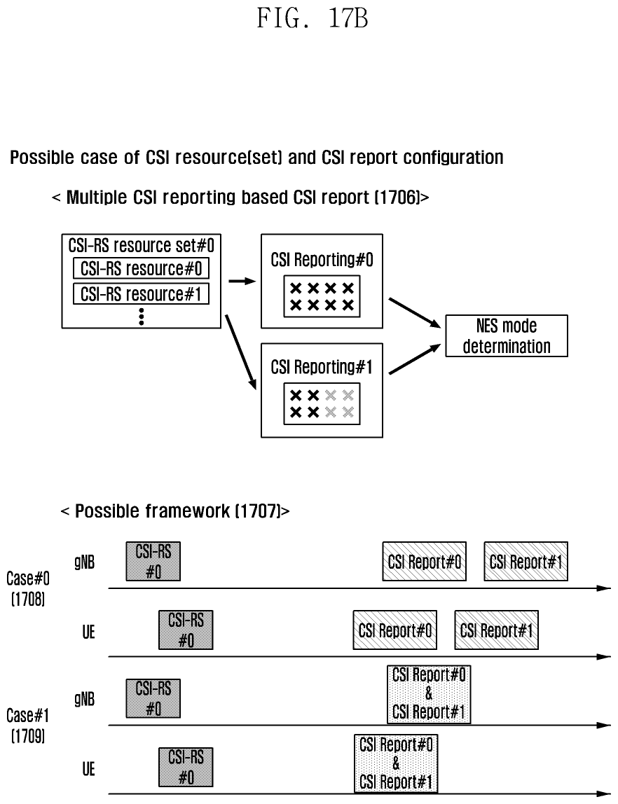

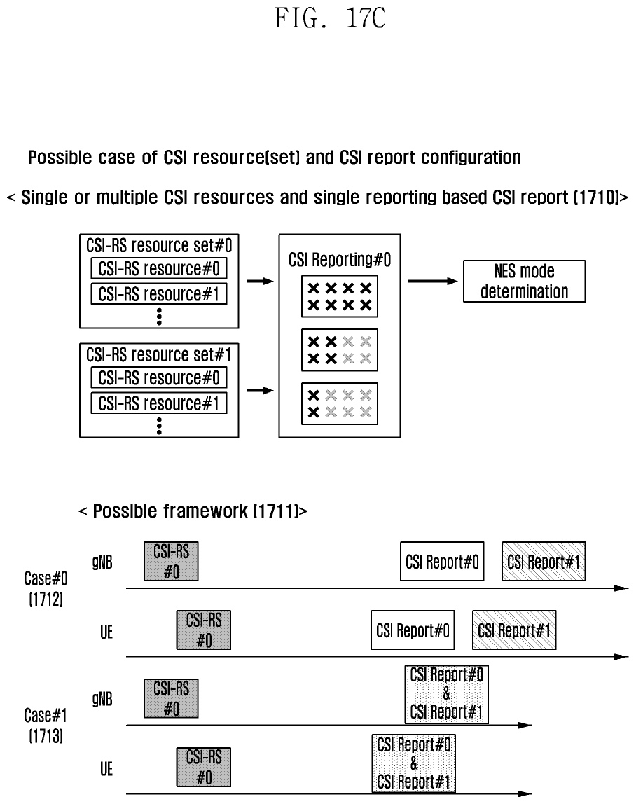

FIG. 17A is a diagram for illustrating a method of configuring a CSI resource/resource set/report for each terminal by a base station to determine SD adaptation in the wireless communication system according to an embodiment of the disclosure, FIG. 17B is a diagram for illustrating a method of configuring a CSI resource/resource set/report for each terminal by a base station to determine SD adaptation in the wireless communication system according to an embodiment of the disclosure, and FIG. 17C is a diagram for illustrating a method of configuring a CSI resource/resource set/report for each terminal by a base station to determine SD adaptation in the wireless communication system according to an embodiment of the disclosure.

Referring to FIGS. 17A to 17C, a CSI resource/resource set/report configuration method for a base station to determine SD adaptation based on terminal-specific CSI feedback for energy saving may be provided.

A base station may perform CSI resource/resource set/report configuration to determine an appropriate antenna pattern for SD adaptation for each terminal by using one of or a combination of the following methods. The CSI resource/resource set/report configuration method according to an embodiment may be applied to perform the procedures of the SD adaptation determination method according to an embodiment.

FIG. 17A is a diagram illustrating another method of configuring a CSI resource/resource set/report for each terminal by a base station to determine SD adaptation in the wireless communication system according to an embodiment of the disclosure.

### [Method 1]—Multiple CSI Resource-Based CSI Report 1701

According to method 1 1701 according to an embodiment of the disclosure, multiple CSI-RS resources/resource sets and multiple CSI reports may be configured. This may be for energy saving of a base station.

A base station may configure multiple CSI resources/resource sets via higher-layer signaling for CSI reporting. The base station may configure multiple CSI reports for a CSI resource set. For example, each CSI report may have a single antenna structure hypothesis. The base station may perform NES mode determination based on multiple CSI reports received from a terminal.

For example, the base station may configure CSI-RS resource set#0 and CSI-RS resource set#1, which include at least CSI-RS resource#0 and CSI-RS resource#1, respectively. In addition, the base station may configure CSI Reporting#0 corresponding to CSI-RS resource set#0 and CSI Reporting#1 corresponding to CSI-RS resource set#1. CSI Reporting#0 and CSI Reporting#1 may include different antenna structure hypotheses, respectively. The base station may perform NES mode determination based on multiple CSI reports (corresponding to CSI Reporting#0 and CSI Reporting#1) received from the terminal.

The base station and/or the terminal may perform at least some of the following operations via configuration of multiple CSI resources/resource sets and multiple CSI reports.

### [Operation 1]—Case#0

In operation 1 1703, in possible framework 1702, according to an embodiment of the disclosure, based on configuration of multiple CSI resources/resource sets and multiple CSI reports, CSI-RS transmission/measurement in respective different resources and CSI reporting via PUCCHs/PUSCHs may be performed.

The base station may configure, for the terminal, multiple CSI resources/resource sets and multiple CSI reports via higher-layer signaling. Then, the base station may transmit CSI-RSs having different CSI-RS patterns (e.g., different code domain multiplexing (CDM) groups) in different time/frequency resources, respectively. The terminal may measure respective CSI-RSs transmitted from the base station and perform CSI reporting via different PUCCHs/PUSCHs.

For example, the base station may transmit configuration information for a CSI resource/resource set corresponding to CSI-RS#0 and a CSI resource/resource set corresponding to CSI-RS#1 via higher-layer signaling, and the terminal may receive the same. The base station may transmit CSI-RS#0 and CSI-RS#1, and the terminal may receive CSI-RS#0 and CSI-RS#1, based on the configuration information. Based on CSI-RS#0 and CSI-RS#1, the terminal may transmit CSI Report#0 and CSI Report#1 via different PUCCHs/PUSCHs, respectively, and the base station may receive the same.

### [Operation 2]—Case#1

In operation 2 1704 according to an embodiment of the disclosure, based on configuration of multiple CSI resources/resource sets and multiple CSI reports, CSI-RS transmission/measurement in the respective same resources and CSI reporting via different PUCCHs/PUSCHs may be performed. Hereinafter, unless specifically stated otherwise, in the disclosure, the same resource (or the same resource) may be time and frequency resources (e.g., time and frequency resources for CSI (measurement), time and frequency resources for CSI-RS transmission/mapping, CSI resources, or the like) configured within a specific time interval (e.g., a single slot).

The base station may configure, for the terminal, multiple CSI resources/resource sets and multiple CSI reports via higher-layer signaling. Then, the base station may transmit CSI-RSs having various CSI-RS patterns (e.g., different CDM groups) in the same resource. In this case, different CSI-RS patterns may have sub-set structures. The terminal may measure the CSI-RSs transmitted from the base station and report multiple CSI measurement values via different PUCCHs/PUSCHs.

For example, the base station may transmit configuration information for a CSI resource/resource set corresponding to CSI-RS#0 via higher-layer signaling, and the terminal may receive the same. The base station may transmit CSI-RS#0, and the terminal may receive CSI-RS#0, based on the configuration information. Based on CSI-RS#0, the terminal may transmit CSI Report#0 and CSI Report#1 via respective different PUCCHs/PUSCHs, and the base station may receive the same.

### [Operation 3]—Case#2

In operation 3 1705 according to an embodiment of the disclosure, based on configuration of multiple CSI resources/resource sets and multiple CSI reports, a single CSI-RS transmission/measurement and CSI reporting via a single PUCCH/PUSCH may be performed.

The base station may configure, for the terminal, multiple CSI resources/resource sets and multiple CSI reports via higher-layer signaling. Then, the base station may transmit CSI-RSs having various CSI-RS patterns (e.g., different CDM groups) in the same resource. In this case, different CSI-RS patterns may have sub-set structures. The terminal may measure, based on various CSI report configuration information, a single CSI-RS transmitted from the base station, and perform CSI reporting of multiple CSI measurement values via a single PUCCH/PUSCH.

For example, the base station may transmit configuration information for a CSI resource/resource set corresponding to CSI-RS#0 via higher-layer signaling, and the terminal may receive the same. The base station may transmit CSI-RS#0, and the terminal may receive CSI-RS#0, based on the configuration information. Based on CSI-RS#0, the terminal may transmit CSI Report#0 and CSI Report#1 via the same PUCCH/PUSCH, and the base station may receive the same.

Via at least some of the operations above, the base station may obtain CSI reports, based on configuration of multiple CSI resources/resource sets and multiple CSI reports. For example, the base station may obtain CSI reports, based on the configuration of multiple CSI resources/resource sets and multiple CSI reports.

FIG. 17B is a diagram illustrating another method of CSI resource/resource set/report configuration for each terminal to determine SD adaptation by a base station in the wireless communication system according to an embodiment of the disclosure.

### [Method 2]—Multiple CSI Report-Based CSI Report 1706

According to method 2 1706 according to an embodiment of the disclosure, a method of configuring a single CSI-RS resource/resource set and multiple CSI reports may be provided. This may be for energy saving of a base station.

For CSI reporting, a base station may configure a single CSI resource/resource set and configure multiple CSI reports for the CSI resource set via higher-layer signaling. For example, each CSI report may have a single antenna structure hypothesis. The base station may perform NES mode determination based on multiple CSI reports received from a terminal.

For example, the base station may configure CSI-RS resource set#0 including at least CSI-RS resource#0 and CSI-RS resource#1. In addition, the base station may configure CSI Reporting#0 and CSI Reporting#1 corresponding to CSI-RS resource set#0. CSI Reporting#0 and CSI Reporting#1 may include different antenna structure hypotheses, respectively. The base station may perform NES mode determination based on multiple CSI reports (corresponding to CSI Reporting#0 and CSI Reporting#1) received from the terminal.

The base station and/or the terminal may perform at least some of the following operations via configuration of a single CSI resource/resource set and multiple CSI reports.

### [Operation 1]—Case#0

In operation 1 1708, in possible framework 1707, according to an embodiment of the disclosure, based on configuration of a single CSI resource/resource set and multiple CSI reports, CSI-RS transmission/measurement in the respective same resources and CSI reporting via different PUCCHs/PUSCHs may be performed.

The base station may configure, for the terminal, a single CSI resource/resource set and multiple CSI reports via higher-layer signaling. Then, the base station may transmit CSI-RSs having various CSI-RS patterns (e.g., different CDM groups) in the same resource. In this case, different CSI-RS patterns may have sub-set structures. The terminal may measure the CSI-RSs transmitted from the base station and report multiple CSI measurement values via different PUCCHs/PUSCHs.

For example, the base station may transmit configuration information for a CSI resource/resource set corresponding to CSI-RS#0 via higher-layer signaling, and the terminal may receive the same. The base station may transmit CSI-RS#0, and the terminal may receive CSI-RS#0, based on the configuration information. Based on CSI-RS#0, the terminal may transmit CSI Report#0 and CSI Report#1 via respective different PUCCHs/PUSCHs, and the base station may receive the same.

### [Operation 2]—Case#1

In operation 2 1709 according to an embodiment of the disclosure, based on configuration of a single CSI resource/resource set and multiple CSI reports, a single CSI-RS transmission/measurement and CSI reporting via a single PUCCH/PUSCH may be performed. The base station may configure, for the terminal, a single CSI resource/resource set and multiple CSI reports via higher-layer signaling. Then, the base station may transmit CSI-RSs having various CSI-RS patterns (e.g., different CDM groups) in the same resource. In this case, different CSI-RS patterns may have sub-set structures. The terminal may measure, based on various CSI report configuration information, a single CSI-RS transmitted from the base station, and perform CSI reporting of multiple CSI measurement values via a single PUCCH/PUSCH.

For example, the base station may transmit configuration information for a CSI resource/resource set corresponding to CSI-RS#0 via higher-layer signaling, and the terminal may receive the same. The base station may transmit CSI-RS#0, and the terminal may receive CSI-RS#0, based on the configuration information. Based on CSI-RS#0, the terminal may transmit CSI Report#0 and CSI Report#1 via the same PUCCH/PUSCH, and the base station may receive the same.

Via at least some of the operations above, the base station may obtain CSI reports, based on configuration of a single CSI resource/resource set and multiple CSI reports. For example, the base station may obtain CSI reports, based on the configuration of a single CSI resource/resource set and multiple CSI reports.

FIG. 17C is a diagram illustrating another method of CSI resource/resource set/report configuration for each terminal to determine SD adaptation by a base station in the wireless communication system according to an embodiment of the disclosure.

### [Method 3]—Single or Multiple CSI Resources and Single Reporting-Based CSI Report 1710

According to method 3 1710 according to an embodiment of the disclosure, a method of configuring a single resource/resource set or multiple CSI-RS resources/resource sets and a single CSI report having multiple antenna structure hypotheses may be provided. This may be for energy saving of a base station.

For CSI reporting, a base station may configure, via higher-layer signaling, a single CSI resource/resource set or multiple CSI resources/resource sets and configure a single CSI report having multiple antenna structure hypotheses for the CSI resource/resource set. The base station may perform NES mode determination based on a single CSI report received from a terminal.

For example, the base station may configure CSI-RS resource set#0 and CSI-RS resource set#1, which include at least CSI-RS resource#0 and CSI-RS resource#1, respectively. In addition, the base station may configure CSI Reporting#0 corresponding to CSI-RS resource set#0 and CSI-RS resource set#1. CSI Reporting#0 may have multiple antenna structure hypotheses. The base station may perform NES mode determination based on a single CSI report (corresponding to CSI Reporting#0) received from the terminal.

The base station may perform at least some of the following operations via CSI report configuration having the single CSI resource/resource set and multiple antenna structure hypotheses.

### [Operation 1]—Case#0

In operation 1 1712, in possible framework 1711, according to an embodiment of the disclosure, based on configuration of a single CSI resource/resource set and a single CSI report having multiple antenna structure hypotheses, CSI-RS transmission/measurement in the respective same resources and CSI reporting via different PUCCHs/PUSCHs may be performed. For example, the single CSI report configuration may include multiple antenna structure hypotheses.

The base station may configure, for the terminal, a single CSI resource/resource set and a CSI report having multiple antenna structure hypotheses via higher-layer signaling. Then, the base station may transmit CSI-RSs having various CSI-RS patterns (e.g., different CDM groups) in the same resource. In this case, different CSI-RS patterns may have sub-set structures. The terminal may measure the CSI-RSs transmitted from the base station and report multiple CSI measurement values via different PUCCHs/PUSCHs.

For example, the base station may transmit configuration information for a CSI resource/resource set corresponding to CSI-RS#0 via higher-layer signaling, and the terminal may receive the same. The base station may transmit one CSI Reporting#0 including different antenna structure hypotheses (e.g., three), and the terminal may receive the same. The base station may transmit CSI-RS#0, and the terminal may receive CSI-RS#0, based on the configuration information. Based on CSI-RS#0, the terminal may transmit CSI Report#0 and CSI Report#1 via respective different PUCCHs/PUSCHs, and the base station may receive the same. CSI Report#0 and CSI Report#1 may be based on CSI Reporting#0 configuration and each of CSI Report#0 and CSI Report#1 may correspond to one of different antenna structure hypotheses included in CSI Reporting#0.

### [Operation 2]—Case#1

In operation 2 1713 according to an embodiment of the disclosure, based on configuration of a single CSI resource/resource set and a single CSI report having multiple antenna structure hypotheses, a single CSI-RS transmission/measurement and CSI reporting via a single PUCCH/PUSCH may be performed.

The base station may configure, for the terminal, a single CSI resource/resource set and a CSI report having multiple antenna structure hypotheses via higher-layer signaling. Then, the base station may transmit CSI-RSs having various CSI-RS patterns (e.g., different CDM groups) in the same resource. In this case, different CSI-RS patterns may have sub-set structures. The terminal may measure, based on various CSI report configuration information (e.g., antenna structure hypotheses), a single CSI-RS transmitted from the base station, and perform CSI reporting of multiple CSI measurement values via a single PUCCH/PUSCH. In operation 2, the base station may perform transmission via one or more PUCCHs/PUSCHs by considering a CSI report size measured based on the multiple antenna structure hypotheses.

For example, the base station may transmit configuration information for a CSI resource/resource set corresponding to CSI-RS#0 via higher-layer signaling, and the terminal may receive the same. The base station may transmit one CSI Reporting#0 including different antenna structure hypotheses (e.g., three), and the terminal may receive the same. The base station may transmit CSI-RS#0, and the terminal may receive CSI-RS#0, based on the configuration information. Based on CSI-RS#0, the terminal may transmit CSI Report#0 and CSI Report#1 via the same PUCCH/PUSCH, and the base station may receive the same. CSI Report#0 and CSI Report#1 may be based on CSI Reporting#0 configuration and each of CSI Report#0 and CSI Report#1 may correspond to one of different antenna structure hypotheses included in CSI Reporting#0.

Via at least some of the operations above, the base station may obtain a CSI report, based on configuration of a single CSI resource/resource set and a single CSI report. For example, the base station may obtain a CSI report corresponding to the configuration of a single CSI resource/resource set and a single CSI report.

In method 3 according to an embodiment of the disclosure, the base station may configure a CSI report to determine SD adaptation via configuration 1 below. This may be for energy saving.

### [Configuration 1]

In configuration 1 according to an embodiment of the disclosure, a method in which the base station configures, for an RRC connected terminal, CSI report configuration information for SD adaptation determination for energy saving may be performed.

The base station may configure, for the terminal, CSI report configuration information for SD adaptation determination. For example, the CSI report configuration information may be configured for an RRC connected/inactive terminal. This may be for energy saving of the base station.

For example, CodebookConfig of CSI-reportConfig as shown in Table 13 may be configured via RRC signaling.

TABLE 13

```
  CodebookConfig ::= SEQUENCE {
  CodebookConfig-r18 ::= SEQUENCE {
    AdaptationType CHOICE {Type 1, Type 2},
  Active_duration INTEGER (1..31),
  NES-Threshold CHOICE {rsrp-Threshold, CQI index},
  Type2-SD-Adaptation {
      PowerControlOffsetSS ENUMERATED {db-3, db0, db3,
db6},
  typeII-r16 SEQUENCE {
  Multi-n1-n2-codebookSubsetRestriction-r16 ENUMERATED {
  two-one BIT STRING (SIZE (16)),
  two-two BIT STRING (SIZE (43)),
  four-one BIT STRING (SIZE (32)),
  three-two BIT STRING (SIZE (59)),
  ...
  },
  Nrofmulti-n1-n2-codebook ENUMERATED {1, 2, 3, 4},...
  }
  ...
```

Via the CodebookConfig RRC configuration, the base station may configure a CSI report, which has multiple antenna structure hypotheses of the base station, for SD adaptation during an NES mode. In this case, at least some of information on an SD adaptation type, active_duration information for applying of measurement based on the multiple antenna structure hypotheses, NES-Threshold for selective determination of an antenna structure from among the multiple antenna structure hypotheses, a PowerControlOffsetSS value, or Nrofmulti-n1-n2-codebook which is the number of CSI reports that may be CSI reported from among the multiple antenna structure hypotheses may be configured as new information. An RRC signaling value is an example and may be configured in various ways.

Via the aforementioned methods or embodiments of the disclosure, energy consumption of a base station may be reduced. In addition, the methods or embodiments may be configured concurrently via one or more combinations.

Embodiments of the disclosure may provide a method of, in order to apply SD adaptation and PD adaptation during the SD adaptation and PD adaptation to reduce energy consumption of a base station, determining a mapping order of CSI fields based on multiple pieces of CSIs when multiple pieces of CSI features are received from the terminal via a single CSI report transmitted through one PUSCH or PUCCH. According to an embodiment of the disclosure, a base station may receive multiple CSI reports during SD adaptation and/or PD adaptation for energy saving, and energy of the base station may be saved.

### First Embodiment

The first embodiment of the disclosure proposes a method of determining a mapping order of CSI fields when transmitting, via one CSI report, multiple pieces of CSI feedback according to spatial domain (SD) patterns for application of SD adaptation and PD adaptation for energy saving or while a base station is applying the SD adaptation and PD adaptation.

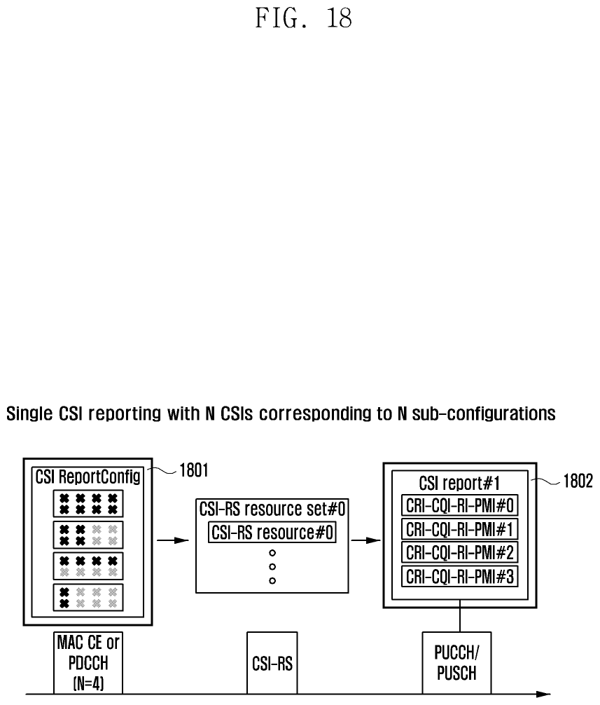

FIG. 18 is a diagram illustrating an operation in which a base station and a terminal transmit multiple pieces of CSI via a single CSI report according to an embodiment of the disclosure.

Referring to FIG. 18, a base station may configure a CSI report for multiple SD patterns, which is from a terminal, in order to determine SD adaptation for energy saving. In this case, different sub-configurations corresponding to L SD patterns may be configured 1801 in one CSI-reportConfig via higher-layer signaling. The sub-configuration may include at least one of the aforementioned information elements for multiple antenna structure hypotheses of the base station for SD adaptation and Table 13. Then, the base station may configure (or indicate), via CSI-reportConfig and/or higher-layer signaling and L1 signaling, a terminal to perform CSI reporting for N out of L sub-configurations, based on CSI-reportConfig. Afterwards, the terminal may calculate N pieces of CSI via the N sub-configurations, based on the configured information, and then report 1802 the calculated CSI via a single PUCCH or PUSCH. In this case, configuration information of the N sub-configurations configured via higher-layer signaling may be configured as shown in Table 14 below.

```
TABLE 14
  CSI-reportConfig-r18 ::= SEQUENCE {
  fixedrankIndex ENUMERATED {n1, n2, n3, n4}
  CommonPMImode or RestrictedPMImode CHOICE {Normal, Common}
  DifferentialPMI CHOICE {00, 01, 10, 11}
  DifferentialCQI CHOICE {enable, disable}
  DifferentialRSRP CHOICE {enable, disable}
  DifferentialRI CHOICE {enable, disable}
  Sub-Config-r18 ::= SEQUENCE {
  SubConfigId Sub-configurationId,
  ReportQuantity CHOICE {
  None,
  cri-RI-PMI-CQI  NULL,
  CQI NULL,
  RSRP NULL,
  CQI-RSRP NULL,
  ...
  }
  CodebookConfig-r18 ::= SEQUENCE {
    AdaptationType CHOICE {Type 1, Type 2},
  Active_duration INTEGER (1..31),
  NES-Threshold CHOICE {rsrp-Threshold, CQI index},
  Type1-SD-Adaptation {
      PowerControlOffsetSS ENUMERATED {db-3, db0, db3,
db6},
  typeX-r16 SEQUENCE {
  Multi-n1-n2-codebookSubsetRestriction-r16 ENUMERATED {
  two-one BIT STRING (SIZE (16)),
  two-two BIT STRING (SIZE (43)),
  four-one BIT STRING (SIZE (32)),
  three-two BIT STRING (SIZE (59)),
  ...
  },
  }
  ...
  reportFreqConfiguration SEQUENCE {
  ...
  }
  Nrofmulti-n1-n2-codebook ENUMERATED {1, 2, 3, 4},...
  }
  ...
```

Referring to CSI-reportConfig, multiple sub-configurations may be configured in one CSI-reportConfig. In this case, each sub-configuration may include independent reportFrequencyConfiguration and ReportQuantity configurations. reportFreqConfiguration may include information on a frequency resource in which CSI is to be measured, and whether a PMI and/or a CQI are reported via a subband or a wideband. ReportQuantity may configure a type of a CSI parameter to be reported. For example, CSI may be measured for different frequency resources for each sub-configuration, and different CSI parameters may be reported. Alternatively, the configurations may be included in CSI-reportConfig so as to be configured, in which case, the same reportFrequencyConfiguration and ReportQuantity may be applied to all sub-configurations. In this case, CSI may be measured for the same frequency resource, and the same CSI parameter may be reported.

In addition, via CSI-reportConfig, the base station may configure, as a configuration (e.g., fixedrankIndex) for fixing or limiting a rank assumed by the terminal when measuring CSI-RS, a value of the rank to be a specific value that is one of {n1, n2, n3, n4}, or may indicate the terminal to consider and perform CSI-RS measurement only for a rank equal to or lower than the specific value. In this case, the terminal may report CSI by using a rank of a configured value or by considering a rank equal to or lower than the configured specific value.

In addition, via CSI-reportConfig, the base station may configure a specific PMI for the terminal via a configuration (e.g., CommonPMImode or RestrictedPMImode) for limiting a PMI used in CSI-RS measurement when CSI reporting for a sub-configuration is performed, and may configure the terminal to perform CSI reporting using a subset of a PMI of a sub-configuration having a lowest (or highest or configured) sub-configuration ID. In this case, the terminal may generate a CQI by using a configured PMI or by using one PMI in a subset of the configured PMI.

In addition, via CSI-reportConfig, the base station may configure at least one of differentialCQI, differentialRSRP, and differentialRI to minimize CSI report overhead, and configure the terminal to perform CSI reporting based on a sub-configuration by using a differential value. In this case, at least one value among a CQI, an RSRP, an RI which serve as reference may be at least one value among a CQI, an RSRP, and an RI of a sub-configuration having a lowest sub-configuration ID, at least one value among a CQI, an RSRP, and an RI of a sub-configuration configured at the top of the CSI-reportConfig configuration, or at least one value among a CQI, an RSRP, and an RI of a sub-configuration having a codebook subset configured to have a largest number of ports.

CSI-reportConfig including N sub-configurations via higher-layer signaling is an example and does not limit the scope of the disclosure, the configured values may be configured within the sub-configurations so as to be independently configured for each of the sub-configurations, or may be configured in CSI-reportConfig, CSI-resourceConfig, or the like, at a level higher than that of the sub-configurations so as to enable operation in common.

As in the configuration, when the base station configures CSI report transmission via CSI-reportConfig having N sub-configurations, a mapping order of CSI fields of the CSI report may be determined to be single-part CSI or two-part CSI according to one of or a combination of the following methods.

### [Method 1]

Method 1 proposes a mapping order of CSI fields for transmitting N pieces of CSI for N sub-configurations via a single-part CSI report. More specifically, as shown in Table 15, a mapping order may be determined for each CSI content of N pieces of CSI with respect to CSI contents.

TABLE 15

| CSI report | |
|---|---|
| number | CSI fields |
| CSI report | N CRI(s) or common CRI or N sub-configuration indexes |
| #n | or none, if reported |
| | N rank indicator(s) or N differential rank indicator with |
| | reference rank indictor or common rank indicator or none, |
| | if reported |
| | N layer indicator(s) or N differential layer indicator with |
| | reference layer indictor or common layer indicator or |
| | none, if reported |
| | Zero padding bits Op, if reported |
| | N PMI(s) or N differential PMI with reference PMI or |
| | Common PMI or 1st priority PMI#1 of wideband |
| | information fields X1, if reported |
| | N PMI(s) or N differential PMI with reference PMI or |
| | Common PMI or 1st priority PMI#1 of wideband |
| | information fields X2, if reported |
| | N CQI(s) or N differential CQI with reference CQI, if |
| | reported |
| | NL1-RSRP(s) or N differential L1-RSRP with reference |
| | L1-RSRP, if reported |

As shown in Table 15, the terminal may determine a mapping order so that N pieces of CSI are included in one single-part CSI report. In this case, zero padding bit Oₚ may be determined as shown in Table 16 below.

```
TABLE 16
  $Zero padding bit {O}_{p} , where {O}_{p} = {\sum }_{i = 1}^{N} {N}_{max , i} - {N}_{reported , i} for CSI report$
  including NCSIs, where
    ${N}_{max , i} = {max}_{r ∈ {S}_{Rank}} N * B ( r ) , and {S}_{Rank} is the set of rank values r that are$
    allowed to be reported by ith sub-configuration, and Nis number of
    sub-configurations indicated by MAC CE or DCI.
    N_{reported,i} = B(R), where R is the reported rank by ith sub-configura-
    tion;
            B(r) = N_{PMI,i1}(r) + N_{PMI,i2}(r) + N_{CQI}(r)
```

### [Method 2]

Method 2 proposes a mapping order of CSI fields for transmitting N pieces of CSI for N sub-configurations via a single-part CSI report. More specifically, as shown in Table 17, a mapping order may be determined sequentially in a unit of N pieces of CSI with respect to CSI contents.

TABLE 17

| CSI report | |
|---|---|
| number | CSI fields |
| CSI report #n | CRI#1 or sub-configuration index#1 or none, if reported |
| | rank indicator#1 or none, if reported |
| | layer indicator#1 or none, if reported |
| | Zero padding bits Op#1, if reported |
| | PMI#1 of wideband information fields X1, if reported |
| | PMI#1 of wideband information fields X2, if reported |
| | CQI#1 if reference CQI or differential CQI#1 based on |
| | reference CQI, if reported |
| | L1-RSRP#1 if reference L1-RSRP or differential |
| | L1-RSRP#N based on reference L1-RSRP, if reported |
| | . . . |
| | CRI#N or sub-configuration index#1 or none, if reported |
| | rank indicator#N or none, if reported |
| | layer indicator#N or none, if reported |
| | Zero padding bits Op#N, if reported |
| | PMI#N of wideband information fields X1, if reported |
| | PMI#N of wideband information fields X2, if reported |
| | CQI#N if reference CQI or differential CQI#N based on |
| | reference CQI, if reported |
| | L1-RSRP#N if reference L1-RSRP or differential |
| | L1-RSRP#N based on reference L1-RSRP, if reported |

As shown in Table 17, the terminal may determine a mapping order so that N pieces of CSI are included sequentially in one single-part CSI report. In this case, compared to method 1, mapping order determination may be easy when some of the N pieces of CSI are omitted (or skipped) in the single-part CSI report, and for the omission, CSI having a low sub-configuration index or a low Pri value may be omitted according to a priority rule. In addition, no additional new zero padding bit calculation method is required. According to Table 2, with respect to the CSI contents, a CSI report of a reference sub-configuration preferentially includes all CSI contents, and for the remaining N−1, a variant in which only CQI or L−1 RSRP is reported is also possible.

### [Method 3]

Method 3 proposes a mapping order of CSI fields for transmitting N pieces of CSI for N sub-configurations via a two-part CSI report. More specifically, as shown in Tables 18 and 19, configuration of CSI part 1 and part 2 is proposed, and the following method of determining a mapping order for each CSI content of N pieces of CSI for CSI contents is proposed.

TABLE 18

| CSI report | |
|---|---|
| number | CSI fields |
| CSI report #n | N CRI(s) or common CRI or N sub-configuration |
| CSI part 1 | indexes or none, if reported |
| | N rank indicator(s) or N differential rank indicator with |
| | reference rank indictor or common rank indicator |
| | or none, if reported |
| | N CQI(s) or N differential CQI with reference CQI, if |
| | reported |
| | N L1-RSRP(s) or N differential L1-RSRP with |
| | reference L1-RSRP, if reported |

TABLE 19

| CSI report | |
|---|---|
| number | CSI fields |
| CSI report #n | N rank indicator(s) or N differential rank indicator with |
| CSI part 2 | reference rank indictor or common rank indicator |
| | or none, if reported |
| | N layer indicator(s) or N differential layer indicator with |
| | reference layer indictor or common layer indicator or |
| | none, if reported |
| | N PMI(s) or N differential PMI with reference PMI or |
| | Common PMI or 1st priority PMI#1 of wideband |
| | information fields X1, if reported |
| | N PMI(s) or N differential PMI with reference PMI or |
| | Common PMI or 1st priority PMI#1 of wideband |
| | information fields X2, if reported |

As shown in Tables 18 and 19, the terminal may determine a mapping order so that N pieces of CSI are included in one two-part CSI report. In this case, L1-RSRP may be included in and reported via CSI part 1. According to this, for SD pattern determination, the terminal and the base station may transmit and receive L1-RSRP with high reliability, and the base station may determine an SD pattern without a coverage problem via the information.

### [Method 4]

Method 4 proposes a mapping order of CSI fields for transmitting N pieces of CSI for N sub-configurations via a two-part CSI report. More specifically, as shown in Table 20, configuration of CSI part 1 and part 2 is proposed, and the following method of determining a mapping order in a unit of N pieces of CSI for CSI contents is proposed.

TABLE 20

| CSI report | |
|---|---|
| number | CSI fields |
| CSI report #n | CRI#1 or sub-configuration index#1 or none, if reported |
| CSI part 1 | rank indicator#1 or none, if reported |
| | CQI#1 if reference CQI or differential CQI#N based on |
| | reference CQI, if reported |
| | L1-RSRP#1 if reference L1-RSRP or differential |
| | L1-RSRP#N based on reference L1-RSRP, if reported |
| | . . . |
| | CRI#N or sub-configuration index#N or none, if reported |
| | rank indicator#N or none, if reported |
| | CQI#N if reference CQI or differential CQI#N based on |
| | reference CQI, if reported |
| | L1-RSRP#N if reference L1-RSRP or differential |
| | L1-RSRP#N based on reference L1-RSRP, if reported |

TABLE 21

| CSI report | |
|---|---|
| number | CSI fields |
| CSI report #n | layer indicator#1 or none, if reported |
| CSI part 2 | PMI#1 of wideband information fields X1, if reported |
| | PMI#1 of wideband information fields X2, if reported |
| | . . . |
| | layer indicator#N or none, if reported |
| | PMI#N of wideband information fields X1, if reported |
| | PMI#N of wideband information fields X2, if reported |

As shown in Tables 20 and 21, the terminal may determine a mapping order so that N pieces of CSI are included in one two-part CSI report. In this case, L1-RSRP may be included in and reported via CSI part 1. According to this, for SD pattern determination, the terminal and the base station may transmit and receive L1-RSRP with high reliability, and the base station may determine an SD pattern without a coverage problem via the information.

CRI, RI, LI, PMI, CQI, and RSRP values of the tables above may be determined as follows.
If CRIs are configured to be reported, the terminal may sequentially aggregate and report N CRIs or N sub-configuration indexes when N pieces of CSI are measured via N different CSI-RS resources. For example, the terminal may report sub-configuration indexes appropriate for the respective CSI-RS resources or the CRIs in ascending or descending order of CSI-RS resource indexes. Alternatively, when the terminal measures the N sub-configurations via one CSI-RS resource, the terminal may report a common CRI or report nothing. In this case, when the terminal sequentially aggregates and reports the N CRIs or the N sub-configuration indexes, this reporting may be performed to inform about a sub-configuration preferred (having better performance) by the terminal or to inform about priority according to performance when a specific N number of sub-configurations among L sub-configuration configurations are reported, where L is larger than N.
If rank indicators (RIs) are configured to be reported, rank indicator content of a CSI report may be determined depending on configuration of rank indicator restriction (e.g., a max rank number is 4, and the terminal may consider only a rank of 4 or lower or have a rank value based on a value of a specific reference rank) or a value of a rank indicator (RI) fixed via higher-layer signaling from the base station. More specifically, if no fixed RI is configured or no rank indicator restriction is configured, the terminal may report all N RIs of the respective N sub-configurations. In this case, the N RIs may be mapped in sub-configuration index order, index order of corresponding CSI-RS resources, or order of high priority sub-configuration. In this case, the order may be ascending order or descending order. In this case, if CSI reporting according to differential RI is configured, RIs of the remaining sub-configurations may be reported as differential RIs, based on an RI obtained via reference sub-configuration (i.e., priority is high, a sub-configuration index is low, or a port number is high). In this case, the differential RI may be configured to be 1 bit or 2 bits. On the other hand, if a fixed RI is configured or rank indicator restriction is configured, only the RI of one reference sub-configuration may be transmitted or nothing may be reported.
If a layer indicator (LI) is configured, an LI reporting method may be applied in the same way as the RI method.
If PMIs are configured to be reported, PMI content of a CSI report may be determined depending on configuration of PMI restriction (e.g., the base station may configure a specific PMI for the terminal, or the terminal may have a subset PMI value based on a PMI value of a specific reference sub-configuration) or a value of a PMI fixed via higher-layer signaling from the base station. More specifically, if no fixed PMII is configured or no PMI restriction is configured, the terminal may report all N PMIs of the respective N sub-configurations. In this case, the N PMIs may be mapped in sub-configuration index order, index order of corresponding CSI-RS resources, or order (X₁, X₂) of high priority sub-configuration. In this case, the order may be ascending order or descending order. (X₁, X₂) may correspond to (first PMI, second PMI). In this case, if CSI reporting according to differential PMI is configured, the terminal may report a PMI subset determination method based on a PMI obtained via a reference sub-configuration (i.e., priority is high, a sub-configuration index is low, or a port number is high). More specifically, a subset of PMI refers to a PMI used by the terminal to calculate a CQI by using a part of a common PMI, and the PMI subset determination method may be pre-configured or determined by the terminal. Therefore, the PMI of one reference sub-configuration may be reported, and PMIs of the remaining sub-configurations may be differential PMIs. In this case, the differential PMI may be configured to be 1 bit or 2 bits. On the other hand, if a fixed PMI is configured or PMI restriction is configured, only the PMI of one reference sub-configuration may be reported or nothing may be reported.
If CQIs are configured to be reported, a CQI of a CSI report may be transmitted as a differential value depending on configuration of CSI reporting according to differential CQI via higher-layer signaling from the base station. In this case, for example, the differential value may be configured to be a negative or positive integer value, based on a reference sub-configuration CQI. In this case, the CQIs may always need to be reported for all sub-configurations for SD patterns for energy saving.
If RSRPs are configured to be reported, an RSRP of a CSI report may be transmitted as a differential value depending on configuration of CSI reporting according to differential RSRP via higher-layer signaling from the base station. In this case, for example, the differential value may be configured to be a negative or positive integer value, based on a reference sub-configuration RSRP. In this case, the RSRPs may always need to be reported for all sub-configurations for SD patterns for energy saving.

Based on the methods, the terminal may determine CSI fields for N CSI reports obtained via multiple sub-configurations. In this case, the CSI content mapping orders in the tables correspond to an embodiment which does not limit the scope of the disclosure, and the mapping order of CSI content may be changed. In addition, a CQI of a second TB or a subband CQI/PMI may also be included in and transmitted via a CSI report.

### Second Embodiment

The second embodiment of the disclosure proposes a differential PMI reporting method and a PMI subset determination method for transmitting, on one PUCCH or PUSCH via a single CSI report, multiple N pieces of CSI according to spatial domain (SD) patterns for application of SD adaptation and PD adaptation for energy saving or while a base station is applying the SD adaptation and PD adaptation.

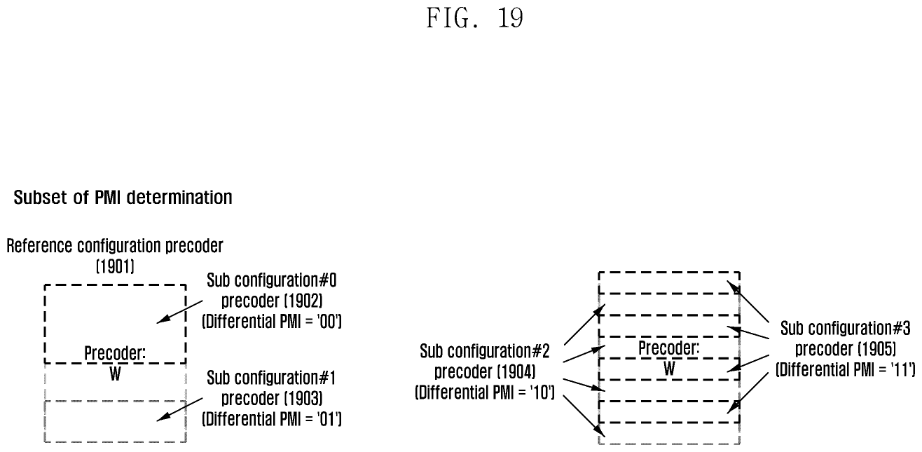

FIG. 19 is a diagram illustrating a method of determining a PMI subset by a terminal according to an embodiment of the disclosure.

Referring to FIG. 19, a base station may configure a CSI report from a terminal with respect to multiple SD patterns in order to determine SD adaptation for energy saving. In this case, when PMI reporting is configured in reportQuantity of the CSI report, and CSI reporting using a differential PMI is configured, the terminal may determine a PMI subset based on a PMI (or common PMI) 1901 obtained via a reference sub-configuration. More specifically, the terminal may determine a PMI subset based on a part of a precoding matrix (or precoder) according to a common PMI, for example, a higher element, and report the PMI subset as differential PMI “00” 1902, and may determine another PMI subset based on another part of the precoding matrix according to the common PMI, for example, a lower element, and report the another PMI subset as differential PMI “01” 1903. Alternatively/in addition, the terminal may determine a PMI subset by using an even element of the precoding matrix according to the common PMI and report the PMI subset as differential PMI “10” 1904, and may determine a PMI subset by using an odd element of the precoding matrix according to the common PMI and report the PMI subset as differential PMI “10” 1905. This may be defined as CSI content of a 2-bit differential PMI as shown in Table 22 below. However, the disclosure is not limited to the example in Table 22 below.

TABLE 22
Differential PMI (2 bit)

| | |
|---|---|
| 00 | Determination from higher element of reference PMI |
| 01 | Determination from lower element of reference PMI |
| 10 | Determination using even element of reference PMI |
| 11 | Determination using odd element of reference PMI |

Via the method above, the terminal may report the best PMI subset selected by the terminal. In addition, if the base station preconfigures or indicates one of differential PMI methods via higher-layer signaling or L1 signaling, the terminal may make a determination and calculate a CQI by using a configured PMI subset determination method without differential PMI reporting.

### Third Embodiment

The third embodiment of the disclosure proposes a method of determining a mapping order of CSI fields when transmitting, via one CSI report, multiple pieces of CSI feedback according to spatial domain (SD) patterns for application of SD adaptation and PD adaptation for energy saving or while a base station is applying the SD adaptation and PD adaptation.

Referring to FIG. 18, a base station may configure a CSI report from a terminal with respect to multiple SD patterns in order to determine SD adaptation for energy saving. In this case, different sub-configurations corresponding to L SD patterns in one CSI-reportConfig may be configured 1801 via higher-layer signaling from the base station. Then, the base station may configure, via higher-layer signaling and L1 signaling, a terminal to perform CSI reporting for N sub-configurations among L sub-configurations, which are configured via CSI-reportConfig. Afterwards, the terminal may calculate N pieces of CSI according to N sub-configurations, based on the configured information, and then perform CSI reporting via a single PUCCH or PUSCH.

In this case, configuration information of the N sub-configurations may be configured via higher-layer signaling. In addition, for SD adaptation and PD adaptation, multiple N sub-configurations may be one-to-one mapped or one-to-multiple mapped (e.g., 1 CSI resource-to-N sub-configurations) to multiple CSI resources (The CSI resource may include one or more CSI-RS resource sets or one or more CSI-RS resources, and M CSI resources may be understood as M CSI-RS resource sets or M CSI-RS resources. Hereinafter, it is assumed that M CSI resources correspond to M CSI-RS resources). In this case, a power control offset value of a CSI-RS may be applied to each sub-configuration or CSI-RS resource, or multiple power control offset values may be configured in CSI-reportConfig. Based on the configuration, the differential report contents described in the first embodiment may be CSI-mapped. More specifically, the terminal may generate CSI based on M (or M cases) CSI-RS resources according to each sub-configuration, and when N sub-configurations are considered, N*M pieces of CSI information according to the number N of multiple sub-configurations and the number M of multiple CSI-RS resources may be mapped and transmitted. The method of transmitting multiple pieces of CSI may be determined according to one of or a combination of the following methods.

In the following methods, as in the prior art, CRI may be used to indicate one CSI-RS resource in a CSI-RS resource set. However, CRI may indicate an index of one among M CSI-RS resources configured in a specific sub-configuration, or may be a value configured sequentially from 0 to M−1 or 1 to M in a mapping order.

### [Method 1]

Method 1 proposes a mapping order of CSI fields for transmitting N*M pieces of CSI for N sub-configurations*M CSI-RS resources via a single-part CSI report. More specifically, the following method of, with respect to CSI contents, determining a mapping order for each CSI content of M*N pieces of CSI is proposed. Table 23 is a table describing the mapping order of CSI fields of one CSI report with multiple sub-configurations [and multiple CSI resources], pmi-FormatIndicator=widebandPMI and cqi-FormatIndicator=widebandCQI, or reportQuantity set to “cri-RI-CQI” and cqi-FormatIndicator=widebandCQI.

TABLE 23

| CSI report | |
|---|---|
| number | CSI fields |
| CSI report #n | CRI#1 of sub-config#1 as in Tables 6.3.1.1.2-3/4, if reported |
| | Rank Indicator of sub-config#1 as in Tables 6.3.1.1.2-3/4, if reported |
| | Layer Indicator of sub-config#1 as in Tables 6.3.1.1.2-3/4, if reported |
| | Zero padding bits of sub-config#1 O_{P1}, if needed |
| | PMI wideband information fields X₁ of sub-config#1, from left to right |
| | as in Tables 6.3.1.1.2-1/2, if reported |
| | PMI wideband information fields X₂ of sub-config#1, from left to right |
| | as in Tables 6.3.1.1.2-1/2, or codebook index for 2 antenna ports |
| | according to Clause 5.2.2.2.1 in [6, TS38.214], if reported |
| | Wideband CQI for the first TB of sub-config#1 as in Tables 6.3.1.1.2-3/4, |
| | if reported |
| | Wideband CQI for the second TB of sub-config#1 as in Tables 6.3.1.1.2-3/4, |
| | if reported |
| | CRI#2 of sub-config#1 as in Tables 6.3.1.1.2-3/4, if reported |
| | Rank Indicator of sub-config#1 as in Tables 6.3.1.1.2-3/4, if reported |
| | Layer Indicator of sub-config#1 as in Tables 6.3.1.1.2-3/4, if reported |
| | Zero padding bits of sub-config#1 O_{P2}, if needed |
| | PMI wideband information fields X₁ of sub-config#1, from left to right |
| | as in Tables 6.3.1.1.2-1/2, if reported |
| | PMI wideband information fields X₂ of sub-config#1, from left to right |
| | as in Tables 6.3.1.1.2-1/2, or codebook index for 2 antenna ports |
| | according to Clause 5.2.2.2.1 in [6, TS38.214], if reported |
| | Wideband CQI for the first TB of sub-config#1 as in Tables 6.3.1.1.2-3/4, |
| | if reported |
| | Wideband CQI for the second TB of sub-config#1 as in Tables 6.3.1.1.2-3/4, |
| | if reported |
| | . . . |
| | CRI#M of sub-config#N as in Tables 6.3.1.1.2-3/4, if reported |
| | Rank Indicator of sub-config#N as in Tables 6.3.1.1.2-3/4, if reported |
| | Layer Indicator of sub-config#N as in Tables 6.3.1.1.2-3/4, if reported |
| | Zero padding bits of sub-config#N O_{Pi}, if needed |
| | PMI wideband information fields X₁ of sub-config#N, from left to right |
| | as in Tables 6.3.1.1.2-1/2, if reported |
| | PMI wideband information fields X₂ of sub-config#N, from left to right |
| | as in Tables 6.3.1.1.2-1/2, or codebook index for 2 antenna ports |
| | according to Clause 5.2.2.2.1 in [6, TS38.214], if reported |
| | Wideband CQI for the first TB of sub-config#N as in Tables 6.3.1.1.2-3/4, |
| | if reported |
| | Wideband CQI for the second TB of sub-config#N as in Tables 6.3.1.1.2-3/4, |
| | if reported |

As shown in Table 23, the mapping order may be determined so that the N*M pieces of CSI are included in one single-part CSI report. Table 23 is an example in which CSI is ordered in sequence for each sub-configuration according to a sub-configuration index, and CSI is ordered according to a CSI-RS resource index corresponding to each sub-configuration.

In this case, zero padding bit Oₚ may be determined by applying an existing equation to each of the N*M pieces of CSI or determined as shown in Table 24 below. Table 24 is a table describing a method for determining zero padding bit Oₚ.

```
TABLE 24
$Zero padding bit {O}_{p} , where {O}_{p} = {\sum }_{i = 1}^{N} {N}_{max , i} - {N}_{reported , i}$
for CSI report including N * M CSIs, where
  ${N}_{max , i} = {max}_{r ∈ {S}_{R a n k}} N * M * B ( r ) , and {S}_{Rank} is the set of rank values$
  r that are allowed to be reported by ith sub-configuration, and
  N is number of sub-configurations indicated by MAC CE or DCI,
  M is number of CSI-RS resource configured in resourceset.
  N_{reported,i} = B(R), where R is the reported rank by ith sub-
  configuration;
  B(r) = N_{PMI,i1}(r) + N_{PMI,i2}(r) + N_{CQI}(r)
```

### [Method 2]

Method 2 proposes a mapping order of CSI fields for transmitting N*M pieces of CSI for N sub-configurations*M CSI-RS resources via a single-part CSI report. More specifically, the following method of, with respect to CSI contents, determining a mapping order for each CSI content of M*N pieces of CSI is proposed. Table 25 is a table describing the mapping order of CSI fields of one CSI report with multiple sub-configurations [and multiple CSI resources], pmi-FormatIndicator=widebandPMI and cqi-FormatIndicator=widebandCQI, or reportQuantity set to “cri-RI-CQI” and cqi-FormatIndicator=widebandCQI.

TABLE 25

| CSI report | |
|---|---|
| number | CSI fields |
| CSI report #n | CRI#1 of sub-config#1 as in Tables 6.3.1.1.2-3/4, if reported |
| | Rank Indicator of sub-config#1 as in Tables 6.3.1.1.2-3/4, if reported |
| | Layer Indicator of sub-config#1 as in Tables 6.3.1.1.2-3/4, if reported |
| | Zero padding bits of sub-config#1 O_{P1}, if needed |
| | PMI wideband information fields X₁ of sub-config#1, from left to right |
| | as in Tables 6.3.1.1.2-1/2, if reported |
| | PMI wideband information fields X₂ of sub-config#1, from left to right |
| | as in Tables 6.3.1.1.2-1/2, or codebook index for 2 antenna ports |
| | according to Clause 5.2.2.2.1 in [6, TS38.214], if reported |
| | Wideband CQI for the first TB of sub-config#1 as in Tables 6.3.1.1.2-3/4, |
| | if reported |
| | Wideband CQI for the second TB of sub-config#1 as in Tables 6.3.1.1.2-3/4, |
| | if reported |
| | CRI#1 of sub-config#2 as in Tables 6.3.1.1.2-3/4, if reported |
| | Rank Indicator of sub-config#2 as in Tables 6.3.1.1.2-3/4, if reported |
| | Layer Indicator of sub-config#2 as in Tables 6.3.1.1.2-3/4, if reported |
| | Zero padding bits of sub-config#2 O_{P2}, if needed |
| | PMI wideband information fields X₁ of sub-config#2, from left to right |
| | as in Tables 6.3.1.1.2-1/2, if reported |
| | PMI wideband information fields X₂ of sub-config#2, from left to right |
| | as in Tables 6.3.1.1.2-1/2, or codebook index for 2 antenna ports |
| | according to Clause 5.2.2.2.1 in [6, TS38.214], if reported |
| | Wideband CQI for the first TB of sub-config#2 as in |
| | Tables 6.3.1.1.2-3/4, if reported |
| | Wideband CQI for the second TB of sub-config#2 as in Tables 6.3.1.1.2-3/4, |
| | if reported |
| | . . . |
| | CRI#M of sub-config#N as in Tables 6.3.1.1.2-3/4, if reported |
| | Rank Indicator of sub-config#N as in Tables 6.3.1.1.2-3/4, if reported |
| | Layer Indicator of sub-config#N as in Tables 6.3.1.1.2-3/4, if reported |
| | Zero padding bits of sub-config#N O_{Pi}, if needed |
| | PMI wideband information fields X₁ 1 of sub-config#N, from left to right |
| | as in Tables 6.3.1.1.2-1/2, if reported |
| | PMI wideband information fields X₂ of sub-config#N, from left to right |
| | as in Tables 6.3.1.1.2-1/2, or codebook index for 2 antenna ports |
| | according to Clause 5.2.2.2.1 in [6, TS38.214], if reported |
| | Wideband CQI for the first TB of sub-config#N as in Tables 6.3.1.1.2-3/4, |
| | if reported |
| | Wideband CQI for the second TB of sub-config#N as in Tables 6.3.1.1.2-3/4, |
| | if reported |

As shown in Table 25, the mapping order may be determined so that the N*M pieces of CSI are included in one single-part CSI report. Table 25 is an example in which CSI is ordered according to indexes of CSI-RS resources, and the CSI is ordered in the order of sub-configuration indexes based on the sub-configuration indexes related to the respective CSI-RS resources.

In this case, zero padding bit Oₚ may be determined by applying an existing equation to each of the N*M pieces of CSI or determined as shown in Table 26 below. Table 26 is a table describing a method for determining zero padding bit Oₚ.

```
TABLE 26
$Zero padding bit {O}_{p} , where {O}_{p} = {\sum }_{i = 1}^{N} {N}_{max , i} - {N}_{reported , i}$
for CSI report including N * M CSIs, where
  ${N}_{max , i} = {max}_{r ∈ {S}_{R a n k}} N * M * B ( r ) , and {S}_{Rank} is the set of rank values$
  r that are allowed to be reported by ith sub-configuration, and
  N is number of sub-configurations indicated by MAC CE or DCI,
  M is number of CSI-RS resource configured in resourceset.
  N_{reported,i} = B(R), where R is the reported rank by ith sub-
  configuration;
  B(r) = N_{PMI,i1}(r) + N_{PMI,i2}(r) + N_{CQI}(r)
```

### [Method 3]

Method 3 proposes a mapping order of CSI fields for transmitting N*M pieces of CSI for N sub-configurations*M CSI-RS resources via a single-part CSI report. More specifically, the following method of, with respect to CSI contents, determining a mapping order for each CSI content of M*N pieces of CSI is proposed. Table 27 is a table describing the mapping order of CSI fields of one CSI report with multiple sub-configurations [and multiple CSI resources], pmi-FormatIndicator=widebandPMI and cqi-FormatIndicator=widebandCQI, or reportQuantity set to “cri-RI-CQI” and cqi-FormatIndicator=widebandCQI.

TABLE 27

| CSI report | |
|---|---|
| number | CSI fields |
| CSI report #n | CRI#1 of sub-config#1 as in Tables 6.3.1.1.2-3/4, if reported |
| | CRI#2 of sub-config#1 as in Tables 6.3.1.1.2-3/4, if reported |
| | . . . |
| | CRI#M of sub-config#N as in Tables 6.3.1.1.2-3/4, if reported |
| | Rank Indicator of CRI#1 of sub-config#1 as in Tables 6.3.1.1.2-3/4, if |
| | reported |
| | Rank Indicator of CRI#2 of sub-config#1 as in Tables 6.3.1.1.2-3/4, if |
| | reported |
| | . . . |
| | Rank Indicator of CRI#M of sub-config#N as in Tables 6.3.1.1.2-3/4, if |
| | reported |
| | Layer Indicator of CRI#1 of sub-config#1 as in Tables 6.3.1.1.2-3/4, if |
| | reported |
| | Layer Indicator of CRI#2 of sub-config#1 as in Tables 6.3.1.1.2-3/4, if |
| | reported |
| | . . . |
| | Layer Indicator of CRI#M of sub-config#N as in Tables 6.3.1.1.2-3/4, if |
| | reported |
| | Zero padding bits of CRI#1 of sub-config#1 O_{P1}, if needed |
| | Zero padding bits of CRI#2 of sub-config#1 O_{P1}, if needed |
| | . . . |
| | Zero padding bits of CRI#M of sub-config#N O_{P1}, if needed |
| | PMI wideband information fields X₁ of CRI#1 of sub-config#1, from |
| | left to right as in Tables 6.3.1.1.2-1/2, if reported |
| | PMI wideband information fields X₁ of CRI#2 of sub-config#1, from |
| | left to right as in Tables 6.3.1.1.2-1/2, if reported |
| | . . . |
| | PMI wideband information fields X₁ of CRI#M of sub-config#N, from |
| | left to right as in Tables 6.3.1.1.2-1/2, if reported |
| | PMI wideband information fields X₂ of CRI#1 of sub-config#1, from |
| | left to right as in Tables 6.3.1.1.2-1/2, or codebook index for 2 antenna |
| | ports according to Clause 5.2.2.2.1 in [6, TS38.214], if reported |
| | PMI wideband information fields X₂ of CRI#2 of sub-config#1, from |
| | left to right as in Tables 6.3.1.1.2-1/2, or codebook index for 2 antenna |
| | ports according to Clause 5.2.2.2.1 in [6, TS38.214], if reported |
| | . . . |
| | PMI wideband information fields X₂ of CRI#M of sub-config#N, from |
| | left to right as in Tables 6.3.1.1.2-1/2, or codebook index for 2 antenna |
| | ports according to Clause 5.2.2.2.1 in [6, TS38.214], if reported |
| | Wideband CQI for the first TB of CRI#1 of sub-config#1 as in Tables |
| | 6.3.1.1.2-3/4, if reported |
| | Wideband CQI for the first TB of CRI#2 of sub-config#1 as in Tables |
| | 6.3.1.1.2-3/4, if reported |
| | . . . |
| | Wideband CQI for the first TB of CRI#M of sub-config#N as in Tables |
| | 6.3.1.1.2-3/4, if reported |
| | Wideband CQI for the second TB of CRI#1 of sub-config#1 as in Tables |
| | 6.3.1.1.2-3/4, if reported |
| | Wideband CQI for the second TB of CRI#2 of sub-config#1 as in Tables |
| | 6.3.1.1.2-3/4, if reported |
| | . . . |
| | Wideband CQI for the second TB of CRI#M of sub-config#N as in Tables |
| | 6.3.1.1.2-3/4, if reported |

As shown in Table 27, the mapping order may be determined so that the N*M pieces of CSI are included in one single-part CSI report. Table 27 is an example in which the CSI is sorted by sub-configuration according to a sub-configuration index, wherein ordering is performed for each CSI content within one sub-configuration, and the CSI contents are additionally ordered based on CSI-RS resource indexes according to respective sub-configurations.

In this case, zero padding bit Oₚ may be determined by applying an existing equation to each of the N*M pieces of CSI or determined as shown in Table 28 below. Table 28 is a table describing a method for determining zero padding bit Oₚ.

```
TABLE 28
$Zero padding bit {O}_{p} , where {O}_{p} = {\sum }_{i = 1}^{N} {N}_{max , i} - {N}_{reported , i}$
for CSI report including N * M CSIs, where
  ${N}_{max , i} = {max}_{r ∈ {S}_{R a n k}} N * M * B ( r ) , and {S}_{Rank} is the set of rank values$
  r that are allowed to be reported by ith sub-configuration, and
  N is number of sub-configurations indicated by MAC CE or DCI,
  M is number of CSI-RS resource configured in resourceset.
  N_{reported,i} = B(R), where R is the reported rank by ith sub-
  configuration;
  B(r) = N_{PMI,i1}(r) + N_{PMI,i2}(r) + N_{CQI}(r)
```

### [Method 4]

Method 4 proposes a mapping order of CSI fields for transmitting N*M pieces of CSI for N sub-configurations*M CSI-RS resources via a single-part CSI report. More specifically, the following method of, with respect to CSI contents, determining a mapping order for each CSI content of M*N pieces of CSI is proposed. Table 29 is a table describing the mapping order of CSI fields of one CSI report with multiple sub-configurations [and multiple CSI resources], pmi-FormatIndicator=widebandPMI and cqi-FormatIndicator=widebandCQI, or reportQuantity set to “cri-RI-CQI” and cqi-FormatIndicator=widebandCQI.

TABLE 29

| CSI report | |
|---|---|
| number | CSI fields |
| CSI report #n | CRI#1 of sub-config#1 as in Tables 6.3.1.1.2-3/4, if reported |
| | CRI#1 of sub-config#2 as in Tables 6.3.1.1.2-3/4, if reported |
| | . . . |
| | CRI#M of sub-config#N as in Tables 6.3.1.1.2-3/4, if reported |
| | Rank Indicator of sub-config#1 as in Tables 6.3.1.1.2-3/4, if reported |
| | Rank Indicator of sub-config#2 as in Tables 6.3.1.1.2-3/4, if reported |
| | . . . |
| | Rank Indicator of sub-config#N as in Tables 6.3.1.1.2-3/4, if reported |
| | Layer Indicator of sub-config#1 as in Tables 6.3.1.1.2-3/4, if reported |
| | Layer Indicator of sub-config#2 as in Tables 6.3.1.1.2-3/4, if reported |
| | . . . |
| | Layer Indicator of sub-config#N as in Tables 6.3.1.1.2-3/4, if reported |
| | Zero padding bits of sub-config#1 O_{P1}, if needed |
| | Zero padding bits of sub-config#2 O_{P1}, if needed |
| | . . . |
| | Zero padding bits of sub-config#N O_{P1}, if needed |
| | PMI wideband information fields X₁ of sub-config#1, from left to right |
| | as in Tables 6.3.1.1.2-1/2, if reported |
| | PMI wideband information fields X₁ of sub-config#2, from left to right |
| | as in Tables 6.3.1.1.2-1/2, if reported |
| | . . . |
| | PMI wideband information fields X₁ of sub-config#N, from left to right |
| | as in Tables 6.3.1.1.2-1/2, if reported |
| | PMI wideband information fields X₂ of sub-config#1, from left to right |
| | as in Tables 6.3.1.1.2-1/2, or codebook index for 2 antenna ports |
| | according to Clause 5.2.2.2.1 in [6, TS38.214], if reported |
| | PMI wideband information fields X₂ of sub-config#2, from left to right |
| | as in Tables 6.3.1.1.2-1/2, or codebook index for 2 antenna ports |
| | according to Clause 5.2.2.2.1 in [6, TS38.214], if reported |
| | . . . |
| | PMI wideband information fields X₂ of sub-config#N, from left to right |
| | as in Tables 6.3.1.1.2-1/2, or codebook index for 2 antenna ports |
| | according to Clause 5.2.2.2.1 in [6, TS38.214], if reported |
| | Wideband CQI for the first TB of sub-config#1 as in |
| | Tables 6.3.1.1.2-3/4, if reported |
| | Wideband CQI for the first TB of sub-config#2 as in |
| | Tables 6.3.1.1.2-3/4, if reported |
| | . . . |
| | Wideband CQI for the first TB of sub-config#N as in |
| | Tables 6.3.1.1.2-3/4, if reported |
| | Wideband CQI for the second TB of sub-config#1 as in |
| | Tables 6.3.1.1.2-3/4, if reported |
| | Wideband CQI for the second TB of sub-config#2 as in |
| | Tables 6.3.1.1.2-3/4, if reported |
| | . . . |
| | Wideband CQI for the second TB of sub-config#N as in |
| | Tables 6.3.1.1.2-3/4, if reported |

As shown in Table 29, the mapping order may be determined so that the N*M pieces of CSI are included in one single-part CSI report. Table 29 is an example in which the CSI is sorted by CSI content, wherein the CSI is ordered according to a CSI-RS resource index within each CSI content, and each piece of CSI is additionally ordered based on a sub-configuration index after each CSI-RS resource index.

In this case, zero padding bit Oₚ may be determined by applying an existing equation to each of the N*M pieces of CSI or determined as shown in Table 30 below. Table 30 is a table describing a method for determining zero padding bit Oₚ.

```
TABLE 30
$Zero padding bit {O}_{p} , where {O}_{p} = {\sum }_{i = 1}^{N} {N}_{max , i} - {N}_{reported , i}$
for CSI report including N * M CSIs, where
  ${N}_{max , i} = {max}_{r ∈ {S}_{R a n k}} N * M * B ( r ) , and {S}_{Rank} is the set of rank values$
  r that are allowed to be reported by ith sub-configuration, and
  N is number of sub-configurations indicated by MAC CE or DCI,
  M is number of CSI-RS resource configured in resourceset.
  N_{reported,i} = B(R), where R is the reported rank by ith sub-
  configuration;
  B(r) = N_{PMI,i1}(r) + N_{PMI,i2}(r) + N_{CQI}(r)
```

### [Method 5]

Method 5 proposes a mapping order of CSI fields for transmitting N*M pieces of CSI for N sub-configurations*M CSI-RS resources via a two-part CSI report. More specifically, the following method of, with respect to CSI contents, determining a mapping order for each CSI content of M*N pieces of CSI is proposed. Table 31 is a table describing the mapping order of CSI fields of one CSI report with multiple sub-configurations [and multiple CSI resources], CSI part 1, pmi-FormatIndicator=subbandPMI or cqi-FormatIndicator=subbandCQI. Table 32 is a table describing the mapping order of CSI fields of one CSI report with multiple sub-configurations [and multiple CSI resources], CSI part 2 wideband, pmi-FormatIndicator=subbandPMI or cqi-FormatIndicator=subbandCQI. Table 33 is a table describing the mapping order of CSI fields of one CSI report with multiple sub-configurations [and multiple CSI resources], CSI part 2 subband, pmi-FormatIndicator=subbandPMI or cqi-FormatIndicator=subbandCQI.

TABLE 31

| CSI report | |
|---|---|
| number | CSI fields |
| CSI report #n | CRI#1 of sub-config#1 as in Tables 6.3.1.1.2-3/4, |
| CSI part 1 | if reported |
| | Rank Indicator of sub-config#1 as in |
| | Tables 6.3.1.1.2-3/4/5, if reported |
| | Wideband CQI for the first TB of sub-config#1 as in |
| | Tables 6.3.1.1.2-3/4/5, if reported |
| | Subband differential CQI for the first TB with increasing |
| | order of subband number of sub-config#1 as in Tables |
| | 6.3.1.1.2-3/4/5, if reported |
| | CRI#2 of sub-config#1 as in Tables 6.3.1.1.2-3/4, |
| | if reported |
| | Rank Indicator of sub-config#1 as in Tables |
| | 6.3.1.1.2-3/4/5, if reported |
| | Wideband CQI for the first TB of sub-config#1 as in |
| | Tables 6.3.1.1.2-3/4/5, if reported |
| | Subband differential CQI for the first TB with increasing |
| | order of subband number of sub-config#1 as in |
| | Tables 6.3.1.1.2-3/4/5, if reported |
| | . . . |
| | CRI#M of sub-config#N as in Tables 6.3.1.1.2-3/4, |
| | if reported |
| | Rank Indicator of sub-config#N as in |
| | Tables 6.3.1.1.2-3/4/5, if reported |
| | Wideband CQI for the first TB of sub-config#N as in |
| | Tables 6.3.1.1.2-3/4/5, if reported |
| | Subband differential CQI for the first TB with |
| | increasing order of subband number of sub-config#N |
| | as in Tables 6.3.1.1.2-3/4/5, if reported |

Note:
Subbands for given CSI report n indicated by the higher layer parameter csi-ReportingBand are numbered continuously in the increasing order with the lowest subband of csi-ReportingBand as subband 0.

TABLE 32

| CSI report | |
|---|---|
| number | CSI fields |
| CSI report #n | Wideband CQI for the second TB of sub-config#1 with CRI#1 as in |
| CSI part 2 | Tables 6.3.1.1.2-3/4/5, if present and reported |
| wideband | Layer Indicator of sub-config#1 with CRI#1 as in Tables 6.3.1.1.2-3/4/5, |
| | if reported |
| | PMI wideband information fields X₁ of sub-config#1 with CRI#1, from |
| | left to right as in Tables 6.3.1.1.2-1/2, if reported |
| | PMI wideband information fields X₂ of sub-config#1 with CRI#1, from |
| | left to right as in Tables 6.3.1.1.2-1/2, or codebook index for 2 antenna |
| | ports according to Clause 5.2.2.2.1 in [6, TS38.214], if |
| | pmi-FormatIndicator = widebandPMI and if reported |
| | Wideband CQI for the second TB of sub-config#1 with CRI#2 as in |
| | Tables 6.3.1.1.2-3/4/5, if present and reported |
| | Layer Indicator of sub-config#1 with CRI#2 as in Tables 6.3.1.1.2-3/4/5, |
| | if reported |
| | PMI wideband information fields X₁ of sub-config#1 with CRI#2, from |
| | left to right as in Tables 6.3.1.1.2-1/2, if reported |
| | PMI wideband information fields X₂ of sub-config#1 with CRI#2, from |
| | left to right as in Tables 6.3.1.1.2-1/2, or codebook index for 2 antenna |
| | ports according to Clause 5.2.2.2.1 in [6, TS38.214], if |
| | pmi-FormatIndicator = widebandPMI and if reported |
| | . . . |
| | Wideband CQI for the second TB of sub-config#N with CRI#M as in |
| | Tables 6.3.1.1.2-3/4/5, if present and reported |
| | Layer Indicator of sub-config#N with CRI#M as in |
| | Tables 6.3.1.1.2-3/4/5, if reported |
| | PMI wideband information fields X₁ of sub-config#N with CRI#M, |
| | from left to right as in Tables 6.3.1.1.2-1/2, if reported |
| | PMI wideband information fields X₂, of sub-config#N with CRI#M, |
| | from left to right as in Tables 6.3.1.1.2-1/2, or codebook index for 2 |
| | antenna ports according to Clause 5.2.2.2.1 in [6, TS38.214], if |
| | pmi-FormatIndicator = widebandPMI and if reported |

TABLE 33

| | |
|---|---|
| CSI report | Subband differential CQI for the second TB of all even subbands with |
| #n | increasing order of subband number of sub-config#1 with CRI#1, as in |
| Part 2 | Tables 6.3.1.1.2-3/4/5, if cqi-FormatIndicator = subbandCQI and if reported |
| subband | PMI subband information fields X₂ of all even subbands with increasing |
| | order of subband number of sub-config#1 with CRI#1, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#1 with CRI#1, if |
| | pmi-FormatIndicator = subbandPMI and if reported |
| | Subband differential CQI for the second TB of all even subbands with |
| | increasing order of subband number of sub-config#1 with CRI#2, as in |
| | Tables 6.3.1.1.2-3/4/5, if cqi-FormatIndicator = subbandCQI and if reported |
| | PMI subband information fields X₂ of all even subbands with increasing |
| | order of subband number of sub-config#1 with CRI#2, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#1 with CRI#2, if |
| | pmi-FormatIndicator = subbandPMI and if reported |
| | . . . |
| | Subband differential CQI for the second TB of all even subbands with |
| | increasing order of subband number of sub-config#N with CRI#M, as in |
| | Tables 6.3.1.1.2-3/4/5, if cqi-FormatIndicator = subbandCQI and if reported |
| | PMI subband information fields X₂ of all even subbands with increasing |
| | order of subband number of sub-config#N with CRI#M, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#N with CRI#M, if |
| | pmi-FormatIndicator = subbandPMI and if reported |
| | Subband differential CQI for the second TB of all odd subbands with |
| | increasing order of subband number of sub-config#1 with CRI#1, as in |
| | Tables 6.3.1.1.2-3/4/5, if cqi-FormatIndicator = subbandCQI and if reported |
| | PMI subband information fields X₂ of all odd subbands with increasing |
| | order of subband number of sub-config#1 with CRI#1, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number, if pmi-FormatIndicator = subbandPMI and if reported |
| | Subband differential CQI for the second TB of all odd subbands with |
| | increasing order of subband number of sub-config#1 with CRI#2, as in |
| | Tables 6.3.1.1.2-3/4/5, if cqi-FormatIndicator = subbandCQI and if reported |
| | PMI subband information fields X₂ of all odd subbands with increasing |
| | order of subband number of sub-config#1 with CRI#2, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number of sub-config#1 with CRI#2, if |
| | pmi-FormatIndicator = subbandPMI and if reported |
| | . . . |
| | Subband differential CQI for the second TB of all odd subbands with |
| | increasing order of subband number of sub-config#N with CRI#M, as in |
| | Tables 6.3.1.1.2-3/4/5, if cqi-FormatIndicator = subbandCQI and if reported |
| | PMI subband information fields X₂ of all odd subbands with increasing |
| | order of subband number of sub-config#N with CRI#M, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number of sub-config#N with CRI#M, if |
| | pmi-FormatIndicator = subbandPMI and if reported |

As shown in Tables 31 to 33, the mapping order may be determined by considering a wideband and a subband so that the N*M pieces of CSI are included in one two-part CSI report. Tables 31 to 33 are examples in which the CSI is sorted by sub-configuration and is sorted in sequence by index of the CSI-RS resource measured in association with the sub-configuration.

### [Method 6]

Method 6 proposes a mapping order of CSI fields for transmitting N*M pieces of CSI for N sub-configurations*M CSI-RS resources via a two-part CSI report. More specifically, the following method of, with respect to CSI contents, determining a mapping order for each CSI content of M*N pieces of CSI is proposed. Table 34 is a table describing the mapping order of CSI fields of one CSI report with multiple sub-configurations [and multiple CSI resources], CSI part 1, pmi-FormatIndicator=subbandPMI or cqi-FormatIndicator=subbandCQI. Table 35 is a table describing the mapping order of CSI fields of one CSI report with multiple sub-configurations [and multiple CSI resources], CSI part 2 wideband, pmi-FormatIndicator=subbandPMI or cqi-FormatIndicator=subbandCQI. Table 36 is a table describing the mapping order of CSI fields of one CSI report with multiple sub-configurations [and multiple CSI resources], CSI part 2 subband, pmi-FormatIndicator=subbandPMI or cqi-FormatIndicator=subbandCQI.

TABLE 34

| CSI report | |
|---|---|
| number | CSI fields |
| CSI report #n | CRI#1 of sub-config#1 as in Tables 6.3.1.1.2-3/4, if reported |
| CSI part 1 | Rank Indicator of sub-config#1 as in Tables 6.3.1.1.2-3/4/5, if reported |
| | Wideband CQI for the first TB of sub-config#1 as in |
| | Tables 6.3.1.1.2-3/4/5, if reported |
| | Subband differential CQI for the first TB with increasing order of |
| | subband number of sub-config#1 as in Tables 6.3.1.1.2-3/4/5, if |
| | reported |
| | CRI#1 of sub-config#2 as in Tables 6.3.1.1.2-3/4, if reported |
| | Rank Indicator of sub-config#2 as in Tables 6.3.1.1.2-3/4/5, if reported |
| | Wideband CQI for the first TB of sub-config#2 as in |
| | Tables 6.3.1.1.2-3/4/5, if reported |
| | Subband differential CQI for the first TB with increasing order of |
| | subband number of sub-config#2 as in Tables 6.3.1.1.2-3/4/5, if |
| | reported |
| | . . . |
| | CRI#M of sub-config#N as in Tables 6.3.1.1.2-3/4, if reported |
| | Rank Indicator of sub-config#N as in Tables 6.3.1.1.2-3/4/5, if reported |
| | Wideband CQI for the first TB of sub-config#N as in |
| | Tables 6.3.1.1.2-3/4/5, if reported |
| | Subband differential CQI for the first TB with increasing order of |
| | subband number of sub-config#N as in Tables 6.3.1.1.2-3/4/5, if |
| | reported |

Note:
Subbands for given CSI report n indicated by the higher layer parameter csi-ReportingBand are numbered continuously in the increasing order with the lowest subband of csi-ReportingBand as subband 0.

TABLE 35

| CSI report | |
|---|---|
| number | CSI fields |
| CSI report #n | Wideband CQI for the second TB of sub-config#1 with CRI#1 as in |
| CSI part 2 | Tables 6.3.1.1.2-3/4/5, if present and reported |
| wideband | Layer Indicator of sub-config#1 with CRI#1 as in Tables 6.3.1.1.2-3/4/5, |
| | if reported |
| | PMI wideband information fields X₁ of sub-config#1 with CRI#1, from |
| | left to right as in Tables 6.3.1.1.2-1/2, if reported |
| | PMI wideband information fields X₂ of sub-config#1 with CRI#1, from |
| | left to right as in Tables 6.3.1.1.2-1/2, or codebook index for 2 antenna |
| | ports according to Clause 5.2.2.2.1 in [6, TS38.214], if |
| | pmi-FormatIndicator = widebandPMI and if reported |
| | Wideband CQI for the second TB of sub-config#2 with CRI#1 as in |
| | Tables 6.3.1.1.2-3/4/5, if present and reported |
| | Layer Indicator of sub-config#2 with CRI#1 as in Tables 6.3.1.1.2-3/4/5, |
| | if reported |
| | PMI wideband information fields X₁ of sub-config#2 with CRI#1, from |
| | left to right as in Tables 6.3.1.1.2-1/2, if reported |
| | PMI wideband information fields X₂ of sub-config#2 with CRI#1, from |
| | left to right as in Tables 6.3.1.1.2-1/2, or codebook index for 2 antenna |
| | ports according to Clause 5.2.2.2.1 in [6, TS38.214], if |
| | pmi-FormatIndicator = widebandPMI and if reported |
| | . . . |
| | Wideband CQI for the second TB of sub-config#N with CRI#M as in |
| | Tables 6.3.1.1.2-3/4/5, if present and reported |
| | Layer Indicator of sub-config#N with CRI#M as in |
| | Tables 6.3.1.1.2-3/4/5, if reported |
| | PMI wideband information fields X₁ of sub-config#N with CRI#M, |
| | from left to right as in Tables 6.3.1.1.2-1/2, if reported |
| | PMI wideband information fields X₂, of sub-config#N with CRI#M, |
| | from left to right as in Tables 6.3.1.1.2-1/2, or codebook index for 2 |
| | antenna ports according to Clause 5.2.2.2.1 in [6, TS38.214], if |
| | pmi-FormatIndicator = widebandPMI and if reported |

TABLE 36

| | |
|---|---|
| CSI report | Subband differential CQI for the second TB of all even subbands with |
| #n | increasing order of subband number of sub-config#1 with CRI#1, as in |
| Part 2 | Tables 6.3.1.1.2-3/4/5, if cqi-FormatIndicator = subbandCQI and if reported |
| subband | PMI subband information fields X₂ of all even subbands with increasing |
| | order of subband number of sub-config#1 with CRI#1, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#1 with CRI#1, if |
| | pmi-FormatIndicator = subbandPMI and if reported |
| | Subband differential CQI for the second TB of all even subbands with |
| | increasing order of subband number of sub-config#2 with CRI#1, as in |
| | Tables 6.3.1.1.2-3/4/5, if cgi-FormatIndicator = subbandCQI and if reported |
| | PMI subband information fields X₂ of all even subbands with increasing |
| | order of subband number of sub-config#2 with CRI#1, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#2 with CRI#1, if |
| | pmi-FormatIndicator = subbandPMI and if reported |
| | . . . |
| | Subband differential CQI for the second TB of all even subbands with |
| | increasing order of subband number of sub-config#N with CRI#M, as in |
| | Tables 6.3.1.1.2-3/4/5, if cqi-FormatIndicator = subbandCQI and if reported |
| | PMI subband information fields X₂ of all even subbands with increasing |
| | order of subband number of sub-config#N with CRI#M, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#N with CRI#M, if |
| | pmi-FormatIndicator = subbandPMI and if reported |
| | Subband differential CQI for the second TB of all odd subbands with |
| | increasing order of subband number of sub-config#1 with CRI#1, as in |
| | Tables 6.3.1.1.2-3/4/5, if cqi-FormatIndicator = subbandCQI and if reported |
| | PMI subband information fields X₂ of all odd subbands with increasing |
| | order of subband number of sub-config#1 with CRI#1, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number, if pmi-FormatIndicator = subbandPMI and if reported |
| | Subband differential CQI for the second TB of all odd subbands with |
| | increasing order of subband number of sub-config#2 with CRI#1, as in |
| | Tables 6.3.1.1.2-3/4/5, if cqi-FormatIndicator = subbandCQI and if reported |
| | PMI subband information fields X₂ of all odd subbands with increasing |
| | order of subband number of sub-config#2 with CRI#1, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number of sub-config#2 with CRI#1, if |
| | pmi-FormatIndicator = subbandPMI and if reported |
| | . . . |
| | Subband differential CQI for the second TB of all odd subbands with |
| | increasing order of subband number of sub-config#N with CRI#M, as in |
| | Tables 6.3.1.1.2-3/4/5, if cqi-FormatIndicator = subbandCQI and if reported |
| | PMI subband information fields X₂ of all odd subbands with increasing |
| | order of subband number of sub-config#N with CRI#M, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number of sub-config#N with CRI#M, if |
| | pmi-FormatIndicator = subbandPMI and if reported |

As shown in Tables 34 to 36, the mapping order may be determined by considering a wideband and a subband so that the N*M pieces of CSI are included in one two-part CSI report. Tables 34 to 36 are examples in which the CSI is first sorted by CSI-RS resource index, and the CSI is sorted in sequence by index of the sub-configuration mapped to each CSI-RS resource.

### [Method 7]

Method 7 proposes a mapping order of CSI fields for transmitting N*M pieces of CSI for N sub-configurations*M CSI-RS resources via a two-part CSI report. More specifically, the following method of, with respect to CSI contents, determining a mapping order for each CSI content of M*N pieces of CSI is proposed. Table 37 is a table describing the mapping order of CSI fields of one CSI report with multiple sub-configurations [and multiple CSI resources], CSI part 1, pmi-FormatIndicator=subbandPMI or cqi-FormatIndicator=subbandCQI. Table 38 is a table describing the mapping order of CSI fields of one CSI report with multiple sub-configurations [and multiple CSI resources], CSI part 2 wideband, pmi-FormatIndicator=subbandPMI or cqi-FormatIndicator=subbandCQI. Table 39 is a table describing the mapping order of CSI fields of one CSI report with multiple sub-configurations [and multiple CSI resources], CSI part 2 subband, pmi-FormatIndicator=subbandPMI or cqi-FormatIndicator=subbandCQI.

TABLE 37

| CSI report | |
|---|---|
| number | CSI fields |
| CSI report #n | CRI#1 of sub-config#1 as in Tables 6.3.1.1.2-3/4, if reported |
| CSI part 1 | CRI#1 of sub-config#2 as in Tables 6.3.1.1.2-3/4, if reported |
| | . . . |
| | CRI#M of sub-config#N as in Tables 6.3.1.1.2-3/4, if reported |
| | Rank Indicator of sub-config#1 as in Tables 6.3.1.1.2-3/4/5, if reported |
| | Rank Indicator of sub-config#2 as in Tables 6.3.1.1.2-3/4/5, if reported |
| | . . . |
| | Rank Indicator of sub-config#N as in Tables 6.3.1.1.2-3/4/5, if reported |
| | Wideband CQI for the first TB of sub-config#1 as in |
| | Tables 6.3.1.1.2-3/4/5, if reported |
| | Wideband CQI for the first TB of sub-config#2 as in |
| | Tables 6.3.1.1.2-3/4/5, if reported |
| | . . . |
| | Wideband CQI for the first TB of sub-config#N as in |
| | Tables 6.3.1.1.2-3/4/5, if reported |
| | Subband differential CQI for the first TB with increasing order of |
| | subband number of sub-config#1 as in Tables 6.3.1.1.2-3/4/5, if |
| | reported |
| | Subband differential CQI for the first TB with increasing order of |
| | subband number of sub-config#2 as in Tables 6.3.1.1.2-3/4/5, if |
| | reported |
| | . . . |
| | Subband differential CQI for the first TB with increasing order of |
| | subband number of sub-config#N as in Tables 6.3.1.1.2-3/4/5, if |
| | reported |

Note:
Subbands for given CSI report n indicated by the higher layer parameter csi-ReportingBand are numbered continuously in the increasing order with the lowest subband of csi-ReportingBand as subband 0.

TABLE 38

| CSI report | |
|---|---|
| number | CSI fields |
| CSI report #n | Wideband CQI for the second TB of sub-config#1 with CRI#1 as in |
| CSI part 2 | Tables 6.3.1.1.2-3/4/5, if present and reported |
| wideband | Wideband CQI for the second TB of sub-config#2 with CRI#1 as in |
| | Tables 6.3.1.1.2-3/4/5, if present and reported |
| | . . . |
| | Wideband CQI for the second TB of sub-config#N with CRI#M as in |
| | Tables 6.3.1.1.2-3/4/5, if present and reported |
| | Layer Indicator of sub-config#1 with CRI#1 as in Tables 6.3.1.1.2-3/4/5, |
| | if reported |
| | Layer Indicator of sub-config#2 with CRI#1 as in Tables 6.3.1.1.2-3/4/5, |
| | if reported |
| | . . . |
| | Layer Indicator of sub-config#N with CRI#M as in |
| | Tables 6.3.1.1.2-3/4/5, if reported |
| | PMI wideband information fields X₁ of sub-config#1 with CRI#1, from |
| | left to right as in Tables 6.3.1.1.2-1/2, if reported |
| | PMI wideband information fields X₁ of sub-config#2 with CRI#1, from |
| | left to right as in Tables 6.3.1.1.2-1/2, if reported |
| | . . . |
| | PMI wideband information fields X₁ of sub-config#N with CRI#M, |
| | from left to right as in Tables 6.3.1.1.2-1/2, if reported |
| | PMI wideband information fields X₂ of sub-config#1 with CRI#1, from |
| | left to right as in Tables 6.3.1.1.2-1/2, or codebook index for 2 antenna |
| | ports according to Clause 5.2.2.2.1 in [6, TS38.214], if |
| | pmi-FormatIndicator = widebandPMI and if reported |
| | PMI wideband information fields X₂, of sub-config#2 with CRI#1, from |
| | left to right as in Tables 6.3.1.1.2-1/2, or codebook index for 2 antenna |
| | ports according to Clause 5.2.2.2.1 in [6, TS38.214], if |
| | pmi-FormatIndicator = widebandPMI and if reported |
| | . . . |
| | PMI wideband information fields X₂ of sub-config#N with CRI#M, |
| | from left to right as in Tables 6.3.1.1.2-1/2, or codebook index for 2 |
| | antenna ports according to Clause 5.2.2.2.1 in [6, TS38.214], if |
| | pmi-FormatIndicator = widebandPMI and if reported |

TABLE 39

| | |
|---|---|
| CSI report | Subband differential CQI for the second TB of all even subbands with |
| #n | increasing order of subband number of sub-config#1 with CRI#1, as in |
| Part 2 | Tables 6.3.1.1.2-3/4/5, if cqi-FormatIndicator = subbandCQI and if reported |
| subband | Subband differential CQI for the second TB of all even subbands with |
| | increasing order of subband number of sub-config#2 with CRI#1, as in |
| | Tables 6.3.1.1.2-3/4/5, if cqi-FormatIndicator = subbandCQI and if reported |
| | . . . |
| | Subband differential CQI for the second TB of all even subbands with |
| | increasing order of subband number of sub-config#N with CRI#M, as in |
| | Tables 6.3.1.1.2-3/4/5, if cqi-FormatIndicator = subbandCQI and if reported |
| | PMI subband information fields X₂ of all even subbands with increasing |
| | order of subband number of sub-config#1 with CRI#1, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#1 with CRI#1, if |
| | pmi-FormatIndicator = subbandPMI and if reported |
| | PMI subband information fields X₂ of all even subbands with increasing |
| | order of subband number of sub-config#2 with CRI#1, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#2 with CRI#1, if |
| | pmi-FormatIndicator = subbandPMI and if reported |
| | . . . |
| | PMI subband information fields X₂ of all even subbands with increasing |
| | order of subband number of sub-config#N with CRI#M, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#N with CRI# M, if |
| | pmi-FormatIndicator = subbandPMI and if reported |
| | Subband differential CQI for the second TB of all odd subbands with |
| | increasing order of subband number of sub-config#1 with CRI#1, as in |
| | Tables 6.3.1.1.2-3/4/5, if cqi-FormatIndicator = subbandCQI and if reported |
| | Subband differential CQI for the second TB of all odd subbands with |
| | increasing order of subband number of sub-config#2 with CRI#1, as in |
| | Tables 6.3.1.1.2-3/4/5, if cqi-FormatIndicator = subbandCQI and if reported |
| | . . . |
| | Subband differential CQI for the second TB of all odd subbands with |
| | increasing order of subband number of sub-config#N with CRI#M, as in |
| | Tables 6.3.1.1.2-3/4/5, if cqi-FormatIndicator = subbandCQI and if reported |
| | PMI subband information fields X₂, of all odd subbands with increasing |
| | order of subband number of sub-config#1 with CRI#1, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number, if pmi-FormatIndicator = subbandPMI and if reported |
| | PMI subband information fields X₂ of all odd subbands with increasing |
| | order of subband number of sub-config#2 with CRI#1, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number of sub-config#2 with CRI#1, |
| | if pmi-FormatIndicator = subbandPMI and if reported |
| | . . . |
| | PMI subband information fields X₂ of all odd subbands with increasing |
| | order of subband number of sub-config#N with CRI#M, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number of sub-config#N with CRI#M, if |
| | pmi-FormatIndicator = subbandPMI and if reported |

As shown in Tables 37 to 39, the mapping order may be determined by considering a wideband and a subband so that the N*M pieces of CSI are included in one two-part CSI report. Tables 37 to 39 are examples in which the CSI is sorted by CSI content, the CSI is first sorted by CSI-RS resource within each CSI content, and then the CSI is sorted in sequence by sub-configuration mapped to the CSI-RS resource.

### [Method 8]

Method 8 proposes a mapping order of CSI fields for transmitting N*M pieces of CSI for N sub-configurations*M CSI-RS resources via a two-part CSI report. More specifically, the following method of, with respect to CSI contents, determining a mapping order for each CSI content of M*N pieces of CSI is proposed. Table 40 is a table describing the mapping order of CSI fields of one CSI report with multiple sub-configurations [and multiple CSI resources], CSI part 1, pmi-FormatIndicator=subbandPMI or cqi-FormatIndicator=subbandCQI. Table 41 is a table describing the mapping order of CSI fields of one CSI report with multiple sub-configurations [and multiple CSI resources], CSI part 2 wideband, pmi-FormatIndicator=subbandPMI or cqi-FormatIndicator=subbandCQI. Table 42 is a table describing the mapping order of CSI fields of one CSI report with multiple sub-configurations [and multiple CSI resources], CSI part 2 subband, pmi-FormatIndicator=subbandPMI or cqi-FormatIndicator=subbandCQI.

TABLE 40

| CSI report | |
|---|---|
| number | CSI fields |
| CSI report #n | CRI#1 of sub-config#1 as in Tables 6.3.1.1.2-3/4, if reported |
| CSI part 1 | CRI#2 of sub-config#1 as in Tables 6.3.1.1.2-3/4, if reported |
| | . . . |
| | CRI#M of sub-config#N as in Tables 6.3.1.1.2-3/4, if reported |
| | Rank Indicator of sub-config#1 as in Tables 6.3.1.1.2-3/4/5, if reported |
| | Rank Indicator of sub-config#1 as in Tables 6.3.1.1.2-3/4/5, if reported |
| | . . . |
| | Rank Indicator of sub-config#N as in Tables 6.3.1.1.2-3/4/5, if reported |
| | Wideband CQI for the first TB of sub-config#1 as in |
| | Tables 6.3.1.1.2-3/4/5, if reported |
| | Wideband CQI for the first TB of sub-config#1 as in |
| | Tables 6.3.1.1.2-3/4/5, if reported |
| | . . . |
| | Wideband CQI for the first TB of sub-config#N as in |
| | Tables 6.3.1.1.2-3/4/5, if reported |
| | Subband differential CQI for the first TB with increasing order of |
| | subband number of sub-config#1 as in Tables 6.3.1.1.2-3/4/5, if |
| | reported |
| | Subband differential CQI for the first TB with increasing order of |
| | subband number of sub-config#1 as in Tables 6.3.1.1.2-3/4/5, if |
| | reported |
| | . . . |
| | Subband differential CQI for the first TB with increasing order of |
| | subband number of sub-config#N as in Tables 6.3.1.1.2-3/4/5, if |
| | reported |

Note:
Subbands for given CSI report n indicated by the higher layer parameter csi-ReportingBand are numbered continuously in the increasing order with the lowest subband of csi-ReportingBand as subband 0.

TABLE 41

| CSI report | |
|---|---|
| number | CSI fields |
| CSI report #n | Wideband CQI for the second TB of sub-config#1 with CRI#1 as in |
| CSI part 2 | Tables 6.3.1.1.2-3/4/5, if present and reported |
| wideband | Wideband CQI for the second TB of sub-config#1 with CRI#2 as in |
| | Tables 6.3.1.1.2-3/4/5, if present and reported |
| | . . . |
| | Wideband CQI for the second TB of sub-config#N with CRI#M as in |
| | Tables 6.3.1.1.2-3/4/5, if present and reported |
| | Layer Indicator of sub-config#1 with CRI#1 as in Tables 6.3.1.1.2-3/4/5, |
| | if reported |
| | Layer Indicator of sub-config#1 with CRI#2 as in Tables 6.3.1.1.2-3/4/5, |
| | if reported |
| | . . . |
| | Layer Indicator of sub-config#N with CRI#M as in |
| | Tables 6.3.1.1.2-3/4/5, if reported |
| | PMI wideband information fields X₁ of sub-config#1 with CRI#1, from |
| | left to right as in Tables 6.3.1.1.2-1/2, if reported |
| | PMI wideband information fields X₁ of sub-config#1 with CRI#2, from |
| | left to right as in Tables 6.3.1.1.2-1/2, if reported |
| | . . . |
| | PMI wideband information fields X₁ of sub-config#N with CRI#M, |
| | from left to right as in Tables 6.3.1.1.2-1/2, if reported |
| | PMI wideband information fields X₂ of sub-config#1 with CRI#1, from |
| | left to right as in Tables 6.3.1.1.2-1/2, or codebook index for 2 antenna |
| | ports according to Clause 5.2.2.2.1 in [6, TS38.214], if |
| | pmi-FormatIndicator = widebandPMI and if reported |
| | PMI wideband information fields X₂, of sub-config#1 with CRI#2, from |
| | left to right as in Tables 6.3.1.1.2-1/2, or codebook index for 2 antenna |
| | ports according to Clause 5.2.2.2.1 in [6, TS38.214], if |
| | pmi-FormatIndicator = widebandPMI and if reported |
| | . . . |
| | PMI wideband information fields X₂, of sub-config#N with CRI#M, |
| | from left to right as in Tables 6.3.1.1.2-1/2, or codebook index for 2 |
| | antenna ports according to Clause 5.2.2.2.1 in [6, TS38.214], |
| | if pmi-FormatIndicator = widebandPMI and if reported |

TABLE 42

| | |
|---|---|
| CSI report #n Part 2 | Subband differential CQI for the second TB of all even subbands with |
| subband | increasing order of subband number of sub-config#1 with CRI#1, as in |
| | Tables 6.3.1.1.2-3/4/5, if cqi-FormatIndicator=subbandCQI and if reported |
| | Subband differential CQI for the second TB of all even subbands with |
| | increasing order of subband number of sub-config#1 with CRI#2, as in |
| | Tables 6.3.1.1.2-3/4/5, if cqi-FormatIndicator=subbandCQI and if reported |
| | . . . . . . |
| | Subband differential CQI for the second TB of all even subbands with |
| | increasing order of subband number of sub-config#N with CRI#M, as in |
| | Tables 6.3.1.1.2-3/4/5, if cqi-FormatIndicator=subbandCQI and if reported |
| | PMI subband information fields X₂ of all even subbands with increasing |
| | order of subband number of sub-config#1 with CRI#1, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#1 with CRI#1, if pmi-FormatIndicator= |
| | subbandPMI and if reported |
| | PMI subband information fields X₂ of all even subbands with increasing |
| | order of subband number of sub-config#1 with CRI#2, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#1 with CRI#2, if pmi-FormatIndicator= |
| | subbandPMI and if reported |
| | . . . . . . |
| | PMI subband information fields X₂ of all even subbands with increasing |
| | order of subband number of sub-config#N with CRI#M, from left to right as |
| | in Tables 6.3.1.1.2-1/2, or codebook index for 2 antenna ports according to |
| | Clause 5.2.2.2.1 in [6, TS38.214] of all even subbands with increasing order |
| | of subband number of sub-config#N with CRI# M, if pmi- |
| | FormatIndicator= subbandPMI and if reported |
| | Subband differential CQI for the second TB of all odd subbands with |
| | increasing order of subband number of sub-config#1 with CRI#1, as in |
| | Tables 6.3.1.1.2-3/4/5, if cqi-FormatIndicator=subbandCQI and if reported |
| | Subband differential CQI for the second TB of all odd subbands with |
| | increasing order of subband number of sub-config#1 with CRI#2, as in |
| | Tables 6.3.1.1.2-3/4/5, if cqi-FormatIndicator=subbandCQI and if reported |
| | . . . . . . |
| | Subband differential CQI for the second TB of all odd subbands with |
| | increasing order of subband number of sub-config#N with CRI#M, as in |
| | Tables 6.3.1.1.2-3/4/5, if cqi-FormatIndicator=subbandCQI and if reported |
| | PMI subband information fields X₂ of all odd subbands with increasing |
| | order of subband number of sub-config#1 with CRI#1, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number, if pmi-FormatIndicator= subbandPMI and if reported |
| | PMI subband information fields X₂ of all odd subbands with increasing |
| | order of subband number of sub-config#1 with CRI#2, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number of sub-config#2 with CRI#1, if pmi-FormatIndicator= |
| | subbandPMI and if reported |
| | . . . . . . |
| | PMI subband information fields X₂ of all odd subbands with increasing |
| | order of subband number of sub-config#N with CRI#M, from left to right as |
| | in Tables 6.3.1.1.2-1/2, or codebook index for 2 antenna ports according to |
| | Clause 5.2.2.2.1 in [6, TS38.214] of all odd subbands with increasing order |
| | of subband number of sub-config#N with CRI#M, if pmi-FormatIndicator= |
| | subbandPMI and if reported |

As shown in Tables 40 to 42, the mapping order may be determined by considering a wideband and a subband so that the N*M pieces of CSI are included in one two-part CSI report. Tables 40 to 42 are examples in which the CSI is sorted by CSI content, the CSI is sorted by index of the sub-configuration within each CSI content, and then the CSI is sorted in index order of the CSI-RS resource mapped to each sub-configuration.

### [Method 9]

Method 9 proposes a mapping order of CSI fields for transmitting N*M pieces of CSI for N sub-configurations*M CSI-RS resources via a single-part CSI report or a two-part CSI report. More specifically, the following method of, with respect to CSI contents, determining a mapping order for each CSI content of M*N pieces of CSI is proposed. Table 43 is a table describing the mapping order of CSI fields of one CSI report with multiple sub-configurations [and multiple CSI resources], pmi-FormatIndicator=widebandPMI cqi-FormatIndicator=widebandCQI, or reportQuantity set to “cri-RI-CQI” and cqi-FormatIndicator=widebandCQI. Table 44 is a table describing the mapping order of CSI fields of one CSI report with multiple sub-configurations [and multiple CSI resources], CSI part 1, pmi-FormatIndicator=subbandPMI or cqi-FormatIndicator=subbandCQI. Table 45 is a table describing the mapping order of CSI fields of one CSI report with multiple sub-configurations [and multiple CSI resources], CSI part 2 wideband, pmi-FormatIndicator=subbandPMI or cqi-FormatIndicator=subbandCQI. Table 46 is a table describing the mapping order of CSI fields of one CSI report with multiple sub-configurations [and multiple CSI resources], CSI part 2 subband, pmi-FormatIndicator=subbandPMI or cqi-FormatIndicator=subbandCQI.

TABLE 43

| CSI report | |
|---|---|
| number | CSI fields |
| CSI report of | CRI#1 as in Tables 6.3.1.1.2-3/4, if reported |
| sub-configuration#n | Rank Indicator as in Tables 6.3.1.1.2-3/4, if reported |
| | Layer Indicator as in Tables 6.3.1.1.2-3/4, if reported |
| | Zero padding bits Oₚ₁, if needed |
| | PMI wideband information fields X _{1,} from left to right as in Tables |
| | 6.3.1.1.2-1/2, if reported |
| | PMI wideband information fields X₂, from left to right as in Tables |
| | 6.3.1.1.2-1/2, or codebook index for 2 antenna ports according to Clause |
| | 5.2.2.2.1 in [6, TS38.214], if reported |
| | Wideband CQI for the first TB as in Tables 6.3.1.1.2-3/4, if reported |
| | Wideband CQI for the second TB as in Tables 6.3.1.1.2-3/4, if reported |
| | CRI#2 as in Tables 6.3.1.1.2-3/4, if reported |
| | Rank Indicator as in Tables 6.3.1.1.2-3/4, if reported |
| | Layer Indicator as in Tables 6.3.1.1.2-3/4, if reported |
| | Zero padding bits of Oₚ₂, if needed |
| | PMI wideband information fields X₁, from left to right as in Tables |
| | 6.3.1.1.2-1/2, if reported |
| | PMI wideband information fields X₂, from left to right as in Tables |
| | 6.3.1.1.2-1/2, or codebook index for 2 antenna ports according to Clause |
| | 5.2.2.2.1 in [6, TS38.214], if reported |
| | Wideband CQI for the first TB as in Tables 6.3.1.1.2-3/4, if reported |
| | Wideband CQI for the second TB as in Tables 6.3.1.1.2-3/4, if reported |
| | . . . . . . |
| | CRI#M as in Tables 6.3.1.1.2-3/4, if reported |
| | Rank Indicator as in Tables 6.3.1.1.2-3/4, if reported |
| | Layer Indicator as in Tables 6.3.1.1.2-3/4, if reported |
| | Zero padding bits Oₚᵢ, if needed |
| | PMI wideband information fields X_{1,} from left to right as in Tables |
| | 6.3.1.1.2-1/2, if reported |
| | PMI wideband information fields X_{1,} from left to right as in Tables |
| | 6.3.1.1.2-1/2, or codebook index for 2 antenna ports according to Clause |
| | 5.2.2.2.1 in [6, TS38.214], if reported |
| | Wideband CQI for the first TB as in Tables 6.3.1.1.2-3/4, if reported |
| | Wideband CQI for the second TB as in Tables 6.3.1.1.2-3/4, if reported |

TABLE 44

| CSI report | |
|---|---|
| number | CSI fields |
| CSI report of | CRI#1 as in Tables 6.3.1.1.2-3/4, if reported |
| sub-configuration #n | Rank Indicator as in Tables 6.3.1.1.2-3/4/5, if reported |
| CSI part 1 | Wideband CQI for the first TB as in Tables 6.3.1.1.2-3/4/5, if reported |
| | Subband differential CQI for the first TB with increasing order of |
| | subband number as in Tables 6.3.1.1.2-3/4/5, if reported |
| | CRI#2 as in Tables 6.3.1.1.2-3/4, if reported |
| | Rank Indicator as in Tables 6.3.1.1.2-3/4/5, if reported |
| | Wideband CQI for the first TB as in Tables 6.3.1.1.2-3/4/5, if reported |
| | Subband differential CQI for the first TB with increasing order of |
| | subband number as in Tables 6.3.1.1.2-3/4/5, if reported |
| | CRI#M as in Tables 6.3.1.1.2-3/4, if reported |
| | Rank Indicator as in Tables 6.3.1.1.2-3/4/5, if reported |
| | Wideband CQI for the first TB as in Tables 6.3.1.1.2-3/4/5, if reported |
| | Subband differential CQI for the first TB with increasing order of |
| | subband number as in Tables 6.3.1.1.2-3/4/5, if reported |

Note:
Subbands for given CSI report n indicated by the higher layer parameter csi-ReportingBand are numbered continuously in the increasing order with the lowest subband of csi-ReportingBand as subband 0.

TABLE 45

| CSI report | |
|---|---|
| number | CSI fields |
| CSI report of | Wideband CQI for the second TB of CRI#1 as in Tables 6.3.1.1.2-3/4/5, |
| sub-configuration | if present and reported |
| #n CSI part 2 | Layer Indicator of CRI#1 as in Tables 6.3.1.1.2-3/4/5, if reported |
| wideband | PMI wideband information fields X₁ of CRI#1, from left to right as in |
| | Tables 6.3.1.1.2-1/2, if reported |
| | PMI wideband information fields X₂ of CRI#1, from left to right as in |
| | Tables 6.3.1.1.2-1/2, or codebook index for 2 antenna ports according to |
| | Clause 5.2.2.2.1 in [6, TS38.214], if pmi-FormatIndicator= |
| | widebandPMI and if reported |
| | Wideband CQI for the second TB of CRI#2 as in Tables 6.3.1.1.2-3/4/5, |
| | if present and reported |
| | Layer Indicator of CRI#2 as in Tables 6.3.1.1.2-3/4/5, if reported |
| | PMI wideband information fields X₁ of CRI#2, from left to right as in |
| | Tables 6.3.1.1.2-1/2, if reported |
| | PMI wideband information fields X₂ of CRI#2, from left to right as in |
| | Tables 6.3.1.1.2-1/2, or codebook index for 2 antenna ports according to |
| | Clause 5.2.2.2.1 in [6, TS38.214], if pmi-FormatIndicator= |
| | widebandPMI and if reported |
| | . . . . . . |
| | Wideband CQI for the second TB of CRI#M as in Tables 6.3.1.1.2-3/4/5, |
| | if present and reported |
| | Layer Indicator of CRI#M as in Tables 6.3.1.1.2-3/4/5, if reported |
| | PMI wideband information fields X₁ of CRI#M, from left to right as in |
| | Tables 6.3.1.1.2-1/2, if reported |
| | PMI wideband information fields X₂ of CRI#M, from left to right as in |
| | Tables 6.3.1.1.2-1/2, or codebook index for 2 antenna ports according to |
| | Clause 5.2.2.2.1 in [6, TS38.214], if pmi-FormatIndicator= |
| | widebandPMI and if reported |

TABLE 46

| | |
|---|---|
| CSI | Subband differential CQI for the second TB of all even subbands with |
| report of | increasing order of subband number of CRI#1, as in Tables 6.3.1.1.2-3/4/5, |
| sub-configuration | if cqi-FormatIndicator=subbandCQI and if reported |
| #n Part 2 | PMI subband information fields X₂ of all even subbands with increasing |
| subband | order of subband number of CRI#1, from left to right as in Tables 6.3.1.1.2- |
| | 1/2, or codebook index for 2 antenna ports according to Clause 5.2.2.2.1 in |
| | [6, TS38.214] of all even subbands with increasing order of subband |
| | number of CRI#1, if pmi-FormatIndicator= subbandPMI and if reported |
| | Subband differential CQI for the second TB of all even subbands with |
| | increasing order of subband number of CRI#2, as in Tables 6.3.1.1.2-3/4/5, |
| | if cqi-FormatIndicator=subbandCQI and if reported |
| | PMI subband information fields X₂ of all even subbands with increasing |
| | order of subband number of CRI#2, from left to right as in Tables 6.3.1.1.2- |
| | 1/2, or codebook index for 2 antenna ports according to Clause 5.2.2.2.1 in |
| | [6, TS38.214] of all even subbands with increasing order of subband |
| | number of sub-config#1 with CRI#2, if pmi-FormatIndicator= |
| | subbandPMI and if reported |
| | . . . . . . |
| | Subband differential CQI for the second TB of all even subbands with |
| | increasing order of subband number of CRI#M, as in Tables 6.3.1.1.2- |
| | 3/4/5, if cqi-FormatIndicator=subbandCQI and if reported |
| | PMI subband information fields X₂ of all even subbands with increasing |
| | order of subband number of CRI#M, from left to right as in Tables |
| | 6.3.1.1.2-1/2, or codebook index for 2 antenna ports according to Clause |
| | 5.2.2.2.1 in [6, TS38.214] of all even subbands with increasing order of |
| | subband number of sub-config#N with CRI#M, if pmi-FormatIndicator= |
| | subbandPMI and if reported |
| | Subband differential CQI for the second TB of all odd subbands with |
| | increasing order of subband number of CRI#1, as in Tables 6.3.1.1.2-3/4/5, |
| | if cqi-FormatIndicator=subbandCQI and if reported |
| | PMI subband information fields X₂ of all odd subbands with increasing |
| | order of subband number of CRI#1, from left to right as in Tables 6.3.1.1.2- |
| | 1/2, or codebook index for 2 antenna ports according to Clause 5.2.2.2.1 in |
| | [6, TS38.214] of all odd subbands with increasing order of subband |
| | number, if pmi-FormatIndicator= subbandPMI and if reported |
| | Subband differential CQI for the second TB of all odd subbands with |
| | increasing order of subband number of CRI#2, as in Tables 6.3.1.1.2-3/4/5, |
| | if cqi-FormatIndicator=subbandCQI and if reported |
| | PMI subband information fields X₂ of all odd subbands with increasing |
| | order of subband number of CRI#2, from left to right as in Tables 6.3.1.1.2- |
| | 1/2, or codebook index for 2 antenna ports according to Clause 5.2.2.2.1 in |
| | [6, TS38.214] of all odd subbands with increasing order of subband number |
| | of sub-config#1 with CRI#2, if pmi-FormatIndicator= subbandPMI and if |
| | reported |
| | . . . . . . |
| | Subband differential CQI for the second TB of all odd subbands with |
| | increasing order of subband number of CRI#M, as in Tables 6.3.1.1.2- |
| | 3/4/5, if cqi-FormatIndicator=subbandCQI and if reported |
| | PMI subband information fields X₂ of all odd subbands with increasing |
| | order of subband number of CRI#M, from left to right as in Tables |
| | 6.3.1.1.2-1/2, or codebook index for 2 antenna ports according to Clause |
| | 5.2.2.2.1 in [6, TS38.214] of all odd subbands with increasing order of |
| | subband number of sub-config#N with CRI#M, if pmi-FormatIndicator= |
| | subbandPMI and if reported |

As shown in Tables 43 to 46, the CSI mapping orders based on multiple CSI-RS resources for each sub-configuration according to wideband and subband configurations for a single-part CSI and a two-part CSI have been proposed. The mapping order between the sub-configurations may be based on sub-configuration indexes as shown in the first embodiment of the disclosure, or by considering the CSI for the sub-configurations as one CSI report, CSI reports may be multiplexed and transmitted according to the priority rule described above. In addition, as described above, CSI is generated for each CSI-RS resource rather than for each sub-configuration, and it is also possible that CSI for N multiple sub-configurations is mapped in sequence to each CSI (to each CSI-RS resource) and transmitted. For example, each of a CSI report of CSI-RS resource #m, a CSI report of CSI-RS resource #m Part 1, a CSI report of CSI-RS resource #m Part 2 wideband, and a CSI report of CSI-RS resource #m Part 2 subband may include CSI of the N sub-configurations in order of sub-configuration indexes.

### [Method 10]

Method 10 proposes a mapping order of CSI fields for transmitting N*M pieces of CSI for N sub-configurations*M CSI-RS resources via a single-part CSI report or a two-part CSI report. More specifically, the following method of, with respect to CSI contents, determining a mapping order for each CSI content of M*N pieces of CSI is proposed. Table 47 is a table describing the mapping order of CSI fields of one CSI report with multiple sub-configurations [and multiple CSI resources], pmi-FormatIndicator=widebandPMI and cqi-FormatIndicator=widebandCQI, or reportQuantity set to “cri-RI-CQI” and cqi-FormatIndicator=widebandCQI. Table 48 is a table describing the mapping order of CSI fields of one CSI report with multiple sub-configurations [and multiple CSI resources], CSI part 1, pmi-FormatIndicator=subbandPMI or cqi-FormatIndicator=subbandCQI. Table 49 is a table describing the mapping order of CSI fields of one CSI report with multiple sub-configurations [and multiple CSI resources], CSI part 2 wideband, pmi-FormatIndicator=subbandPMI or cqi-FormatIndicator=subbandCQI. Table 50 is a table describing the mapping order of CSI fields of one CSI report with multiple sub-configurations [and multiple CSI resources], CSI part 2 subband, pmi-FormatIndicator=subbandPMI or cqi-FormatIndicator=subbandCQI.

TABLE 47

| CSI report | |
|---|---|
| number | CSI fields |
| CSI report of | CRI#1 as in Tables 6.3.1.1.2-3/4, if reported |
| sub-configuration#n | CRI#2 as in Tables 6.3.1.1.2-3/4, if reported |
| | . . . . . . |
| | CRI#M as in Tables 6.3.1.1.2-3/4, if reported |
| | Rank Indicator as in Tables 6.3.1.1.2-3/4, if reported |
| | Rank Indicator as in Tables 6.3.1.1.2-3/4, if reported |
| | . . . . . . |
| | Rank Indicator as in Tables 6.3.1.1.2-3/4, if reported |
| | Layer Indicator as in Tables 6.3.1.1.2-3/4, if reported |
| | Layer Indicator as in Tables 6.3.1.1.2-3/4, if reported |
| | . . . . . . |
| | Layer Indicator as in Tables 6.3.1.1.2-3/4, if reported |
| | Zero padding bits of CRI#1 Oₚ₁, if needed |
| | Zero padding bits of CRI#2 Oₚ₂, if needed |
| | . . . . . . |
| | Zero padding bits of CRI#M Oₚᵢ, if needed |
| | PMI wideband information fields X₁, from left to right as in Tables |
| | 6.3.1.1.2-1/2, if reported |
| | PMI wideband information fields X₁, from left to right as in Tables |
| | 6.3.1.1.2-1/2, if reported |
| | PMI wideband information fields X₁, from left to right as in Tables |
| | 6.3.1.1.2-1/2, if reported |
| | . . . . . . |
| | PMI wideband information fields X₂, from left to right as in Tables |
| | 6.3.1.1.2-1/2, or codebook index for 2 antenna ports according to Clause |
| | 5.2.2.2.1 in [6, TS38.214], if reported |
| | PMI wideband information fields X₂, from left to right as in Tables |
| | 6.3.1.1.2-1/2, or codebook index for 2 antenna ports according to Clause |
| | 5.2.2.2.1 in [6, TS38.214], if reported |
| | . . . . . . |
| | PMI wideband information fields X₂, from left to right as in Tables |
| | 6.3.1.1.2-1/2, or codebook index for 2 antenna ports according to Clause |
| | 5.2.2.2.1 in [6, TS38.214], if reported |
| | Wideband CQI for the first TB as in Tables 6.3.1.1.2-3/4, if reported |
| | Wideband CQI for the first TB as in Tables 6.3.1.1.2-3/4, if reported |
| | . . . . . . |
| | Wideband CQI for the first TB as in Tables 6.3.1.1.2-3/4, if reported |
| | Wideband CQI for the second TB as in Tables 6.3.1.1.2-3/4, if reported |
| | Wideband CQI for the second TB as in Tables 6.3.1.1.2-3/4, if reported |
| | Wideband CQI for the second TB as in Tables 6.3.1.1.2-3/4, if reported |

TABLE 48

| CSI report | |
|---|---|
| number | CSI fields |
| CSI report of | CRI#1 as in Tables 6.3.1.1.2-3/4, if reported |
| sub-configuration #n | CRI#2 as in Tables 6.3.1.1.2-3/4, if reported |
| CSI part 1 | . . . . . . |
| | CRI#M as in Tables 6.3.1.1.2-3/4, if reported |
| | Rank Indicator as in Tables 6.3.1.1.2-3/4/5, if reported |
| | Rank Indicator as in Tables 6.3.1.1.2-3/4/5, if reported |
| | . . . . . . |
| | Rank Indicator as in Tables 6.3.1.1.2-3/4/5, if reported |
| | Wideband CQI for the first TB as in Tables 6.3.1.1.2-3/4/5, if reported |
| | Wideband CQI for the first TB as in Tables 6.3.1.1.2-3/4/5, if reported |
| | . . . . . . |
| | Wideband CQI for the first TB as in Tables 6.3.1.1.2-3/4/5, if reported |
| | Subband differential CQI for the first TB with increasing order of |
| | subband number as in Tables 6.3.1.1.2-3/4/5, if reported |
| | Subband differential CQI for the first TB with increasing order of |
| | subband number as in Tables 6.3.1.1.2-3/4/5, if reported |
| | . . . . . . |
| | Subband differential CQI for the first TB with increasing order of |
| | subband number as in Tables 6.3.1.1.2-3/4/5, if reported |

Note:
Subbands for given CSI report n indicated by the higher layer parameter csi-ReportingBand are numbered continuously in the increasing order with the lowest subband of csi-ReportingBand as subband 0.

TABLE 49

| CSI report | |
|---|---|
| number | CSI fields |
| CSI report of | Wideband CQI for the second TB of CRI#1 as in Tables 6.3.1.1.2-3/4/5, |
| sub-configuration | if present and reported |
| #n CSI part 2 | Wideband CQI for the second TB of CRI#2 as in Tables 6.3.1.1.2-3/4/5, |
| wideband | if present and reported |
| | . . . . . . |
| | Wideband CQI for the second TB of CRI#M as in Tables 6.3.1.1.2-3/4/5, |
| | if present and reported |
| | Layer Indicator of CRI#1 as in Tables 6.3.1.1.2-3/4/5, if reported |
| | Layer Indicator of CRI#2 as in Tables 6.3.1.1.2-3/4/5, if reported |
| | . . . . . . |
| | Layer Indicator of CRI#M as in Tables 6.3.1.1.2-3/4/5, if reported |
| | PMI wideband information fields X₁ of CRI#1, from left to right as in |
| | Tables 6.3.1.1.2-1/2, if reported |
| | PMI wideband information fields X₁ of CRI#2, from left to right as in |
| | Tables 6.3.1.1.2-1/2, if reported |
| | . . . . . . |
| | PMI wideband information fields X₁ of CRI#M, from left to right as in |
| | Tables 6.3.1.1.2-1/2, if reported |
| | PMI wideband information fields X₂ of CRI#1, from left to right as in |
| | Tables 6.3.1.1.2-1/2, or codebook index for 2 antenna ports according to |
| | Clause 5.2.2.2.1 in [6, TS38.214], if pmi-FormatIndicator= |
| | widebandPMI and if reported |
| | PMI wideband information fields X₂ of CRI#2, from left to right as in |
| | Tables 6.3.1.1.2-1/2, or codebook index for 2 antenna ports according to |
| | Clause 5.2.2.2.1 in [6, TS38.214], if pmi-FormatIndicator= |
| | widebandPMI and if reported |
| | . . . . . . |
| | PMI wideband information fields X₂ of CRI#M, from left to right as in |
| | Tables 6.3.1.1.2-1/2, or codebook index for 2 antenna ports according to |
| | Clause 5.2.2.2.1 in [6, TS38.214], if pmi-FormatIndicator= |
| | widebandPMI and if reported |

TABLE 50

| | |
|---|---|
| CSI report of | Subband differential CQI for the second TB of all even subbands with |
| sub-configuration | increasing order of subband number of CRI#1, as in Tables 6.3.1.1.2-3/4/5, |
| #n Part 2 | if cqi-FormatIndicator=subbandCQI and if reported |
| subband | Subband differential CQI for the second TB of all even subbands with |
| | increasing order of subband number of CRI#2, as in Tables 6.3.1.1.2-3/4/5, |
| | if cqi-FormatIndicator=subbandCQI and if reported |
| | . . . . . . |
| | Subband differential CQI for the second TB of all even subbands with |
| | increasing order of subband number of CRI#M, as in Tables 6.3.1.1.2- |
| | 3/4/5, if cqi-FormatIndicator=subbandCQI and if reported |
| | PMI subband information fields X₂ of all even subbands with increasing |
| | order of subband number of CRI#1, from left to right as in Tables 6.3.1.1.2- |
| | 1/2, or codebook index for 2 antenna ports according to Clause 5.2.2.2.1 in |
| | [6, TS38.214] of all even subbands with increasing order of subband |
| | number of CRI#1, if pmi-FormatIndicator= subbandPMI and if reported |
| | PMI subband information fields X₂ of all even subbands with increasing |
| | order of subband number of CRI#2, from left to right as in Tables 6.3.1.1.2- |
| | 1/2, or codebook index for 2 antenna ports according to Clause 5.2.2.2.1 in |
| | [6, TS38.214] of all even subbands with increasing order of subband |
| | number of sub-config#1 with CRI#2, if pmi-FormatIndicator= |
| | subbandPMI and if reported |
| | . . . . . . |
| | PMI subband information fields X₂ of all even subbands with increasing |
| | order of subband number of CRI#M, from left to right as in Tables |
| | 6.3.1.1.2-1/2, or codebook index for 2 antenna ports according to Clause |
| | 5.2.2.2.1 in [6, TS38.214] of all even subbands with increasing order of |
| | subband number of sub-config#N with CRI#M, if pmi-FormatIndicator= |
| | subbandPMI and if reported |
| | Subband differential CQI for the second TB of all odd subbands with |
| | increasing order of subband number of CRI#1, as in Tables 6.3.1.1.2-3/4/5, |
| | if cqi-FormatIndicator=subbandCQI and if reported |
| | Subband differential CQI for the second TB of all odd subbands with |
| | increasing order of subband number of CRI#2, as in Tables 6.3.1.1.2-3/4/5, |
| | if cqi-FormatIndicator=subbandCQI and if reported |
| | . . . . . . |
| | Subband differential CQI for the second TB of all odd subbands with |
| | increasing order of subband number of CRI#M, as in Tables 6.3.1.1.2- |
| | 3/4/5, if cqi-FormatIndicator=subbandCQI and if reported |
| | PMI subband information fields X₂ of all odd subbands with increasing |
| | order of subband number of CRI#1, from left to right as in Tables 6.3.1.1.2- |
| | 1/2, or codebook index for 2 antenna ports according to Clause 5.2.2.2.1 in |
| | [6, TS38.214] of all odd subbands with increasing order of subband |
| | number, if pmi-FormatIndicator= subbandPMI and if reported |
| | PMI subband information fields X₂ of all odd subbands with increasing |
| | order of subband number of CRI#2, from left to right as in Tables 6.3.1.1.2- |
| | 1/2, or codebook index for 2 antenna ports according to Clause 5.2.2.2.1 in |
| | [6, TS38.214] of all odd subbands with increasing order of subband number |
| | of sub-config#1 with CRI#2, if pmi-FormatIndicator= subbandPMI and if |
| | reported |
| | . . . . . . |
| | PMI subband information fields X₂ of all odd subbands with increasing |
| | order of subband number of CRI#M, from left to right as in Tables |
| | 6.3.1.1.2-1/2, or codebook index for 2 antenna ports according to Clause |
| | 5.2.2.2.1 in [6, TS38.214] of all odd subbands with increasing order of |
| | subband number of sub-config#N with CRI#M, if pmi-FormatIndicator= |
| | subbandPMI and if reported |

As shown in Tables 47 to 50, the CSI mapping orders for each CSI content based on multiple CSI-RS resources for each sub-configuration according to wideband and subband configurations for a single-part CSI and a two-part CSI have been proposed. The mapping order between the sub-configurations may be based on sub-configuration indexes as shown in the first embodiment of the disclosure, or by considering the CSI for the sub-configurations as one CSI report, CSI reports may be multiplexed and transmitted according to the priority rule described above. In addition, similarly, CSI is generated for each CSI-RS resource rather than for each sub-configuration, and it is also possible that the CSI for N multiple sub-configurations is mapped in sequence to each CSI (to each CSI-RS resource) and transmitted. For example, each of a CSI report of CSI-RS resource #m, a CSI report of CSI-RS resource #m Part 1, a CSI report of CSI-RS resource #m Part 2 wideband, and a CSI report of CSI-RS resource #m Part 2 subband may include CSI of the N sub-configurations in order of sub-configuration indexes.

Via the methods above, the base station may transmit N*M pieces of CSI by determining CSI fields depending on whether a CSI report corresponds to a single-part CSI or a two-part CSI. Therefore, omission (e.g., the omission depends on whether multiplexing on an uplink resource is possible, and based on the amount of uplink resources available for CSI transmission, transmission can be omitted for a CSI report exceeding the amount of transmittable information) and priority rules may be applied based on the amount of UL resources available for CSI transmission sequentially according to sub-configuration indexes and CSI-RS resource indexes.

In the methods above, when the number of sub-configurations or CSI-RSs is 1, N=1 or M=1 is applicable in the methods, and in a specific CSI part, limited N sub-configurations or M CSI-RSs may be applied. For example, for a single-part CSI, N may be a value of 2 or smaller, M may be a value of 2 or smaller, or N*M may be configured to be a value of 2 or smaller.

The methods define a mapping order according to configurations of multiple sub-configurations and multiple CSI-RS resources. More specifically, the method includes operations of 1) sorting and mapping CSI according to multiple sub-configurations within a CSI report, and then 2) sorting and mapping, for each sub-configuration, CSI for multiple CSI-RS resources measured via sub-configurations. In this case, the order may be reversed. Additionally, multiple power control offset values may be configured in one sub-configuration. For example, two power control offsets may be configured in each of two sub-configurations, and two CSI-RS resources may be configured for the two sub-configurations. In this case, the terminal may generate a total of 2 (number of power control offsets)*2 (number of sub-configurations)*2 (number of CSI-RS resources)=8 pieces of CSI, and map and report the CSI. For example, the terminal may generate CSI by applying different power control offsets to one CSI-RS resource. In this case, as in the methods, each piece of CSI may be ordered and mapped according to a sequence of 1) CSI of sub-configuration ordering and mapping per CSI report, 2) CSI of CSI-RS resource ordering and mapping per sub-configuration, and 3) CSI of power control offset ordering and mapping per CSI-RS resource corresponding to sub-configuration.

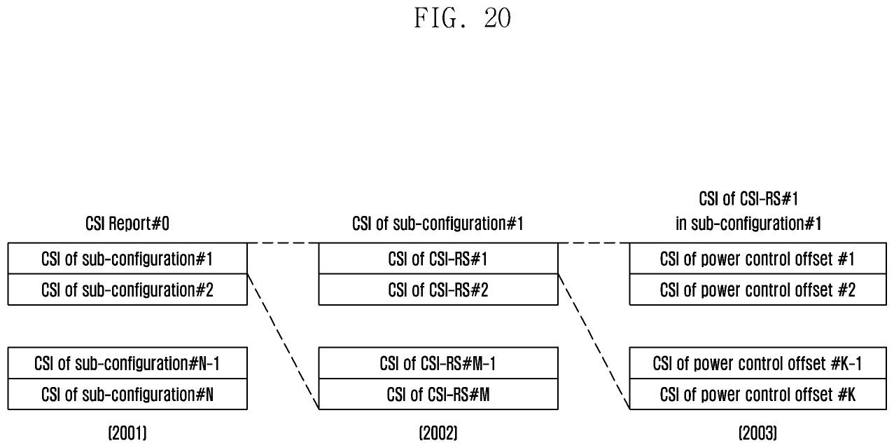

FIG. 20 is a diagram illustrating a CSI report in which a base station and a terminal have multiple sub-configurations, multiple CSI-RSs, and multiple power control offset values according to an embodiment of the disclosure.

Referring to FIG. 20, the described 1) CSI of sub-configuration ordering and mapping per CSI report corresponds to reference numeral 2001, 2) CSI of CSI-RS resource ordering and mapping per sub-configuration corresponds to reference numeral 2002, and 3) CSI of power control offset ordering and mapping per CSI-RS resource corresponding to sub-configuration corresponds to reference numeral 2003.

The disclosure is not limited to the sequence of the ordering and mapping proposed above, and the sequence of each of procedures 1) to 3) may be changed and applied. In addition, some of the procedures may be omitted depending on a configuration. The CSI may be ordered and mapped in sequence according to sub-configuration indexes, CSI-RS resource indexes, and power control offset indexes, and as another method, for procedures 2) and/or 3), all or some of the CSI may be transmitted by prioritizing a power control offset value and a CSI-RS resource preferred by a terminal. For example, it is possible for the terminal to generate and report the CSI based on the preferred CSI-RS resource and/or power control offset, rather than generating and reporting the CSI based on all CSI-RS resources and/or all power control offsets. In addition, for a specific CSI content, a differential value may be applied and reported as described in the second embodiment.

In addition, even if N sub-configurations and M CSI-RS resources are configured, N′ sub-configurations and M′ CSI-RS resources for determination of CSI fields according to an N-to-M sub-configuration and a CSI-RS resource mapping relationship may be determined. For example, when full connected mapping is applied to 4 sub-configurations and 2 CSI-RS resources, 4*2=8 pieces of CSI may be transmitted according to the method, and if N-to-M mapping (e.g., 2-to-1 mapping) is applied, sub-configurations #1 and #2 may be mapped to CSI-RS resource #1, and sub-configurations #3 and #4 may be mapped to CSI-RS resource #2, so that 2*2=4 pieces of CSI may be transmitted according to the method. Likewise, a power control offset configuration may also be applied according to the same method. Vis this, the base station may receive, from the terminal, CSI information according to multiple sub-configurations and CSI-RSs and determine an antenna pattern and transmission power for energy saving.

Hereinafter, descriptions will be provided for an example of terminal and base station configurations and an example of terminal and base station operations for determining a mapping order of CSI fields when transmitting, via one CSI report, multiple pieces of CSI feedback according to spatial domain (SD) patterns for application of SD adaptation and PD adaptation for energy saving or while a base station is applying the SD adaptation and PD adaptation.

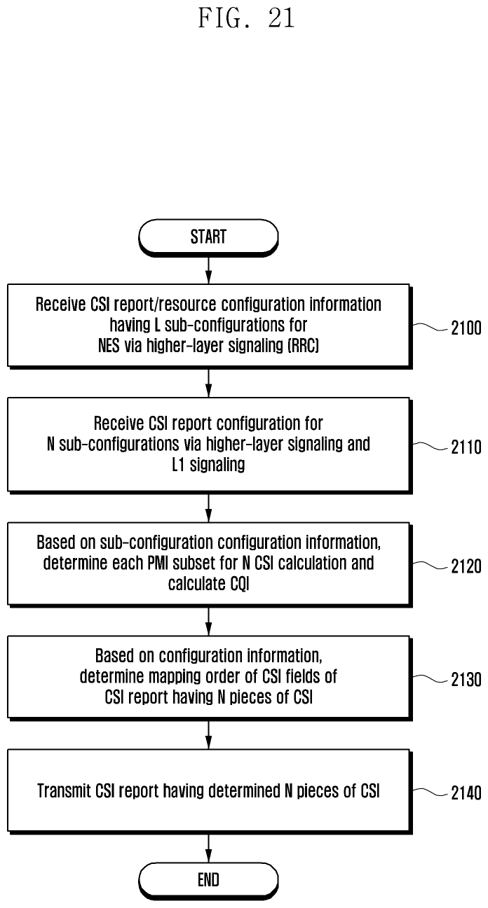

FIG. 21 is a terminal flowchart for applying an energy saving method in a wireless communication system according to an embodiment of the disclosure.

Referring to FIG. 21, in operation 2100, a terminal may receive CSI report configuration information and/or CSI-RS resource configuration information having L sub-configurations from a base station via higher-layer signaling (RRC signaling) for energy saving of the base station. The CSI report configuration information and/or CSI-RS resource configuration information may follow the specific details described above. For example, the CSI report configuration information may include configuration information for the L sub-configurations.

In operation 2110, the terminal may receive the CSI report configuration for the N sub-configuration via higher-layer signaling and L1 signaling. Operation 2110 can also be omitted.

In operation 2120, the terminal may determine each PMI subset for N CSI calculation, based on the received sub-configuration configuration information, and calculate a CQI according to the determined PMI subset.

In operation 2130, the terminal may determine a mapping order of CSI fields of a CSI report having N pieces of CSI, based on the configuration information. In this case, the mapping order may be determined by applying a predetermined method or by configuration of the base station, or the like, and may follow at least one combination of the methods described above.

In operation 2140, the terminal may transmit the CSI report including the determined N pieces of CSI to the base station.

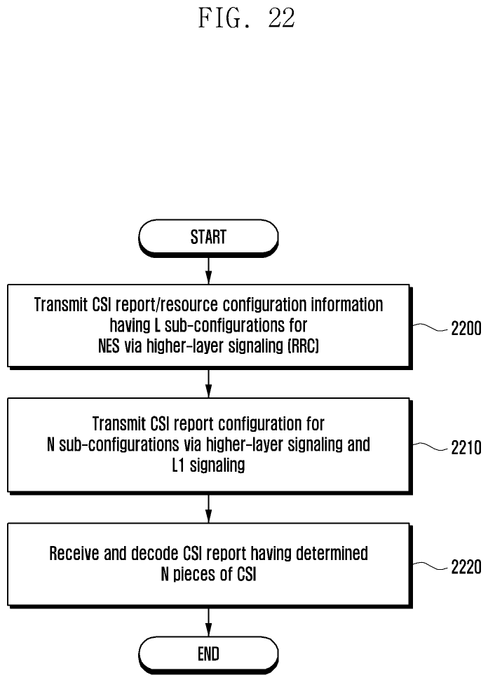

FIG. 22 is a base station flowchart for applying an energy saving method in a wireless communication system according to an embodiment of the disclosure.

Referring to FIG. 22, in operation 2200, a base station may transmit CSI report configuration information and/or CSI resource configuration information having L sub-configurations to a terminal via higher-layer signaling (RRC signaling) for energy saving of the base station. The CSI report configuration information and/or CSI-RS resource configuration information may follow the specific details described above. For example, the CSI report configuration information may include configuration information for the L sub-configurations.

In operation 2210, the base station may transmit the CSI report configuration for the N sub-configuration to the terminal via higher-layer signaling and L1 signaling. Operation 2210 can be omitted.

In operation 2220, the base station may receive and decode a CSI report including N pieces of CSI. After decoding the CSI report, the base station may identify, according to a mapping order of CSI fields of the CSI report including the N pieces of CSI, the CSI included in the CSI report. The mapping order may be determined by applying a predetermined method or by configuration of the base station, or the like, and may follow at least one combination of the methods described above.

The above flowcharts illustrate various methods that may be implemented in accordance with the principles of the disclosure, and various changes may be made to the methods illustrated in the flowcharts herein. For example, while illustrated as a series of operations, various operations in each figure may overlap, occur in parallel, occur in a different order, or occur multiple times. In another example, operations may be omitted or replaced by other operations.

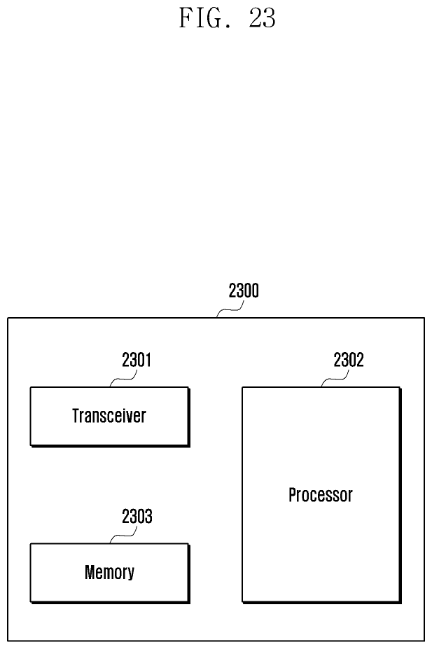

FIG. 23 is a block diagram of a terminal according to an embodiment of the disclosure.

Referring to FIG. 23, a terminal 2300 may include a transceiver 2301, a controller (e.g., a processor) 2302, and a storage unit (e.g., memory) 2303. The transceiver 2301, the controller 2302, and the storage unit 2303 of the terminal 2300 may operate according to at least one or a combination of methods corresponding to the aforementioned embodiments. However, the elements of the terminal 2300 are not limited to the described examples. According to another embodiment of the disclosure, the terminal 2300 may include more or fewer elements compared to the aforementioned elements. In addition, in a specific case, the transceiver 2301, the controller 2302, and the storage unit 2303 may be implemented in the form of a single chip.

The transceiver 2301 may include a transmitter and a receiver according to an embodiment. The transceiver 2301 may transmit signals to or receive signals from a base station. The signal may include control information and data. The transceiver 2301 may include an RF transmitter configured to perform amplification and up-conversion of a frequency of a transmitted signal, and an RF receiver configured to perform low-noise amplification of a received signal and perform down-conversion of a frequency. The transceiver 2301 may receive a signal via a radio channel, output the signal to the controller 2302, and transmit, via the radio channel, a signal output from the controller 2302.

The controller 2302 may control a series of procedures in which the terminal 2300 may operate according to the aforementioned embodiments of the disclosure. For example, the controller 2302 may perform or control a terminal operation for performing at least one or a combination of methods according to the embodiments of the disclosure. The controller 2302 may include at least one processor. For example, the controller 2302 may include a communication processor (CP) configured to perform control for communication and an application processor (AP) configured to control a higher layer (e.g., an application).

The storage unit 2303 may store control information or data, and may have an area for storing data required for controlling by the controller 2302 and data generated during controlling by the controller 2302.

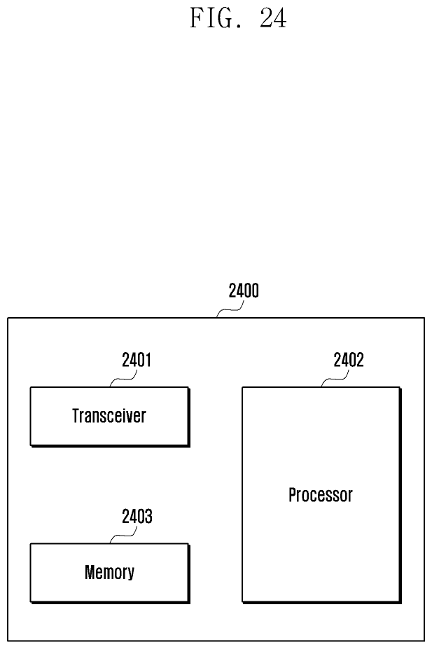

FIG. 24 is a block diagram of a base station according to an embodiment of the disclosure.

Referring to FIG. 24, a base station 2400 may include a transceiver 2401, a controller (e.g., a processor) 2402, and a storage unit (e.g., memory) 2403. The transceiver 2401, the controller 2402, and the storage unit 2403 of the base station 2400 may operate according to at least one or a combination of methods corresponding to the aforementioned embodiments. However, the elements of the base station 2400 are not limited to the described examples. According to another embodiment of the disclosure, the base station 2400 may include more or fewer elements compared to the aforementioned elements. In addition, in a specific case, the transceiver 2401, the controller 2402, and the storage unit 2403 may be implemented in the form of a single chip.

The transceiver 2401 may include a transmitter and a receiver according to an embodiment. The transceiver 2401 may transmit signals to or receive signals from a terminal. The signal may include control information and data. The transceiver 2401 may include an RF transmitter configured to perform amplification and up-conversion of a frequency of a transmitted signal, and an RF receiver configured to perform low-noise amplification of a received signal and perform down-conversion of a frequency. The transceiver 2401 may receive a signal via a radio channel, output the signal to the controller 2402, and transmit, via the radio channel, a signal output from the controller 2402.

The controller 2402 may control a series of procedures so that the base station 2400 may operate according to the aforementioned embodiment of the disclosure. For example, the controller 2402 may perform or control a base station operation for performing at least one or a combination of methods according to the embodiments of the disclosure. The controller 2402 may include at least one processor. For example, the controller 2402 may include a communication processor (CP) configured to perform control for communication and an application processor (AP) configured to control a higher layer (e.g., an application).

The storage unit 2403 may store control information, data, and control information or data received from a terminal, and may have an area for storing data required for controlling by the controller 2402 and data generated during controlling by the controller 2402.

Although figures illustrate different examples of a user equipment/base station, various changes may be made to the figures. For example, a user equipment/base station may include any number of respective elements in any suitable arrangement. In general, figures do not limit the scope of the disclosure to any particular configuration(s). Moreover, while figures illustrate operational environments in which various user equipment/base station features disclosed in the patent document may be used, these features may be used in any other suitable system.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a communication system, the method comprising:
receiving, from a base station, configuration information for a channel state information (CSI) report, wherein the configuration information includes a CSI report configuration including a plurality of sub-configurations for sub-reports;
receiving, from the base station, channel state information reference signals (CSI-RSs) associated with the CSI report configuration;
identifying CSI based on the CSI-RSs and the configuration information; and
transmitting, to the base station, the CSI,
wherein the CSI includes CSI fields of sub-reports ordered by indexes of the sub-reports.

2. The method of claim 1,
wherein in case that the CSI corresponds to a plurality of single part CSI reports, the CSI includes CSI fields of the plurality of single part CSI reports, and
wherein CSI fields of a single part CSI report include CSI fields of sub-reports corresponding to the single part CSI report ordered by indexes of the sub-reports corresponding to the single part CSI report.

3. The method of claim 2, wherein CSI fields of a sub-report include zero padding bits determined based on a sub-configuration of the sub-report.

4. The method of claim 1, wherein in case that the CSI corresponds to a plurality of two part CSI reports, the CSI includes a first bit sequence including first CSI parts of sub-reports corresponding to the plurality of two part CSI reports, and a second bit sequence including second CSI parts of sub-reports corresponding to the plurality of two part CSI reports.

5. The method of claim 4, wherein in case that second CSI parts include subband precoding matrix indicators (PMIs) or subband channel quality indicators (CQIs), the second bit sequence includes sub-reports corresponding to even subbands and sub-reports corresponding to odd subbands following the sub-reports corresponding to even subbands.

6. A method performed by a base station in a communication system, the method comprising:
transmitting, to a terminal, configuration information for a channel state information (CSI) report, wherein the configuration information includes a CSI report configuration including a plurality of sub-configurations for sub-reports;
transmitting, to the terminal, channel state information reference signals (CSI-RSs) associated with the CSI report configuration; and
receiving, from the terminal, CSI corresponding to the CSI-RSs and the configuration information,
wherein the CSI includes CSI fields of sub-reports ordered by indexes of the sub-reports.

7. The method of claim 6,
wherein in case that the CSI corresponds to a plurality of single part CSI reports, the CSI includes CSI fields of the plurality of single part CSI reports, and
wherein CSI fields of a single part CSI report include CSI fields of sub-reports corresponding to the single part CSI report ordered by indexes of the sub-reports corresponding to the single part CSI report.

8. The method of claim 7, wherein CSI fields of a sub-report include zero padding bits determined based on a sub-configuration of the sub-report.

9. The method of claim 6, wherein in case that the CSI corresponds to a plurality of two part CSI reports, the CSI includes a first bit sequence including first CSI parts of sub-reports corresponding to the plurality of two part CSI reports, and a second bit sequence including second CSI parts of sub-reports corresponding to the plurality of two part CSI reports.

10. The method of claim 9, wherein in case that second CSI parts include subband precoding matrix indicators (PMIs) or subband channel quality indicators (CQIs), the second bit sequence includes sub-reports corresponding to even subbands and sub-reports corresponding to odd subbands following the sub-reports corresponding to even subbands.

11. A terminal in a communication system, the terminal comprising:
transceivers;
memory storing one or more computer programs; and
one or more processors communicatively coupled to the transceivers and the memory,
wherein the one or more computer programs include computer-executable instructions that, when executed by the one or more processors individually or collectively, cause the terminal to:
receive, from a base station, configuration information for a channel state information (CSI) report, wherein the configuration information includes a CSI report configuration including a plurality of sub-configurations for sub-reports,
receive, from the base station, channel state information reference signals (CSI-RSs) associated with the CSI report configuration,
identify CSI based on the CSI-RSs and the configuration information, and transmit, to the base station, the CSI,
wherein the CSI includes CSI fields of sub-reports ordered by indexes of the sub-reports.

12. The terminal of claim 11,
wherein in case that the CSI corresponds to a plurality of single part CSI reports, the CSI includes CSI fields of the plurality of single part CSI reports, and
wherein CSI fields of a single part CSI report include CSI fields of sub-reports corresponding to the single part CSI report ordered by indexes of the sub-reports corresponding to the single part CSI report.

13. The terminal of claim 12, wherein CSI fields of a sub-report include zero padding bits determined based on a sub-configuration of the sub-report.

14. The terminal of claim 11, wherein in case that the CSI corresponds to a plurality of two part CSI reports, the CSI includes a first bit sequence including first CSI parts of sub-reports corresponding to the plurality of two part CSI reports, and a second bit sequence including second CSI parts of sub-reports corresponding to the plurality of two part CSI reports.

15. The terminal of claim 11, wherein in case that second CSI parts include subband precoding matrix indicators (PMIs) or subband channel quality indicators (CQIs), the second bit sequence includes sub-reports corresponding to even subbands and sub-reports corresponding to odd subbands following the sub-reports corresponding to even subbands.

16. A base station in a communication system, the base station comprising:
transceivers;
memory storing one or more computer programs; and
one or more processors communicatively coupled to the transceivers and the memory,
wherein the one or more computer programs include computer-executable instructions that, when executed by the one or more processors individually or collectively, cause the base station to:
transmit, to a terminal, configuration information for a channel state information (CSI) report, wherein the configuration information includes a CSI report configuration including a plurality of sub-configurations for sub-reports,
transmit, to the terminal, channel state information reference signals (CSI-RSs) associated with the CSI report configuration, and
receive, from the terminal, CSI corresponding to the CSI-RSs and the configuration information,
wherein the CSI includes CSI fields of sub-reports ordered by indexes of the sub-reports.

17. The base station of claim 16,
wherein in case that the CSI corresponds to a plurality of single part CSI reports, the CSI includes CSI fields of the plurality of single part CSI reports, and
wherein CSI fields of a single part CSI report include CSI fields of sub-reports corresponding to the single part CSI report ordered by indexes of the sub-reports corresponding to the single part CSI report.

18. The base station of claim 17, wherein CSI fields of a sub-report include zero padding bits determined based on a sub-configuration of the sub-report.

19. The base station of claim 16, wherein in case that the CSI corresponds to a plurality of two part CSI reports, the CSI includes a first bit sequence including first CSI parts of sub-reports corresponding to the plurality of two part CSI reports, and a second bit sequence including second CSI parts of sub-reports corresponding to the plurality of two part CSI reports.

20. The base station of claim 16, wherein in case that second CSI parts include subband precoding matrix indicators (PMIs) or subband channel quality indicators (CQIs), the second bit sequence includes sub-reports corresponding to even subbands and sub-reports corresponding to odd subbands following the sub-reports corresponding to even subbands.
